(19) United States
(12) Patent Application Publication
(10) Pub. No.: US 2007/0231506 A1
(43) Pub. Date: Oct. 4, 2007

(54) Optical film, polarizing plate and liquid crystal display device

(75) Inventors: Ikuko Ohgaru, Minami-ashigara-shi (JP); Susumu Sugiyama, Minami-ashigara-shi (JP); Yoichi Maruyama, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/727,607

(22) Filed: Mar. 27, 2007

(30) Foreign Application Priority Data
Mar. 28, 2006 (JP) P2006-088537
Mar. 28, 2006 (JP) P2006-088929
Mar. 31, 2006 (JP) P2006-100170

(51) Int. Cl. C09K 19/00

(52) U.S. Cl. 428/1.31

(57) ABSTRACT

An optical film, which has a photoelastic coefficient in a longitudinal direction and a photoelastic coefficient in a direction approximately orthogonal to the longitudinal direction, wherein a value obtained by dividing smaller one of the two photoelastic coefficients by greater one is 0.8 or below; an optical film, which has a value of 1.2 or above obtained by dividing greater one of a velocity of sound in a longitudinal direction and a velocity of sound in a direction approximately orthogonal to the longitudinal direction by smaller one; and an optical film, which has a coefficient of linear thermal expansion in a longitudinal direction and a coefficient of linear thermal expansion in a width direction approximately orthogonal to the longitudinal direction, wherein a value obtained by dividing smaller one of the two coefficients of linear thermal expansion by greater one is from 0.1 to 0.5.

### BACKGROUND OF THE INVENTION

1. Field of the Invention

The present invention relates to an optical film, a manufacturing method thereof, a polarizing plate and a liquid crystal display device.

2. Description of the Related Art

A liquid crystal display device has a liquid crystal cell and a polarizing plate. In general, the polarizing plate has a polarizing film and protective films made of cellulose acetate, and is prepared by dyeing a polarizing film formed of, e.g., a polyvinyl alcohol film with iodine, stretching the dyed film, and laminating protective films on both sides of the stretched film. Some of transmission liquid crystal display devices take a form that polarizing plates are mounted on both sides of a liquid crystal cell and at least one sheet of optically compensatory film is further arranged. In reflection liquid crystal display devices, a reflecting plate, a liquid crystal cell, at least one sheet of optically compensatory film and a polarizing plate are generally arranged in order of mention. The liquid crystal cell is made up of liquid crystalline molecules, two substrates in which the liquid crystalline molecules are enclosed, and electrode layers for applying a voltage to the liquid crystalline molecules. The liquid crystal cell provides ON/OFF indications according to difference in state of orientational ordering among liquid crystalline molecules, and can be applied in both transmission and reflection liquid crystal display devices. Various display modes, such as TN (Twisted Nematic), IPS (In-Plane Switching), OBC (Optically Compensatory Bend), VA (Vertically Aligned) and ECB (Electrically Controlled Birefringence) modes, have been put forth.

Of these LCDs, a twisted nematic liquid crystal display device of a 90-degree twist structure (hereinafter referred to as “TN-mode liquid crystal display”), which utilizes nematic liquid crystalline molecules having positive permittivity anisotropy and is actuated by thin-film transistors, has been predominantly used in applications in which high definition is required for display. Although it demonstrates excellent displaying properties when viewed from the front, a TN-mode liquid crystal display has a viewing angle characteristic that, when viewed from oblique directions, there occur a drop in the contrast and deterioration in display quality due to tone reversal, or brightness inversion in gray-scale display. So it has been strongly desired to make improvements in such a viewing angle characteristic.

On the other hand, liquid crystal systems with wide viewing angles, such as IPS-mode, OCB-mode and VA-mode liquid crystal displays, have been increasing their market shares with recent increase in demand for liquid-crystal TV sets. All of these modes have been moving up in their display qualities year after year, but a color drift problem occurring at the occasion of oblique viewing is still unsolved.

As to methods for solving such a problem, there is a proposal of reducing light leakage by combined use of a first retardation plate having positive refractive index anisotropy for which the relation nx>ny=nz holds and a second retardation plate having negative refractive index anisotropy for which the relation nx>ny>nz holds (e.g., Japanese Patent No. 3,027,805). In addition, improvements in viewing angle characteristics of VA-mode liquid crystal display devices by use of optically biaxial retardation plates satisfying the relation nx>ny>nz are suggested (e.g., in Japanese Patent No. 3,330,574). Herein, nx, ny and nz represent refractive indices of the retardation plate in the X-axis direction, the Y-axis direction and the Z-axis direction, respectively. The X-axis direction is an axis direction in which the refractive index becomes greatest of all in-plane directions of the retardation plate, the Y-axis direction is an axis direction perpendicular to the X-axis direction in the same plane of the retardation plate, and the Z-axis direction is a thickness direction perpendicular to both the X-axis direction and the Y-axis direction.

Various liquid crystal systems, including those of IPS and OCB modes, are also increasing in their display performances with growing demand for liquid-crystal TV sets in years (JP-A-9-211444, JP-A-11-316378, JP-A-2003-15134 and JP-A-10-54982).

Additionally, it is already known that retardation plates formed of polymeric oriented films, notably quarter-wave retardation plates, are required to satisfy the relations

0.6<Δn·d(450)/Δn·d(550)<0.97 and

1.01<Δn·d(650)/Δn·d(550)<1.35

wherein Δn·d(λ) stands for retardation of polymeric oriented film at the wavelength λnm (JP-A-2000-137116).

Moreover, as liquid crystal TV sets have recently become widespread and increased in screen size and intensity of backlight, unevenness in the screen and light leakage have come to be regarded as problems. When such a TV set is exposed to drastic changes in ambient temperature and humidity, it is particularly required to improve unevenness caused on the perimeter of the screen by dimensional changes in the polarizing plate(s).

In some cases, warpage further developing in the liquid crystal panel causes a phenomenon of “unevenness at corners”, or uneven light leakage at the four corners of the panel (screen) when the screen is in a black-display state.

A cause of the warpage consists in that, when expansion and shrinkage of various members laminated on the front and rear sides of a substrate made of glass or resin, which does not warp by nature, are caused by heating and moisture absorption or desorption, a difference arises between the front and rear sides of the substrate and a force balance between the front and the rear of an image display unit comes undone to result in warping of the panel in its entirety. In addition, a general image display unit has an open surface on the front side, while the rear thereof is integrated into a cabinet and in a quasi-closed state. As a result, differences of heating and moisture absorption or desorption arise between the front laminate and the rear laminate which face each other across the substrate, and thereby differences in expansion and shrinkage are also brought about.

In the case of a liquid crystal display device, polarizing plates causing polarization of light are placed on both sides of a liquid crystal cell containing a liquid crystal enclosed with glass substrates, various optical elements including a retardation plate, an antireflective film and a brightness enhancing film are laminated on an as needed basis, a fastening frame made of a metal plate, such as a stainless steel plate, referred to as “bezel” is fastened around the rim of the thus formed laminate to form a liquid crystal module, and this liquid crystal module and other constituent members are assembled and housed in a cabinet, thereby making the liquid crystal display device.

There is a case where, since a backlight illuminates and causes a temperature rise when a liquid crystal display device is switched on, temperature and humidity differences arise between the front side (viewing side) and the backlight side. In this case, the front-side laminate containing a polarizing plate and the backlight-side laminate, which are divided by a liquid cell, differ in temperature and humidity situations under which they are placed, and the laminates are thought to be affected by their individual situations. When warpage occurs, not only the perimeter or four corners of the panel come into contact with the cabinet, but also the contact condition between the panel and the backlight placed on the back thereof is influenced by the warpage; as a result, problems arise in point of display performance. In some cases, there further occurs uneven light leakage at the four corners of the panel (screen) in a black-display state, or the phenomenon of “unevenness at corners”.

### SUMMARY OF THE INVENTION

One object of the invention is to provide an optical film, notably for VA-, IPS- and OCB-mode use, by which a liquid crystal cell can be optically compensated with high accuracy, resulting in achievement of high contrast and improvement in color drift depending on viewing directions at black-display time, a manufacturing method thereof, and a polarizing plate using such an optical film.

Another object of the invention is to provide a liquid crystal display device, notably of VA, IPS or OBC mode, which resists developing unevenness on the perimeter of its screen even when undergoes drastic changes in temperature and humidity.

A further object of the invention is to provide a liquid crystal display device which is prevented from panel warpage and thereby inhibited from causing uneven light leakage at the four corners of the panel (screen) when the screen is in a black-display state, or the phenomenon of “unevenness at corners”.

The following are aspects that enable the invention to attain the objects described above.

[1] An optical film, which has a photoelastic coefficient in a longitudinal direction of the optical film and a photoelastic coefficient in a direction approximately orthogonal to the longitudinal direction,

wherein a value obtained by dividing smaller one of the two photoelastic coefficients by greater one of the two photoelastic coefficients is 0.8 or below.

[2] The optical film as described in [1] above,

wherein values of in-plane retardation Re and thickness-direction retardation Rth at wavelengths 450 nm, 550 nm and 650 nm satisfy the following relations (I) to (III):

0.4<{(Re(450)/Rth(450))/(Re(550)/Rth(550))}<0.95 and

1.05<{(Re(650)/Rth(650))/(Re(550)/Rth(550))}<1.9 Relation (I)

0.1<(Re(450)/Re(550))<0.95 Relation (II)

1.03<(Re(650)/Re(550))<1.93 Relation (III)

wherein Re(λ) represents an in-plane retardation Re value, expressed in the unit nm, at a wavelength λ nm; and

Rth(λ) represents a thickness-direction retardation Rth value, expressed in the unit nm, at a wavelength λ nm.

[3] A method of manufacturing an optical film, which comprises:

casting a dope solution on to a support; then

drying the dope solution at a temperature of from 40° C. to 60° C., so as to form a film; then

stretching the film; and

shrinking the film.

[4] The optical film as described in [1] or [2] above, which is produced by a method as described in [3] above.

[5] An optical film, which has a value of 1.2 or above obtained by dividing greater one of a velocity of sound in a longitudinal direction of the optical film and a velocity of sound in a direction approximately orthogonal to the longitudinal direction by smaller one of the two velocities.

[6] An optical film, which has a value of 1.1 or above obtained by dividing greater one of a velocity of sound in a longitudinal direction of the optical film and a velocity of sound in a direction approximately orthogonal to the longitudinal direction by smaller one of the two velocities,

wherein values of in-plane retardation Re and thickness-direction retardation Rth at wavelengths 450 nm, 550 nm and 650 nm satisfy the following relations (I) to (III):

0.4<{(Re(450)/Rth(450))/(Re(550)/Rth(550))}<0.95 and

1.05<{(Re(650)/Rth(650))/(Re(550)/Rth(550))}<1.9 Relation (I)

0.1<(Re(450)/Re(550))<0.95 Relation (II)

1.03<(Re(650)/Re(550))<1.93 Relation (III)

wherein Re(λ) represents an in-plane retardation Re value, expressed in the unit nm, at a wavelength λ nm; and

Rth(λ) represents a thickness-direction retardation Rth value, expressed in the unit nm, at a wavelength λ nm.

[7] A method of manufacturing an optical film, which comprises:

stretching a film; and

shrinking a film,

wherein the shrinking is performed at a shrink speed of 10% to 100% per minute.

[8] The optical film as described in [5] or [6], which is produced by a method as described in [7] above.

[9] The optical film as described in any of [1], [2], [4] to [6] and [8] above,

wherein an in-plane retardation Re value at a wavelength of 550 nm is in a range of from 20 to 100 nm and a thickness-direction retardation Rth value at a wavelength of 550 nm is in a range of from 100 to 300 nm.

[10] The optical film as described in any of [1], [2], [4] to [6], [8] and [9] above, which comprises a cellulose acylate.

[11] The optical film as described in [10] above,

wherein substitution degrees of hydroxyl groups with acyl groups at 2-, 3- and 6-positions of a glucose unit in the cellulose acylate satisfy the following relations (IV) and (V):

2.0≦(DS2+DS3+DS6)≦3.0 Relation (IV)

DS6/(DS2+DS3+DS6)≧0.315 Relation (V)

wherein DS2 represents an acyl substitution degree on the 2-position hydroxyl group;

DS3 represents an acyl substitution degree on the 3-position hydroxyl group; and

DS6 represents an acyl substitution degree on the 6-position hydroxyl group.

[12] The cellulose acylate film as described in [10] or [11] above, which substantially comprises a cellulose acylate satisfying the following relations (VI) and (VII):

2.0≦A+B≦3.0 Relation (VI)

0≦B Relation (VII)

wherein A represents a substitution degree of hydroxyl groups of a glucose unit in the cellulose acylate with acetyl groups; and

B represents a substitution degree of hydroxyl groups of a glucose unit in the cellulose acylate with propionyl groups, butyryl groups or benzoyl groups.

[13] The optical film as described in any of [1], [2], [4] to [6] and [8] to [12] above, which comprises a retardation developer.

[14] A polarizing plate, which comprises:

a polarizing film; and

a pair of protective films sandwiching the polarizing film,

wherein at least one of the pair of protective films is an optical film as described in any of [1], [2], [4] to [6] and [8] to [13] above.

[15] A liquid crystal display device, which comprises an optical film as described in any of [1], [2], [4] to [6] and [8] to [13] above or a polarizing plate as described in [14] above.

[16] A liquid crystal display device, which comprises a polarizing plate as described in [14] above,

wherein the liquid crystal display device is of IPS-mode, OCB-mode or VA-mode.

[17] A VA-mode liquid crystal display device, which comprises a polarizing plate as described in [14] above on a backlight side.

[18] An optical film, which has a coefficient of linear thermal expansion in a longitudinal direction of the optical film and a coefficient of linear thermal expansion in a width direction approximately orthogonal to the longitudinal direction,

wherein a value obtained by dividing smaller one of the two coefficients of linear thermal expansion by greater one of the two coefficients is from 0.1 to 0.5.

[19] The optical film as described in [18] above,

wherein one of the two coefficients of linear thermal expansion in the longitudinal direction of the optical film and the width direction approximately orthogonal to the longitudinal direction is 42 or below and the other is 80 or above.

[20] The optical film as described in [18] or [19] above,

wherein values of in-plane retardation Re and thickness-direction retardation Rth at wavelengths 450 nm, 550 nm and 650 nm satisfy the following relations (I) to (III):

0.4<{(Re(450)/Rth(450))/(Re(550)/Rth(550))}<0.95 and

1.05<{(Re(650)/Rth(650))/(Re(550)/Rth(550))}<1.9 Relation (I)

0.1<(Re(450)/Re(550))<0.95 Relation (II)

1.03<(Re(650)/Re(550))<1.93 Relation (III)

wherein Re(λ) represents an in-plane retardation Re value, expressed in the unit nm, at a wavelength λ nm; and

Rth(λ) represents a thickness-direction retardation Rth value, expressed in the unit nm, at a wavelength λ nm.

[21] A method of manufacturing an optical film, which comprises:

stretching a film; and

shrinking a film,

wherein an ending temperature of the stretching is adjusted to a range of (crystallization temperature of the optical film −10° C.) to (crystallization temperature of the optical film +10° C.).

[22] The optical film as described in any of [18] to [20] above, which is produced by a method as described in [21] above.

[23] The optical film as described in any of [18] to [20] and [22] above, which comprises a cellulose acylate.

[24] The optical film as described in [23] above, wherein all acyl substitutents in the cellulose acylate are acetyl groups and a total degree of acyl substitution is from 2.56 to 3.00.

[25] The optical film as described in [23] or [24] above, wherein substitution degrees of hydroxyl groups with acyl groups at 2-, 3- and 6-positions of a glucose unit in the cellulose acylate satisfy the following relations (IV) and (V):

2.0≦(DS2+DS3+DS6)≦3.0 Relation (IV)

DS6/(DS2+DS3+DS6)≧0.315 Relation (V)

wherein DS2 represents an acyl substitution degree on the 2-position hydroxyl group;

DS3 represents an acyl substitution degree on the 3-position hydroxyl group; and

DS6 represents an acyl substitution degree on the 6-position hydroxyl group.

[26] The optical film as described in [23] or [25] above,

wherein acyl substitutents of the cellulose acylate comprises at least two of acetyl, propionyl, butanoyl and benzoyl groups, and a total degree of acyl substitution is from 2.50 to 3.00

The optical film as described in any of [18] to [20] and [22] to [26] above, which comprises a retardation developer.

[28] A polarizing plate, which comprises:

a polarizing film; and

a pair of protective films sandwiching the polarizing film,

wherein at least one of the pair of protective films is an optical film as described in any of [18] to [20] and [22] to [27] above.

[29] A liquid crystal display device, which comprises an optical film as described in any of [18] to [20] and [22] to [27] above or a polarizing plate as described in [28] above.

[30] A liquid crystal display device, which comprises:

a pair of polarizing plates; and

a liquid crystal cell between the pair of polarizing plates,

wherein at least one of the pair of polarizing plates is a polarizing plate as described in [28] above, and the liquid crystal display device is of IPS-mode, OCB-mode or VA-mode.

[31] A VA-mode liquid crystal display, which comprises a polarizing plate as described in [28] above on a backlight side.

The invention is accomplished on the basis of findings obtained from our intensive studies and, by use of the cellulose acylate film specified in the invention, viewing angle compensation in a black-display state, notably of a VA-mode, IPS-mode or OCB-mode liquid crystal display device, is made possible at almost all wavelengths. As a result, the liquid crystal display devices according to the invention are reduced in light leakage in oblique directions at black-display time and significantly improved in dependency of contrast on viewing angle. Moreover, in the present liquid crystal display devices, light leakage in oblique directions at black-display time can be suppressed over the nearly full range of wavelengths of visible radiation, so color drift dependent on the viewing angle at black-display time, which has so far been a problem, is improved noticeably.

In addition, the liquid crystal display devices utilizing the present polarizing plates is prevented from causing unevenness on the perimeter of the screen by drastic changes in ambient temperature and humidity, and can retain excellent display performance even when used under all environmental conditions.

Furthermore, the liquid crystal display devices utilizing films or/and polarizing plates according to the invention are reduced in panel warpage resulting from environmental changes, so they can keep excellent display performance even when their environments are changed.

### BRIEF DESCRIPTION OF THE DRAWINGS

FIG. 1 illustrates a diagrammatic sketch for explaining a configuration example of a VA-mode liquid crystal display device currently in use;

FIG. 2 illustrates a diagrammatic sketch for explaining a configuration example of a VA-mode liquid crystal display device currently in use;

FIG. 3 illustrates a diagrammatic sketch for explaining a configuration example of a liquid crystal display device according to an aspect of the invention;

FIG. 4 illustrates a graph showing optical characteristics of an exemplary example of an optical compensation film used in the invention;

FIG. 5 illustrates a schematic diagram of a Poincaré sphere used for illustrating a change in polarized state of light entering into a liquid crystal display device according to an aspect of the invention;

FIG. 6 illustrates a schematic diagram of a Poincaré sphere used for illustrating a change in polarized state of light entering into an example of a liquid crystal display device currently in use;

FIG. 7 illustrates a diagram showing schematically another exemplary example of the cross-section structure of a polarizing plate according to an aspect of the invention; and

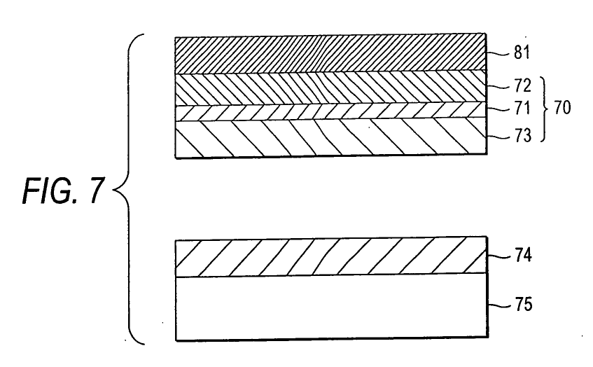

FIG. 8 illustrates a diagram showing a configuration example of a liquid crystal display device according to an aspect of the invention,

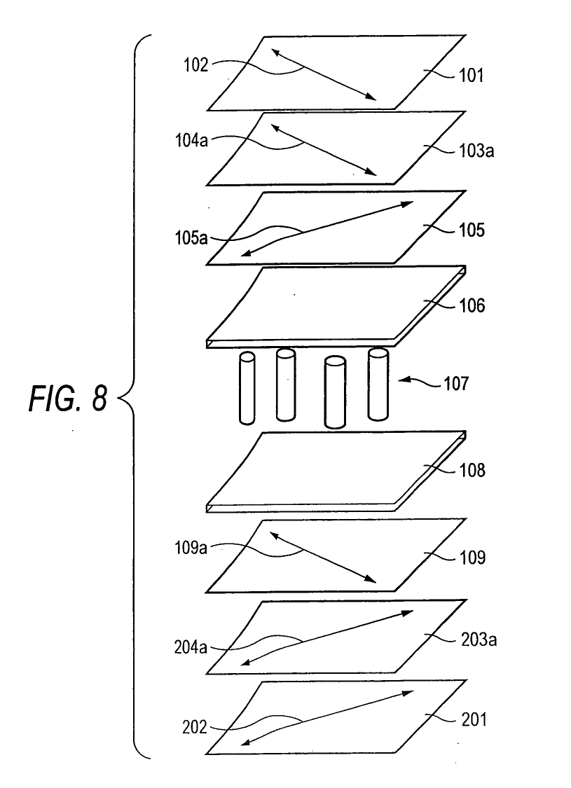

wherein 70 denotes polarizing plate; 71 denotes polarizer; 72 and 73 denote protective films; 81 denotes functional film; 101 denotes polarizing film; 102 denotes absorption axis; 103a denotes protective film; 104a denotes in-plane slow axis; 105 denotes optical compensation film; 105a denotes in-plane slow axis; 106 denotes substrate; 107 denotes liquid crystal molecule; 108 denotes substrate; 109 denotes optical compensation film; 109a denotes in-plane slow axis; 203a denotes protective film; 204a denotes in-plane slow axis; 201 denotes polarizing film; and 202 denotes absorption axis.

### DETAILED DESCRIPTION OF THE INVENTION

The terms “45°”, “parallel” and “orthogonal” as used in the specification are intended to include angles in a range of each individually exact angle plus 5° to each individually exact angle minus 5°. The tolerances on those exacting angles are preferably less than ±4°, far preferably less than ±3°. As to the angles specified herein, the plus sign means a clockwise direction, and the minus sing means a counterclockwise direction. The term “slow axis” as used herein means the direction in which the refractive index becomes maximum. The term “visible region” as used herein refers to a region from 380 nm to 780 nm. The wavelength at which the refractive index is measured is λ=550 nm in the visible region unless otherwise specified.

The term “a polarizing plate” as used in the present specification, unless otherwise noted, is intended to include both a long length of polarizing plate and a polarizing plate cut in a size suitable for incorporation into a liquid crystal device (the word “cut” as used in the present specification is intended to include “stamp” and “cut up into”). In addition, the term “a polarizing plate” is used in the present specification as distinguished from the term “a polarizing film”, and the term “a polarizing plate” means a laminate having “a polarizing film” and a transparent protective film provided on at least one side of the polarizing film for the purpose of protecting the polarizing film.

Re(λ) and Rth(λ) in the present specification are an in-plane retardation and a thickness-direction retardation at the wavelength λ, respectively. The Re(λ) is a value measured with KOBRA 21ADH or WR (made by Oji Scientific Instruments) wherein light with a wavelength of λ nm is made to strike upon a film in the direction of the normal to the film surface.

When the film to be measured is represented by a uniaxial or biaxial index ellipsoid, the Rth(λ) can be calculated in the following manner.

Six values of Re(λ) are measured under conditions that the in-plane slow axis (judged by use of KOBRA 21ADH or WR) is taken as an axis of tilt (rotation axis), or any of in-plane directions is taken as a rotation axis when the film has no slow axis, and light with a wavelength of λnm is made to strike on the film from each of directions tilting in steps of 10° from 0 to +50° with respect to the direction of the normal to one side of the film. And KOBRA 21 ADH or WR calculates the value of Rth(λ) on a basis of these retardation values measured, an assumed value of average refractive index and a thickness value input.

In the above calculation, when a film to be measured has a direction in which the retardation value becomes zero at some tilt angle from the normal direction under a condition that the in-plane slow axis is taken as a rotation axis, the retardation values measured at tilt angles greater than the aforesaid tilt angle are changed in their signs to minus signs, and then subjected to calculations with KOBRA 21ADH or WR.

Alternatively, Rth can be calculated as follows: The slow axis is taken as an axis of tilt (rotation axis), or any of in-plane directions of a film is taken as a rotation axis when the film has no slow axis, and retardation values are measured from two different directions with arbitrary tilt angles. Based on these retardation values, an assumed value of average refractive index and a input thickness value, the Rth is calculated from the following equations (1) and (2).

$$Re ( θ ) = [ nx - \frac{ny \times nz}{\sqrt{{( ny sin ( {sin}^{- 1} ( \frac{sin ( - θ )}{nx} ) ) )}^{2} + {\{ n2 cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad Equation ( 1 ) :$$

In the above equation (1), Re(θ) represents a retardation value in the direction tilting by an angle θ from the normal direction, nx represents an in-plane refractive index in the direction of the slow axis, ny represents an in-plane refractive index in the direction orthogonal to nx, and nz represents a refractive index in the direction orthogonal to nx and ny.

Rth=((nx+ny)/2−nz))×d Equation (2)

When the film to be measured is a film which cannot be represented by a uniaxial or biaxial index ellipsoid, namely a film devoid of an optic axis, the Rth(λ) can be calculated in the following manner.

Eleven values of Re(λ) are measured under conditions that the in-plane slow axis (judged by use of KOBRA 21ADH or WR) is taken as an axis of tilt (rotation axis) and light with a wavelength of λ nm is made to strike on the film from each of directions tilting in steps of 10° from −50° to +50° with respect to the direction of the normal to the film. And KOBRA 21 ADH or WR calculates the value of Rth(λ) on a basis of these retardation values measured, an assumed value of average refractive index and a thickness value input.

As the assumed values of average refractive indices in the above measurements, those listed in Polymer Handbook (JOHN WILEY & SONS, INC) and catalogs of various optical films can be utilized. The average refractive indices of optical films can be measured with an Abbe refractometer even when they are unknown yet. The values of average refractive indices of major optical films are enumerated below: Cellulose acylate (1.48), cycloolefin polymer (1.52), polycarbonate (1.59), polymethyl methacrylate (1.49) and polystyrene (1.59). By inputting these assumed average refractive indices and film thicknesses, KOBRA 21ADH or WR calculates values of nx, ny and nz. From these nx, ny and nz calculated, Nz=(nx−nz)/(nx−ny) is further calculated.

It forms a feature of the invention to impart cellulose acylate film an optical characteristic that the wavelength dispersions with respect to the retardation differ between the incident light from the normal direction and that from an oblique direction slanting off from the normal direction, e.g., the direction with a polar angle of 60 degrees and to use positively such a cellulose acylate film for optical compensation. The scope of the invention is not limited by the display mode of a liquid crystal layer, but the films according to the invention can be used in liquid crystal display devices of all display modes, including a VA mode, an IPS mode, an ECB mole, a TN mode and an OCB mode.

Embodiments of the present optical film include Optical Film I, Optical Film II and Optical Film III. These films are described below in detail.

### (Optical Film I of the Invention)

The Optical Film I of the invention relates to a film characterized in that a value obtained by dividing smaller one of two photoelastic coefficients in a longitudinal direction of the film and a direction approximately orthogonal thereto (i.e. width direction of the film) by greater one of the two coefficients is 0.8 or below.

When a polarizing plate which is made through the use of a film having the aforesaid characteristic is utilized in a liquid crystal TV set, the unevenness on the perimeter of the screen, which has been a problem in recent years, can be suppressed.

The wording “unevenness on the perimeter of the screen” means a phenomenon that a polarizing plate causes a dimensional change when exposed to drastic changes in ambient temperature and humidity and thereby light leakage occurs from the perimeter of the screen to result in localized changes (unevenness) of contrast and hue.

As a result of our intensive study, it has been found that a degree of light leakage is proportional to the dimensional change of a polarizing plate, and the light leakage is attributable to stress produced in adhesives and a cell-side protective film for the polarizing plate by the dimensional change of the polarizing plate.

Our further finding is that the dimensional change of a polarizing plate in a state of being stuck on a liquid crystal panel is greater in the transmission-axis direction than in the absorption-axis direction.

More specifically, when the present optical film is used as a cell-side protective film for the polarizing plate, of its longitudinal direction and the direction approximately orthogonal thereto, a direction in which the film is smaller in photoelastic coefficient is adjusted to be parallel to the transmission axis direction of the polarizing plate, and thereby light leakage occurring under the influence of the film can be suppressed.

In order to suppress the light leakage showing up when the polarizing plate is viewed from an oblique direction, as mentioned above, it is required to arrange the transmission axis of the polarizer and the in-plane slow axis of the cellulose acylate film in parallel to each other and, as the transmission axis of the polarizer which is manufactured continuously in the form of roll film is generally parallel to the width direction of the roll film, it is preferable that the present film is made so as to have a slow axis in the transport direction by stretching film in the transport direction and shrinking film in a direction approximately orthogonal thereto.

In the present optical film, the value obtained by dividing smaller one of two photoelastic coefficients in a longitudinal direction of the film and a direction approximately orthogonal thereto by greater one of the two coefficients is preferably not greater than 0.7 and not smaller than 0.2, and far preferably not greater than 0.6 and not smaller than 0.3.

From the viewpoint of reducing a change caused in tint of a liquid crystal display device with the lapse of time, it is preferable that the photoelastic coefficient is 50×10⁻¹³ cm²/dyn (5×10⁻¹¹ m²/N) or below. Incidentally, the photoelastic coefficient is determined as follows: Tensile stress is applied to the long axis of a film sample measuring 10 mm×100 mm, the retardation Re under this tensile stress is measured with an ellipsometer (M150, made by JASCO Corporation), and the photoelastic coefficient is calculated from the amount of change in retardation with respect to the stress.

In the present manufacturing method, as mentioned above, a film large in thermal shrinkage is employed, and the film employed is subjected to a stretching process and a shrinking process. According to this manufacturing method, the rate of shrinkage in the shrinking process can be heightened, so it is possible to obtain a film high in anisotropy of film's in-plane photoelastic coefficient. In order to enhance anisotropy of the in-plane photoelastic coefficient, it can be thought to adopt a method of raising a stretch ratio in either of film's longitudinal direction or a direction approximately orthogonal thereto, or a method of raising film's photoelastic coefficient in the longitudinal direction and the rate of shrinkage in either of the film's longitudinal direction or a direction approximately orthogonal thereto. According to the former method in which the stretch ratio is raised, too great stretch ratio tends to cause a rupture of the film. Therefore, it is preferred to adopt the latter method in which the rate of shrinkage is raised.

### (Manufacturing Method of Optical Film I of the Invention)

As a result of our intensive study, it has been found that Optical Film I having the favorable optical properties as mentioned above can be obtained through the use of a manufacturing method characterized by including a stretching process for stretching film and a shrinking process for shrinking film.

In the case of using film which is apt to thermal shrinkage in particular, the rate of shrinkage in the shrinking process can be increased, and it is possible to increase in-plane anisotropy of the film even under the same stretch ratio. And we have also found that such a thermal shrinkage-prone film can be obtained by slow drying of film on the support after casting.

And we have further found that the film having a great in-plane anisotropy can be great in anisotropy of photoelastic coefficient.

The method which can be particularly preferably adopted in the invention for manufacturing the optical film is a method characterized by including a stretching process of stretching film in a transport direction of the film and a shrinking process of shrinking the film in a direction approximately orthogonal to the transport direction while grasping the film, or a method characterized by including a shrinking process of shrinking film in a transport direction of the film and a stretching process of stretching the film in a direction approximately orthogonal to the transport direction.

The method of manufacturing an optical film in the case of employing a stretching process of stretching film in a transport direction of the film and a shrinking process of shrinking the film in the width direction of the film while grasping the film is explained first.

In this case, the film employed is stretched in the transport direction thereof, and the method adopted preferably for stretching the film in its transport direction is a method of installing a plurality of rolls whose circumferential velocities are changed by degrees and stretching film longitudinally between rolls by utilizing differences in circumferential velocity between a plurality of rolls. As another method which can be preferably adopted, there is a method of performing film formation in a solution casting process under conditions that the casting over a stainless steel band or drum is carried out and the film brought to a semi-dried state is stripped off and wound into a roll while adjusting roller speeds for transport of the film to make a take-up speed of the film higher than a strip-off speed of the film.

By transporting film while grasping the both edges of the film with a device referred to as a tenter having fastenings such as clips or pins in a direction approximately orthogonal to the transport direction, and lessening the width of the tenter gradually, it becomes possible to shrink the film in the direction approximately orthogonal to the stretch direction of the film.

Alternatively, it is possible to shrink film in the orthogonal direction by grasping the film with a tenter working in directions of two axes, namely a transport direction of the film and a direction approximately orthogonal thereto, such as a tenter of chain type, screw type, pantograph type or linear motor type, and lessening the tenter width gradually as the film is stretched by widening a spacing between clips gradually in the transport direction.

Then, the method of manufacturing an optical film in the case of employing a shrinking process of shrinking film in a transport direction of the film and a stretching process of stretching the film in a direction approximately orthogonal thereto is explained.

In this case, the film employed is shrunken in the transport direction thereof, and the method adopted preferably for shrinking the film in its transport direction is a method of installing a plurality of rolls whose circumferential velocities are changed by degrees and shrinking film longitudinally between rolls by utilizing differences in circumferential velocity between a plurality of rolls. More specifically, rolls placed on the downstream side of the transport are decreased in circumferential velocity, and at this time the film is heated so as to reach a temperature of its Tg or above, thereby undergoing thermal shrinkage. By utilizing this thermal shrinkage, it becomes possible to shrink the film in the transport direction.

On the other hand, it is possible to stretch the film in the direction approximately orthogonal to the shrink direction of the film by transporting film as the both edges of the film are grasped with a device referred to as a tenter equipped with fastenings such as clips or pins in a direction approximately orthogonal to the transport direction, and widening the width of the tenter gradually.

Alternatively, it is possible to shrink film by grasping the film with a tenter working in directions of two axes, namely a transport direction of the film and the direction of the film width, such as a tenter of chain type, screw type, pantograph type or linear motor type, and lessening a spacing between clips gradually in the transport direction as the film is stretched in a direction approximately orthogonal to its transport direction.

The stretching process and the shrinking process as mentioned above, wherein differences in circumferential velocity between rolls and a tenter are utilized, can be performed sequentially in either the order of stretching-shrinking or the order of shrinking-stretching.

In the method of using a tenter working in the directions of two axes, namely transport and width directions of the film, it is possible to perform at least part of the stretching process and at least part of the shrinking process simultaneously.

As a result of our study, it has been found that such a simultaneous processing can have an advantage that unevenness of in-plane stretching and in-plane shrinking of film, which is referred to as “bowing”, is easy to reduce by adjusting the timing, scaling factors and speeds of stretching and shrinking.

Additionally, as stretching apparatus for executing a stretching process in which film is stretched in one of two directions, or the longitudinal direction of the film and a direction approximately orthogonal thereto, and simultaneously shrunken in the other direction and, at the same time, increased in film thickness, a stretching machine FITZ made by ICHIKIN can be preferably used.

A detailed description of such a machine can be found in JP-A-2001-38802.

The rate of stretch in the stretching process and the rate of shrinkage in the shrinking process can be arbitrarily chosen as appropriate according to the intended values of in-plane retardation Re and thickness-direction retardation Rth, but it is preferable that the rate of stretch in the stretching process is adjusted to 10% or above and the rate of shrinkage in the shrinking process is adjusted to 5% or above.

The term “rate of stretch” as used in the invention refers to a proportion of the stretch of film length in a stretch direction after a stretching process to the film length in the stretch direction before the stretching process, and the term “rate of shrinkage” as used in the invention refers to a proportion of the shrinkage of film length in a shrink direction after a shrinking process to the film length in the shrink direction before the shrinking process.

The rate of stretch is preferably from 10 to 45%, particularly preferably from 15 to 35%, while the rate of shrinkage is preferably from 5 to 40%, particularly preferably from 10 to 30%.

From the viewpoint of achieving the desired optical characteristics, it is preferable that the stretching and shrinking processes are carried out at a temperature 25 to 100° C. higher than the glass transition temperature of the film under processing.

It is preferable that the film manufactured in accordance with the present manufacturing method satisfies the following relation (A).

10≧|Rth(550)_{10%RH}−Rth(550)_{60%RH}| (A)

Herein, Rth(550)_{10%RH} and Rth(550)_{60%RH} stand for values of Rth(550) at 25° C.-10% RH and 25° C.-60% RH, respectively.

More specifically, the foregoing relation (A) means that the absolute value of a difference between the value of thickness-direction retardation Rth(λ) measured under the 25° C.-60% RH condition and that measured under the 25° C.-10% RH condition is preferably 10 nm or below.

The absolute value of the foregoing difference, namely the difference between the measurement values of thickness-direction retardation Rth under 25° C.-60% RH and 25° C.-10% RH conditions, is far preferably 5 nm or below.

Furthermore, it is preferable that the stretching and shrinking processes are carried out at a temperature 30° C. to 90° C. higher, particularly 40° C. to 80° C. higher, than the glass transition temperature of the film at the time of starting the stretch-and-shrink processing.

Measurement of a glass transition temperature in the invention is made in the following manner.

A cellulose acylate film sample (undergoing no stretching) measuring 5 mm×30 mm in size is subjected to moisture control for at least 2 hours in the 25° C.-60% RH atmosphere, and then examined for Tg using a dynamic viscoelasticity measuring equipment (Vibron DVA-225, made by I.T. Keisoku Seigyo K.K.) at settings that the intergrip distance is 20 mm, the speed of rising in temperature is 2° C./min, the temperature range of measurement is from 30° C. to 200° C. and the frequency is 1 Hz. When the storage elasticity modulus is plotted as ordinate with a logarithmic scale and the temperature (° C.) as abscissa with a linear scale, the temperature at which a sharp reduction in storage elasticity modulus is seen at the occasion of transfer from the solid region to the glass transition region is taken as a glass transition temperature Tg. More specifically, on the chart obtained, a straight line 1 is drawn in the solid region, a straight line 2 is drawn in the glass transition region, and the intercept of the straight line 1 and the straight line 2 is defined as a glass transition temperature Tg (dynamic viscoelasticity) because it corresponds to a temperature at which the film sample begins softening by sudden decrease in the storage elasticity modulus under rise in temperature and the transfer to the glass transition region starts.

The term “processing temperature” refers to the temperature of film surface measured with a noncontact infrared thermometer.

The invention can be implemented by wet stretching in which the film formed by solution casting is stretched in the course of drying. Alternatively, the film after completion of drying may be subjected to continuous stretch processing, or once wound into a roll and then subjected to stretch processing separately. In addition, the invention may be applied to stretching of film formed in a substantially solvent-free melting process. The film may be stretched or shrunken in one step or multiple steps. When the stretching is carried out in multiple steps, the product of stretch ratios in multiple steps may be adjusted to fall within the preferable range mentioned above.

The suitable stretch speed is from 5% per minute to 1,000% per minute, preferably from 10% per minute to 500% per minute. And it is preferable to perform the stretching with the aid of a heat roll or/and a radiant heat source, or hot air.

In order to obtain film susceptible to thermal shrinkage, it is of great value to carry out the drying prior to stretching and shrinking processes with a slow pace. And a great effect can be achieved particularly when the film in a state of being spread over a support is dried gradually.

Since a long time is required for drying when the temperature for drying before stretching and shrinking processes is low, plane orientation of polymer molecules in film advances, and the finished film causes great thermal shrinkage at temperatures higher than or equal to its glass transition temperature. The temperature suitable for drying is from 40° C. to 60° C., preferably from 40° C. to 55° C., particularly preferably from 40° C. to 50° C.

And the time for drying is preferably from 3 minutes to 20 minutes, far preferably from 3 minutes to 15 minutes, further preferably from 3 minutes to 10 minutes.

### (Optical Film II of the Invention)

In the next place, Optical Film II of the invention is described in detail.

The present Optical Film II relates to an optical film in which a value obtained by dividing greater one of two velocities of sound in a longitudinal direction of the film and a direction approximately orthogonal thereto (i.e. width direction of the film) by smaller one of the two velocities is 1.1 or above. Incidentally, in this specification, the velocity of sound propagating through a film medium is simply referred to as “velocity of sound in film”.

When a polarizing plate made in using the film having such a characteristic is employed in a liquid crystal TV set, the unevenness on the perimeter of the screen, which has been a problem in recent years, can be suppressed.

The unevenness on the perimeter of the screen is a phenomenon that a polarizing plate causes a dimensional change when exposed to drastic changes in ambient temperature and humidity and thereby light leakage occurs from the perimeter of the screen to result in lowering of image contrast and localized change in hue (unevenness of color). Our intensive study has resulted in a finding that a degree of light leakage is proportional to dimensional changes induced in a polarizing plate and a cause of the unevenness on the perimeter is attributable to stress produced in adhesives and a cell-side protective film of the polarizing plate by such dimensional changes in the polarizing plate.

Our further finding is that polarizing plates currently in use suffer dimensional changes greater in their transmission-axis directions than in their absorption-axis directions. Such dimensional changes are associated with the stretch direction of PVA used as a polarizer in the polarizing plates. More specifically, in the absorption-axis direction parallel to the stretch direction, the degree of PVA alignment is heightened by stretching (in other words, PVA density is increased) and resistance to dimensional change becomes high, while a decrease in resistance to dimensional change is brought about in the transmission-axis direction since this axis direction is orthogonal to the direction of PVA alignment.

On the other hand, when the present film is used as a protective film of the polarizing plate, the protective film is laminated so that the TD direction great in the velocity of sound in the film (which means a high density) and resistant to dimensional change becomes parallel to the transmission-axis direction in which the polarizing plate tends to suffer dimensional changes, and thereby a dimensional change in the transmission-axis direction of the polarizing plate can be suppressed and the light leakage can be inhibited.

The value obtained by dividing greater one of two velocities of sound in the longitudinal direction of the film and a direction approximately orthogonal thereto by smaller one of the two velocities is preferably 1.2 or above, particularly preferably 1.3 or above.

Herein, it is preferable that the velocity of sound is greater in the TD direction as the width direction of the film.

A reason for such a preference is as follows: For the purpose of controlling the light leakage when the polarizing plate is viewed from an oblique direction, as mentioned above, it is required to arrange the transmission axis of a polarizer in parallel to the in-plane slow axis of cellulose acylate film and, since the transmission axis of a polarizer manufactured continuously into a roll film is generally parallel to the width direction of the roll film, it is preferred in the invention to make film having a slow axis in the TD direction (higher anisotropy in the TD direction) through processes of stretching in the TD direction and shrinking in the MD direction.

Additionally, the velocity of sound in the present film is preferably from 1.4 to 3.0 km/sec, far preferably from 1.5 to 2.9 km/sec, further preferably from 1.6 to 2.8 km/sec.

The term “velocity of sound” as used herein refers to the propagation velocity of sonic waves. For determination thereof, a film sample is fully humidity-conditioned under circumstances of 25° C. and 60% RH and a sound wave meter (e.g., SST-110 made by Nomura Shoji Co., Ltd.) is used under the same circumstances, and thereby the propagation velocity of longitudinal wave oscillations of ultrasonic pulses along the MD direction (the longitudinal direction at the time of making) or the TD direction (the width direction at the time of making) of the film is measured.

The high anisotropy in the TD direction and the high orientation degree of film in the TD direction are derived from the same root. In general, the direction in which the orientation degree is high is a direction in which the polymer density in the film becomes high as well and the value of sound velocity becomes great.

### (Manufacturing Method of Optical Film II of the Invention)

As a result of our intensive study, it has been found that an optical film having the favorable optical properties as mentioned above can be obtained through the use of a manufacturing method characterized by including a stretching process for stretching film and a shrinking process for shrinking film.

In addition, it has been found that, when the optical film in which the ratio between a sound velocity in film's TD direction C(TD) and a sound velocity in film's MD direction C(MD), or C(TD)/C(MD), is adjusted to 1.2 or above, is used as a protective film of a polarizing plate, a liquid crystal display device using such a polarizing plate can resist developing unevenness on the perimeter of its screen even when undergoes drastic changes in temperature and humidity and can retain excellent display performance even when used under all environmental conditions.

The method used to particular advantage for manufacturing the optical film in the invention is a manufacturing method characterized by including a stretching process of stretching film in a transport direction of the film and a shrinking process of shrinking the film in a direction approximately orthogonal to the transport direction while grasping the film, or a manufacturing method characterized by including a shrinking process of shrinking film in a transport direction of the film and a stretching process of stretching the film in a direction approximately orthogonal to the transport direction.

As to the details of these manufacturing methods, the same conditions as specified in the foregoing descriptions of the manufacturing methods for Optical Film I can be adopted unless otherwise noted, and similar comments can apply to the preferred conditions.

In the manufacturing method of the present Optical Film II in particular, it is preferable that the shrink speed is adjusted to a range of 10 to 100%/min, particularly 15 to 95%/min. When the shrink speed is low, the main chain of polymer in the film which is oriented to the stretch direction comes to undergo thermal relaxation to result in impairment of optical properties, and besides, the manufacturing suitability is poor. Therefore, it is preferable to shrink film at a speed of 10%/min or above. When the shrink speed is too high, on the other hand, the film cannot catch up with a shrink request and forms wrinkles. So, it is preferable that the film is shrunken at a speed of 100%/min or below. In other words, adjustment of the shrink speed to the range of 10 to 100%/min can raise the relaxation rate in the direction orthogonal to the stretch direction without causing relaxation in the stretch direction and making wrinkles in the film.

In addition, when the film is manufactured by the foregoing method, the anti-stretch relaxation rate can be raised, and the film manufactured can have greater orientation anisotropy in the stretch direction.

### (Optical Film III of the Invention)

The present Optical Film III is characterized in that a value obtained by dividing smaller one of two coefficients of linear thermal expansion in a longitudinal direction of the film and a width direction approximately orthogonal to the longitudinal direction by greater one of the two coefficients is from 0.5 to 0.1.

Of two coefficients of linear thermal expansion in a longitudinal direction of the film and a width direction approximately orthogonal to the longitudinal direction, the value obtained by dividing the smaller one by the greater one is preferably from 0.5 to 0.2, far preferably from 0.5 to 0.25.

As a result of our intensive study, to our surprise, it has been found that the panel warpage traceable to environmental changes which a liquid crystal panel undergoes after lamination with film made into a polarizing plate can be improved when a value obtained by dividing smaller one of two coefficients of linear thermal expansion in a longitudinal direction of the film and a width direction approximately orthogonal to the longitudinal direction by greater one of the two coefficients is adjusted to the range specified above. This adjustment can achieve its effect remarkably when the optical film is used on either side of the liquid crystal cell. As a reason for such effect, it may be supposed that the balance of warping stress caused by environmental changes is attained properly between the front side and the rear side.

In addition, of the two coefficients of linear thermal expansion in the longitudinal direction and the width direction, one coefficient is preferably 42 or below, and the other is preferably 80 or above.

Furthermore, the linear thermal expansion coefficient (B) which the present optical film has in a direction approximately orthogonal to its longitudinal direction is preferably from 42 to 2, far preferably from 35 to 3, further preferably from 30 to 5. On the other hand, the linear thermal expansion coefficient (A) which the present film has in its longitudinal direction is preferably from 80 to 300, far preferably from 90 to 250. By uniting the film having such characteristics and a liquid crystal panel so that the width direction of the film aligns parallel to the long-axis direction of the liquid crystal panel, the warpage occurring in the liquid crystal panel by environmental changes is further improved noticeably. Herein, the term “longitudinal direction” refers to the take-up direction of film wound into a roll.

As an example of a method for measuring thermal expansion coefficients, the following method can be given. Specifically, a film sample having a width of 3 mm and a length of 35 mm (in a measurement direction) is cut off. The sample is subjected to moisture control for at least 3 hours in the 25° C.-60% RH atmosphere. Then, measurements are made on the sample by using TMA 2940 (a thermal mechanical analyzer, made by TA Instruments) at the settings that the spacing between chucks is 25.4 mm, the temperature rise condition is from 30° C. to 100° C. (3° C./min) and the tension is 0.04 N. A value obtained by subtracting the inter-chuck dimension of the film at 40° C. from the inter-chuck dimension of the film at 80° C., ΔL(80−40) (mm), is determined, and a value ΔL(80−40)/(25.4×40) is calculated for obtaining a thermal expansion coefficient. These measurements are made on equally spaced 10 points along the width direction of the film, and the mean value of the values thus determined is defined as the thermal expansion coefficient of the sample film. And the value obtained by dividing the difference between the maximum and the minimum of the measurement values by the mean value is defined as the dispersion in thermal expansion coefficient values.

### (Manufacturing Method of Optical Film III of the Invention)

As a result of our intensive study, it has been found that Optical Film III contributing to an improvement of panel warpage can be obtained in accordance with an optical film manufacturing method in which a stretching process of stretching film and a shrinking process of shrinking film are included and the stretch ending temperature is adjusted to a range of (crystallization temperature of the film −10° C.) to (crystallization temperature of the film +10° C.).

It is important for the invention to control the stretch ending temperature. It is preferable that the stretching is ended at a temperature ranging from the temperature 10° C. lower than the crystallization temperature of the film after the conclusion of the stretching to the temperature 10° C. higher than the crystallization temperature of the film after the conclusion of the stretching. When the stretching is carried out at temperatures lower than the foregoing temperature range, sufficient stretch ratios cannot be obtained. On the other hand, the stretching carried out at temperatures higher than the foregoing range causes undesirable changes in optical properties by crystallization.

In the invention, the expression “starting time of a shrinking process” refers to the time at which a shrink processing starts physically by application of a force to film, and the expression “ending time of a shrinking process” refers to the time at which the shrink processing is ended physically by stopping the application of the force to the film. In a like manner, the expression “starting time of a stretching process” refers to the time at which a stretch processing starts physically by application of a force to film, and the expression “ending time of a stretching process” refers to the time at which the stretch processing is ended physically by stopping the application of the force to the film.

The method preferably usable for manufacturing the optical film in the invention is a method including a stretching process of stretching film in a transport direction of the film and a shrinking process of shrinking the film in a direction approximately orthogonal to the transport direction while grasping the film, or a method including a shrinking process of shrinking film in a transport direction of the film and a stretching process of stretching the film in a direction approximately orthogonal to the transport direction.

The manufacturing method of an optical film in the case of including a stretching process of stretching film in a transport direction of the film and a shrinking process of shrinking the film in the width direction of the film while grasping the film is explained first.

In this case, the film employed is stretched in the transport direction thereof, and the method adopted preferably for stretching the film in its transport direction is a method of controlling the speeds of rollers for transporting film so that a take-up speed of the film becomes higher than a strip-off speed of the film.

By transporting film as the both edges of the film are grasped with a tenter and lessening the width of the tenter gradually, it becomes possible to shrink the film in the direction approximately orthogonal to the stretch direction of the film.

More specifically, it is possible to stretch film in the transport direction of the film and at the same time to shrink film in a direction approximately orthogonal to the transport direction by grasping the film with a tenter of, e.g., chain type, screw type, pantograph type or linear motor type and lessening the tenter width gradually as the film is stretched in the transport direction.

On the other hand, in the manufacturing method of an optical film which includes a shrinking process of shrinking film in a transport direction of the film and a stretching process of stretching the film in a direction approximately orthogonal thereto, the film can be shrunken in the transport direction thereof by grasping the film with a tenter of chain type, screw type, pantograph type or linear motor type and lessening a spacing between clips gradually in the transport direction as the film is stretched in a direction approximately orthogonal to its transport direction.

The methods described above are favorable because at least part of the stretching process and at least part of the shrinking process can be carried out simultaneously.

Additionally, as stretching apparatus for executing a stretching process in which film is stretched in either the transport direction of the film or a direction approximately orthogonal thereto, and simultaneously shrunken in the other direction and, at the same time, increased in film thickness, a stretching machine FITZ made by ICHIKIN can be preferably used.

A detailed description of such a machine can be found in JP-A-2001-38802.

The rate of stretch in the stretching process and the rate of shrinkage in the shrinking process can be arbitrarily chosen as appropriate according to the intended values of in-plane retardation Re and thickness-direction retardation Rth, but it is preferable that the rate of stretch in the stretching process is adjusted to 10% or above and the rate of shrinkage in the shrinking process is adjusted to 5% or above.

The term “rate of stretch” as used in the invention refers to a proportion of the stretch of film length in a stretch direction after a stretching process to the film length in the stretch direction before the stretching process, and the term “rate of shrinkage” as used in the invention refers to a proportion of the shrinkage of film length in a shrink direction after a shrinking process to the film length in the shrink direction before the shrinking process.

The rate of stretch is preferably from 10 to 60%, particularly preferably from 20 to 50%, while the rate of shrinkage is preferably from 5 to 40%, particularly preferably from 15 to 35%.

From the viewpoint of achieving the desired optical characteristics, it is preferable that the stretching and shrinking processes are carried out at a temperature 5 to 100° C. higher, particularly 10 to 80° C. higher, than the glass transition temperature of the film under processing.

It is preferable that the film manufactured in accordance with the present manufacturing method satisfies the following relation (A).

10≧|Rth(550)_{10%RH}−Rth(550)_{60%RH}| (A)

Herein, Rth(550)_{10%RH} and Rth(550)_{60%RH} stand for values of Rth(550) at 25° C.-10% RH and 25° C.-60% RH, respectively.

More specifically, the foregoing relation (A) means that the absolute value of a difference between the value of thickness-direction retardation Rth(λ) measured under the 25° C.-60% RH condition and that measured under the 25° C.-10% RH condition is preferably 10 nm or below.

The absolute value of the foregoing difference, namely the difference between the measurement values of thickness-direction retardation Rth under 25° C.-60% RH and 25° C.-10% RH conditions, is far preferably 5 nm or below.

The crystallization temperature of the film is a readout of the temperature at the top of an exothermic peak appearing on the higher temperature side of the glass transition temperature in measurement with DSC (differential scanning calorimeter).

Measurement of a glass transition temperature in the invention is made in the following manner.

A cellulose acylate film sample (undergoing no stretching) measuring 5 mm×30 mm in size is subjected to moisture control for at least 2 hours in the 25° C.-60% RH atmosphere, and then examined for Tg using a dynamic viscoelasticity measuring equipment (Vibron DVA-225, made by I.T. Keisoku Seigyo K.K.) at settings that the intergrip distance is 20 mm, the speed of rising in temperature is 2° C./min, the temperature range of measurement is from 30° C. to 200° C. and the frequency is 1 Hz. When the storage elasticity modulus is plotted as ordinate with a logarithmic scale and the temperature (° C.) as abscissa with a linear scale, the temperature at which a sharp reduction in storage elasticity modulus is seen at the occasion of transfer from the solid region to the glass transition region is defined as a glass transition temperature Tg. More specifically, on the chart obtained, a straight line 1 is drawn in the solid region, a straight line 2 is drawn in the glass transition region, and the intercept of the straight line 1 and the straight line 2 is defined as a glass transition temperature Tg (dynamic viscoelasticity) because it corresponds to a temperature at which the film sample begins softening by sudden decrease in the storage elasticity modulus under rise in temperature and the transfer to the glass transition region starts.

The term “processing temperature” refers to the temperature of film surface measured with a noncontact infrared thermometer.

The stretch processing and the shrink processing may be carried out just after film formation, or they may be carried out after the film is formed and wound into a roll. The stretching may be performed in one step or multiple steps. When the stretching is carried out in multiple steps, the product of stretch ratios in multiple steps may be adjusted to fall within the range mentioned above. The shrinking process also may be carried out in one step or multiple steps.

The stretch speed is preferably from 5% per minute to 1,000% per minute, far preferably from 10% per minute to 500% per minute. And it is preferable to perform the stretching with the aid of a heat roll or/and a radiant heat source (e.g., an IR heater), or hot air. In addition, a constant temperature bath may be installed for enhancing the uniformity of temperature. When uniaxial stretching is carried out by roll stretching, it is preferable that a ratio between an inter-roll distance (L) and a film width (W), or L/W, is from 2.0 to 5.0. The shrink speed is preferably from 5% per minute to 1,000% per minute, far preferably from 10% per minute to 500% per minute. Furthermore, both stretching and shrinking may be performed at constant speeds, or while varying their respective speeds.

Prior to the stretching, a preheating process may be provided. The preheating process may also be provided before the stretching process or the shrinking process as appropriate.

After the stretching process or the shrinking process, heat treatment may further be carried out. It is preferable to perform the heat treatment at temperatures ranging from 20° C. lower than the glass transition temperature of film to 10° C. higher than the glass transition temperature of the film, and the heat treatment time is preferably from 1 second to 300 hours. The heating method may be zone heating or partial heating by use of an IR heater. Both edges of the film may be slit off in the course or end of the process. It is preferable that these slit scraps are recovered and reused as a raw material.

In the manufacturing methods of the invention, the arts described below can be applied as appropriate.

Disclosure of tenters can be found in JP-A-11-077718. More specifically, therein are disclosed the arts of ensuring prevention of deterioration in quality, such as flatness, as seen in the case of increasing the production speed and widening the web in a solution casting method, by appropriate control of the method for blowoff of drying gas, the blowoff angle, the air velocity distribution, the air volume, the temperature difference, the air-volume difference, the ratio between a topside-blowoff air volume and an underside-blowoff air volume, and the use of drying gas with high specific heat.

On the other hand, in JP-A-11-077822 is disclosed the invention in which, for prevention of unevenness from developing, the heat treatment is carried out in a condition that a temperature gradient is given in the width direction of film in a heat relaxation process after a thermoplastic resin film is stretched.

Furthermore, for the purpose of avoiding occurrence of unevenness, in JP-A-4-204503 is disclosed the invention in which the stretching is performed in a condition of adjusting a solvent content in film to a range of 2% to 10% on a solids basis.

In addition, JP-A-2002-248680 discloses the invention in which the curling traceable to a clip bite width is controlled by stretching film with a tenter whose clip bite width D is specified by the relation D≦(33/(log X×log Y)), wherein X stands for a stretch rate (%) and Y stands for a volatile component content, and thereby the film transport after the stretching process is made smooth.

For the purpose of achieving compatibility between high-speed transport of soft film and stretching operations, the invention in which the pins used for fastening film edges in the first half of tenter transport are changed to clips in the second half of tenter transport is disclosed in JP-A-2002-337224.

For purpose of offering simple and easy improvements in viewing angle characteristics and ensuring improved viewing angles in liquid crystal display devices, JP-A-2002-187960 discloses the invention relating to optically biaxial cellulose ester film which is obtained by casting a cellulose ester dope solution over a support for casting use and stretching web (film) stripped off the support for casting use to 1.0 to 4.0 times its original dimension in one direction while the residual solvent content in the web is 100 mass % or below, particularly in the range of 10 to 100 mass %. (In this specification, mass ratio is equal to weight ratio.) Therein are further cited other stretching methods including a method of using a plurality of rolls having different circumferential velocities and performing a longitudinal stretch operation by utilizing circumferential velocity differentials between rolls, a method of performing a longitudinal stretch operation while widening a spacing between clips or pins, with which both edges of web are fastened, in the traveling direction of the web, the method of performing a traverse stretch operation in a manner similar to the above, except that the clip or pin spacing is widened in the traverse direction, a method of performing stretch operations in both longitudinal and traverse directions while simultaneously widening clip or pin spacings in both longitudinal and traverse directions, and a method using a combination of these methods. In addition, it is described that, in the case of using the so-called tenter method, the drive of a clip part by a linear drive system is suitable for smooth stretching and can reduce the risk of rupture.

For the purpose of forming a retardation film reduced in bleedout of an additive, free of a delamination phenomenon, satisfactory in slipping property and superior in transparency, JP-A-2003-014933 discloses the invention which includes preparing dope A containing a resin, an additive and an organic solvent, and dope B containing a resin and an organic solvent and having an additive content of zero or lower than that of the dope A, co-casting the dope A and the dope B over a support so that the dope A forms a core layer and the dope B forms a surface layer, evaporating the organic solvents to such an extent as to allow strip-off of web formed, stripping the web off the support, and further stretching the web to 1.1 to 3.0 times its original dimension in at least one axis direction while the residual solvent content in resin film under stretching is in the range of 3 to 50 mass %. As preferred embodiments of such an invention, the following are described. More specifically, one of preferred embodiments consists in that the stretching of the web stripped-off the support in the invention cited above is carried out at a temperature ranging from 140° C. to 200° C.; another preferred embodiment includes preparing dope A containing a resin and an organic solvent and dope B containing a resin, fine particles and an organic solvent, co-casting the dope A and the dope B over a support so that the dope A forms a core layer and the dope B forms a surface layer, evaporating the organic solvents to such an extent as to allow strip-off of web formed, stripping the web off the support, and further stretching the web to 1.1 to 3.0 times its original dimension in at least one axis direction while the residual solvent content in resin film under stretching is in the range of 3 to 50 mass %; still another embodiment consists in that the stretching of the web stripped-off the support in the above embodiment is carried out at a temperature ranging from 140° C. to 200° C.; a further embodiment includes preparing dope A containing a resin, an additive and an organic solvent, dope B containing a resin and an organic solvent and having an additive content of zero or lower than that of the dope A and dope C containing a resin, fine particles and an organic solvent, co-casting the dope A, the dope B and the dope C over a support so that the dope A forms a core layer, the dope B forms a surface layer and the dope C forms a surface layer on the side opposite to the dope B, evaporating the organic solvents to such an extent as to allow strip-off of the web formed, stripping the web off the support, and further stretching the web to 1.1 to 3.0 times its original dimension in at least one axis direction while the residual solvent content in resin film under stretching is in the range of 3 to 50 mass %; and a still further embodiment consists in that the stretching of the web stripped-off the support in the above embodiment is carried out at a temperature ranging from 140° C. to 200° C. Therein are furthermore described embodiments that the amount of the additive in the dope A is from 1 to 30 mass % based on the resin, the amount of the additive in the dope B is from 0 to 5 mass % based on the resin, the additive is a plasticizer, a ultraviolet absorbent or a retardation control agent and the organic solvents in the dope A and the dope B are solvent mixtures containing methylene chloride or methyl acetate in a proportion of 50 mass % or more of the total organic solvents.

In addition, JP-A-2003-014933 discloses the stretching method in which is preferably used a traverse stretching machine referred to as a tenter which enables traverse stretching by widening in a traverse direction a spacing between clips or pins fastening both edges of web. The document cited also discloses that stretching or shrinking in a longitudinal direction can be performed by using a simultaneous biaxial stretching machine and widening or shortening a spacing between clips or pins in a transport direction. Therein, it is also stated that the drive of a clip part by a linear drive system is suitable for smooth stretching and can reduce the risk of rupture, and the method usable for longitudinal stretch is a method using a plurality of rolls having different circumferential velocities and performing a longitudinal stretch operation by utilizing circumferential velocity differentials between rolls. Additionally, it is also described that these stretching methods can be used in combination and the stretching operation may be carried out in two or more steps, e.g., in combination of longitudinal stretch, traverse stretch and longitudinal stretch, or in a combination of longitudinal stretch and longitudinal stretch.

For the purpose of preventing web from foaming, improving a departing property of web and making web lint-free in tenter drying, JP-A-2003-004374 discloses the invention in which the dryer in drying apparatus is designed to have a width shorter than the width of web in order to avoid exposure of both edge parts of web to hot air from the dryer.

For the same purpose as described above, JP-A-2003-019757 discloses the invention in which the wind shielding plate is placed on the inside of both edge parts of web so that the holding areas of a tenter is not exposed to drying air.

For the purpose of performing transport and drying consistently, on the other hand, JP-A-2003-053749 discloses the invention wherein the process of drying film while transporting the film in holding both film edges with a pin tenter is performed under a condition that, when the thickness of both edge areas of the film after the drying process is symbolized by X μm and the average thickness of a product area of film after the drying process is symbolized by T μm, the relation of (1) 40≦X≦200 when T≦60, (2) 40+(T−60)×0.2≦X≦300 when 60≦T≦120 or (3) 52+(T−120)×0.2≦X≦400 when 120<T holds between X and T.

For the purpose of avoiding occurrence of wrinkles in the use of a multistage tenter, JP-A-2-182654 discloses the invention which includes placement of a heating room and a cooling room in a multistage tenter and install of a device for separate cooling of clip chains on both edges of web in the cooling room.

For the purpose of further avoiding occurrence of rupture, wrinkle and faulty transport of web, JP-A-9-077315 discloses the invention relating to a pin tenter having a pin arrangement that the pin density is thickened on the inner side in the width direction of web and thinned on the outer side.

For the purpose of avoiding foaming of web itself and adhesion of web to a holding device in a tenter, JP-A-9-085846 discloses the invention relating to a tenter-type drying apparatus in which pins holding the both edges of web are cooled at a temperature lower than the foaming temperature of the web by means of a blowoff-type cooler and, at the same time, pins just before being jammed into the web are cooled to or below the temperature 15° C. higher than the dope's gelling temperature by means of a duct-type cooler.

For the purpose of preventing web from coming off a pin tenter and reducing extraneous matter, JP-A-2003-103542 discloses the invention relating to a solution method for film formation wherein a plug structure of a pin tenter used is cooled so that the temperature of web surface brought into contact with the plug structure is adjusted to be below the gelling temperature of web.

For the purpose of preventing the deterioration caused in quality, such as flatness, by increasing the production speed in a solution casting method and widening the web width by means of a tenter, JP-A-11-077718 discloses the invention in which the drying of web in a tenter is performed under conditions that the air velocity is from 0.5 to 20 (40) m/s, the temperature distribution in the width direction is 10% or below, the ratio between air volumes on the topside and the underside of web is from 0.2 to 1, and the specific heat of a drying gas used is from 30 to 250 J/K mol. In addition, the document cited herein discloses preferred drying conditions depending on the amounts of residual solvent in drying with a tenter. More specifically, during the time period over which the amount of residual solvent in web is decreased to 4 mass % after stripping the web off a support, the web is dried by blowoff of a drying gas under the conditions that the blowoff angle from a blowoff outlet is adjusted to a range of 30° to 150° with respect to the film plane and, when the air velocity distribution on the film surface situated in the extension of a drying-gas blowoff direction is determined with reference to the highest air velocity, the difference between the highest and the lowest of air velocities is controlled within 20% of the highest value. When the amount of residual solvent in the web is from 130 mass % to 70 mass %, the blowoff velocity of drying gas from a blowoff-type drier is adjusted to a range of 0.5 m/sec to 20 m/sec on the web surface. When the amount of residual solvent in the web is from lower than 70 mass % to 4 mass %, the web is dried by a drying gas blowing at a velocity ranging from 0.5 m/sec to 40 m/sec and, when the temperature distribution of the drying gas in the width direction of the web is determined with reference to the highest gas temperature, the difference between the highest and the lowest of gas temperatures is controlled within 10% of the highest value. Furthermore, it is described that, when the amount of residual solvent in the web is from 4 mass % to 200 mass %, the ratio between volumes of drying gases blowing from blowoff outlets placed on the topside and the underside of the traveling web, which is symbolized by “q”, is adjusted to 0.2≦q≦1. As another preferred embodiment, the document cited discloses to use at least one kind of gas as a drying gas and adjust the average specific heat of the drying gas to the range of 31.0 J/K·mol to 250 J/K·mol, or to perform drying by use of a drying gas containing an organic compound in a liquid state at room temperature in a concentration that the compound constitutes 50% or below of the saturated vapor pressure during the drying.

For the purpose of preventing contaminants from developing to impair flatness and coating suitability, JP-A-11-077719 discloses the invention which includes incorporation of heating members in clips of a tenter used for TAC (triacetyl cellulose) manufacturing apparatus. As preferred embodiments, the document cited herein also discloses to provide a device for eliminating extraneous matter developing in clip-to-web contact areas in the period from web release from tenter clips to resumption of web holding with the tenter clips, to eliminate extraneous matter by use of a blast of gas, a jet of liquid or a blush, to control the residual solvent content at the time of contact of web with clips or pins to a range of 12 mass % to 50 mass %, and to adjust the surface temperature of clips or pins at the time of contact with web to a range of 60° C. to 200° C. (preferably 80° C. to 120° C.).

For the purpose of improving flatness of web and deterioration in web quality by rupture in a tenter to enhance productivity, JP-A-11-090943 discloses the invention in which the ratio between an arbitrary transport length Lt (m) of a tenter and the sum total of lengths Ltt (m) of web-holding areas which clips in a tenter of the same length as Lt have in the transport direction, Lr=Ltt/Lt, is controlled so as to satisfy the relation 1.0≦Lr≦1.99. As a preferred embodiment, the document cited herein discloses that the web holding areas are arranged without clearance on viewing from the width direction of web.

For the purpose of improving deterioration in flatness due to slack caused in web at the time of its introduction into a tenter and instability of the introduction, JP-A-11-090944 discloses the invention which includes placement of a device for controlling a slack in the width direction of web in front of the entrance to a tenter installed in plastic film manufacturing apparatus. As a preferred embodiment, the document cited herein discloses that the slack control device is a pair of rollers which are arranged on both sides of web at an angle of 2° to 60° with respect to the traveling direction of web so that they each tilt outwardly to the width direction of web, and besides, which are each rotated so as to pull the web outwardly in the width direction, an aspirator is placed over the top surface of web, and a blower capable of sending air from the underside of web is installed.

For the purpose of avoiding slack in web which causes deterioration in quality and impairs the productivity, JP-A-11-090945 discloses the invention which includes introducing web stripped off a support into a tenter in a condition that the web forms a certain angle with the horizontal plane.

For the purpose of forming film having stable physical properties, JP-A-2000-289903 discloses the invention relating to a transport apparatus that is designed to transport stripped web while applying a tension to the web in the width direction of the web in a period of time over which the solvent content is decreased to 12 mass % from 50 mass %, and that has a web width detector, a web holding device and two or more variable bending points and makes modifications to the positions of the bending points by computations of web widths from signals detected by the web width detector.

For the purpose of obtaining film of excellent quality by enhancing clipping performance and avoiding rupture of web for a long time, JP-A-2003-033933 discloses the invention which includes placing guide plates for avoiding occurrence of curling in edge areas of web at positions situated on at least the underside of the topside and underside of the web, and that, on both right and left sides in the region near the entrance of a tenter, and forming each of the web-facing guide surfaces with a resin part for web contact and a metal part for web contact which are arranged in the web transport direction. As preferred embodiments of such an invention, the following (1) to (12) are disclosed: (1) the web-facing resin part for web contact in each guide plate is disposed on the upstream side of the web transport direction and the web-facing metal part for web contact in each guide plate is disposed on the downstream side of the same direction, (2) the level difference between the resin part for web contact and the metal part for web contact in each guide plate (including the amount of tilting) is within 500 μm, (3) the dimension of the resin part for web contact and that of the metal part for web contact in each guide plate brought into contact with web in the width direction are each in a range of 2 to 150 mm, (4) the dimension of the resin part for web contact and that of the metal part for web contact in each guide plate brought into contact with web in the web transport direction are each in a range of 5 to 120 mm, (5) the resin part for web contact in each guide plate is provided on a metal base plate by surface resin finish or resin coating, (6) the resin part for web contact in each guide plate is made only of resin, (7) the distance between the surfaces of guide plates facing the topside and the underside of web, respectively, and being placed on each of the right and left edge areas of the web is from 3 to 30 mm, (8) the distance between the surfaces of guide plates facing the topside and the underside of the web in each of the right and left edge areas of the web is extended inwardly to the width direction of the web at a rate of at least 2 mm per 100 mm of width, (9) each of the topside and underside guide plates has a length of 10 to 300 mm in each of the right and left edge areas of web, and the topside and underside guide plates are arranged so as to deviate from the superposed position along the web transport direction and the deviation distance between the topside guide plate and the underside guide plate is from −200 to +200 mm, (10) the web-facing surfaces of topside guide plates are made only of resin or metal, (11) the resin part for web contact in each guide plate is made of Teflon (trade name) and the metal part for web contact in each guide plate is made of stainless steel, and (12) the surface roughness of the web-facing surface of each guide plate or the surface roughness of the resin part for web contact and/or the metal part for web contact provided on the web-facing side of each guide plate is 3 μm or below. In addition, the document cited herein discloses that the position for placement of topside and underside guide plates for preventing occurrence of curling in edge areas of web is preferably between the end part of a support at which web is stripped off and the web-introduced part of a tenter, particularly in a region near the entrance of a tenter.

For the purpose of avoiding occurrence of rupture and unevenness of web during drying in a tenter, JP-A-11-048271 discloses the invention which includes stretching and drying web with width stretching apparatus in a time period over which the solvent content in the web after stripping is decreased to 12 mass % from 50 mass %, and besides, applying a pressure of 0.2 to 10 KPa to both sides of the web by means of a pressure device at the time when the solvent content in the web reaches to 10 mass % or below. As preferred embodiments, the document cited herein discloses conclusion of tension application before the solvent content becomes below 4 mass %, use of 1 to about 8 pairs of nip rolls as the pressure device for applying pressure to both sides of the web and application of pressure under temperatures adjusted to a range of 100 to 200° C.

JP-A-2002-036266 relating to an invention for providing high-quality thin TAC having a thickness of 20 to 85 μm discloses as a preferred embodiment thereof a film manufacturing method which includes a web stripping process and a stretching process of stretching stripped web with a tenter wherein a difference between tensions applied to the web along the traveling direction of the web at the entrance to and the exit from the tenter is adjusted to 8 N/mm² or below, and which may further include a preheating process of heating the stripped web before the stretching process and a relaxation process of relaxing the stretched web by a quantity less than the elongation gained by the stretching process.

For the purpose of providing a film having a dry thickness of 10 to 60 μm which can contribute to reduction in thickness and size, and having small moisture permeability and excellent durability, JP-A-2002-22054 discloses the film manufacturing method in which dry shrinkage control by web-width hold is performed by grasping the both edges of web with clips while the content of residual solvent in the web after stripping is decreased to 10 mass %, and/or stretching is carried out in the width direction, thereby forming a film having an in-plane orientation degree (S) of 0.0008 to 0.002, which is represented by the equation S={(Nx+Ny)/2}−Nz (wherein Nx stands for a refractive index in the direction showing the greatest refractive index in the film plane, Ny stands for a refractive index in the direction perpendicular to the direction showing Nx and Nz stands for a refractive index in a thickness direction of the film), the time between casting and stripping is adjusted to a range of 30 to 90 seconds, or the web after stripping is stretched in the width direction and/or the longitudinal direction.

For the purpose of controlling optical unevenness, JP-A-2002-341144 discloses the solution method for film formation in which a retardation raising agent is incorporated in the web to be stretched in mass concentrations having a distribution that the concentration of the agent becomes higher the closer to the film center in the width direction is the position in which the agent is incorporated.

In JP-A-2003-07186 relating to the invention for forming haze-free film, it is disclosed that the suitable stretch rate in the width direction is from 0 to 100%, and it is preferably from 5 to 20%, far preferably from 8 to 15%, when the film formed is used as the protective film of a polarizing plate. On the other hand, it is also disclosed that the stretch rate is preferably from 10 to 40%, far preferably from 20 to 30%, when the film formed is used as a retardation film, and it is possible to control Ro by stretch rate and higher stretch rates are preferred because the finished film can have more excellent flatness. Furthermore, it is shown that, when the stretching with a tenter is carried out, the amount of residual solvent in the film is preferably from 20 to 100 mass % at the start of tentering and it is preferable to perform a drying operation under tentering until the content of residual solvent in film is reduced to 10 mass % or below, preferably 5 mass % or below.

JP-A-2002-248639 relating to the invention enabling reduction in longitudinal and traverse dimensional changes upon storage under hot and humid conditions discloses the method of manufacturing film by casting a cellulose ester solution over a support to form film, stripping the film off the support continuously and drying, wherein the drying is carried out so as to satisfy the relation 0≦dry shrinkage rate (%)≦0.1×residual solvent content (%) at stripping time. As preferred embodiments, the document cited discloses that, when the residual solvent content in cellulose ester film after stripping is within the range of 40 to 100 mass %, at least 30 mass % reduction in residual solvent content is accomplished by tenter transport carried out while grasping both edges of cellulose ester film; the residual solvent content in stripped cellulose ester film at the entrance of tenter transport is from 40 to 100 mass % and the residual solvent content at the exit is from 4 to 20 mass %; the tension for transport of cellulose ester film by tenter transport is increased in the direction to the exit from the entrance of tenter transport; and the tension for transport of cellulose ester film by tenter transport is made almost equal to the tension in the width direction of cellulose ester film.

For obtaining thin film having excellent optical isotropy and flatness, JP-A-2000-239403 discloses the film formation under a condition that the residual solvent content at the time of stripping (X) and the residual solvent content at the time of introduction into a tenter (Y) are adjusted to satisfy the relation 0.3X≦Y≦0.9X.

JP-A-2002-286933 explains the method of stretching film under heating and the method of stretching film in a state of containing a solvent as examples of a method of forming film by casting, and discloses as preferred embodiments that the film is stretched at a temperature lower than the vicinity of glass transition point of film resin in the case of stretching under heating and, in the case of stretching film formed by casting in a state that the film contains a solvent, the film once dried can be stretched after it is impregnated again with the solvent by contact with the solvent.

### (Physical Properties of Present Optical Films I, II and III)

In the cases where the present Optical Films I, II and III are cellulose acylate films, physical properties thereof are described below.

Re(550) values of cellulose acylate films according to the invention are preferably in the range of 20 to 100 nm, and Rth(550) values thereof are preferably in the range of 100 to 300 nm.

When each of such cellulose acylate films is used as an optical compensation film in a VA-mode liquid crystal display in particular and optical compensation is provided by using only one sheet thereof on one side of a liquid crystal cell, the Re(550) of each film is preferably from 40 to 100 nm, far preferably from 45 to 80 nm, and the Rth(550) of each film is preferably from 160 to 300 nm, far preferably from 170 to 250 nm.

On the other hand, when each of those films is used as an optical compensation film in a VA-mode liquid crystal display device and optical compensation is provided by using two sheets of each film on both sides of a liquid crystal cell, the Re(550) of each film is preferably from 20 to 100 nm, far preferably from 25 to 80 nm, and the Rth(550) of each film is preferably from 100 to 200 nm, far preferably from 100 to 150 nm.

It is preferable that the cellulose acylate film according to the invention satisfies the following relations (I) to (III).

0.4<{(Re(450)/Rth(450))/(Re(550)/Rth(550))}<0.95

and

1.05<{(Re(650)/Rth(650))/(Re(550)/Rth(550))}<1.9 Relation (I)

0.1<(Re(450)/Re(550))<0.95 Relation (II)

1.03<(Re(650)/Re(550))<1.93 Relation (III)

The following Relations (I) to (III) are preferred by far.

0.5<{(Re(450)/Rth(450))/(Re(550)/Rth(550))}<0.9

and

1.1<{(Re(650)/Rth(650))/(Re(550)/Rth(550))}<1.7 Relation (I)

0.2<(Re(450)/Re(550))<0.9 Relation (II)

1.1<(Re(650)/Re(550))<1.7 Relation (III)

In the above relations, Re(λ) stands for in-plane retardation Re, expressed in the unit nm, at a wavelength λ nm and Rth(λ) stands for thickness-direction retardation Rth, expressed in the unit nm, at a wavelength λ nm.

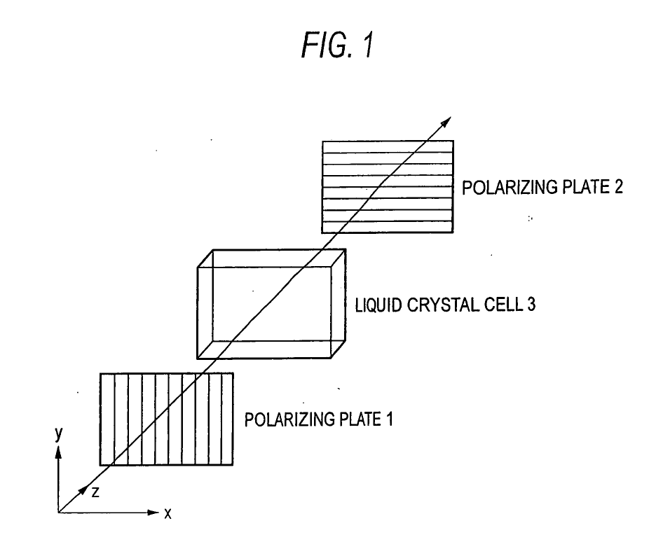

As reasons why these ranges of optical characteristics are preferable, the effects of the invention are illustrated below by use of drawings. FIG. 1 is a diagrammatic sketch illustrating a configuration of a general VA-mode liquid crystal display device. A VA-mode liquid crystal display device has a liquid crystal cell 3 having a liquid crystal layer in which liquid crystal molecules are oriented vertically to a base plate surface when no voltage is applied, or at black-display time, and a polarizing plate 1 and a polarizing plate 2, between which the liquid crystal cell is sandwiched, which are disposed so that the directions of their transmission axes (shown as stripes in FIG. 1) are orthogonal to each other. In FIG. 1, light is incident from the side of the polarizing plate 1. When light traveling in the z-axis direction, or in the normal direction, enters in a condition that no voltage is applied, the light having passed through the polarizing plate 1 passes through the liquid crystal cell 3 as it retains its linear polarization, and it is perfectly cut off by the polarizing plate 2. As a result, images of high contrast can be displayed.

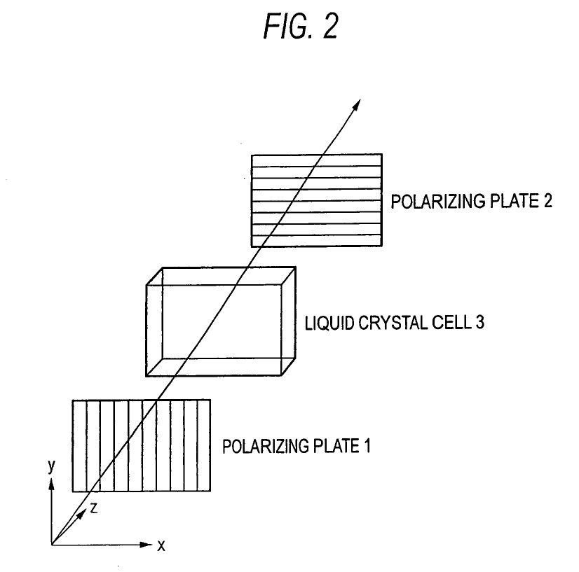

As shown in FIG. 2, however, the situation changes in the case of oblique incidence. When light comes in from an oblique direction, not the z-axis direction, namely form a direction slanting off from the polarization directions of the polarizing plate 1 and the polarizing plate 2 (the so-called OFF AXIS), the incoming light changes its polarization state by undergoing retardation effect in the oblique direction when passes through the vertically oriented liquid crystal layer in the liquid crystal cell 3. In addition, apparent transmission axes of the polarizing plates 1 and 2 deviate from perpendicular alignment. For these two reasons, the light incident from an oblique direction as OFF AXIS is not perfectly cut off by the polarizing plate 2, so light leakage occurs at black-display time and thereby the contrast is lowered.

Herein, a polar angle and an azimuth angle are defined. The polar angle is an angle which a sloped line forms with the direction of the normal on a film surface, namely the z axis in FIG. 1 and FIG. 2 each. For instance, the direction of the normal on a film surface is the direction of polar angle=0. The azimuth angle represents a angular direction reached by an anticlockwise turn from the positive direction of x axis as a reference direction. For instance, the positive direction of x axis is a direction of azimuth=0, and the positive direction of y axis is a direction of azimuth angle=90°. The oblique directions as OFF AXIS mainly refer to the cases where polar angles are not zero and azimuth angles are 45°, 135°, 225° and 315°, respectively.

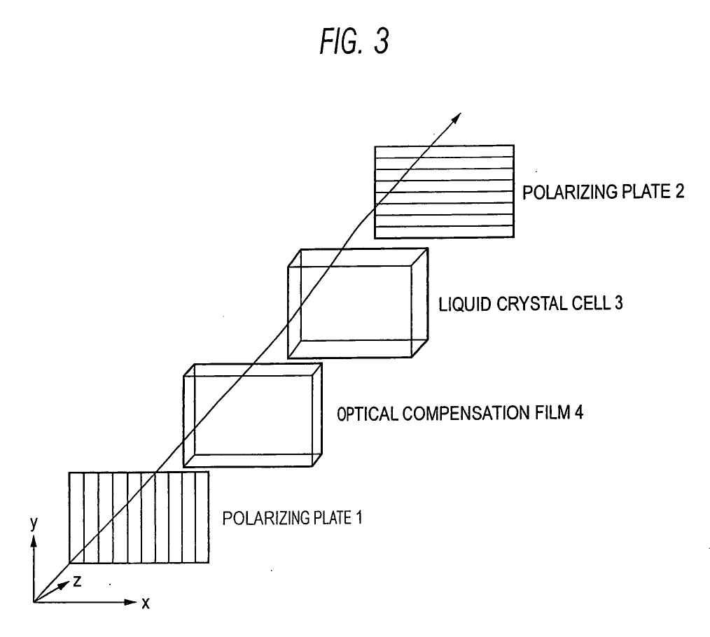

FIG. 3 shows a diagrammatic sketch of a configuration example for illustrating effects of the invention. The configuration shown in FIG. 3 is a configuration formed by arranging an optical compensation film 4 between the liquid crystal cell 3 and the polarizing plate 1 in the configuration shown in FIG. 1.

The optical compensation film 4 is an optical film satisfying the following relations (I) to (III).

0.4<{(Re(450)/Rth(450))/(Re(550)/Rth(550))}<0.95

and

1.05<{(Re(650)/Rth(650))/(Re(550)/Rth(550))}<1.9 Relation (I)

0.1<(Re(450)/Re(550))<0.95 Relation (II)

1.03<(Re(650)/Re(550))<1.93 Relation (III)

By using the optical compensation film having these optical characteristics, the invention makes it possible to provide optical compensations for oblique incoming light with wavelengths of R, G and B in slow axes and retardations varying from one wavelength to another. As a result, the liquid crystal display device using the present optical compensation film can be improved by far in viewing angle contrast in a black-display and reduced by far in tinting in the viewing angle direction in a black-display state, compared with liquid crystal display devices currently in use. In this specification, the wavelength 650 nm is used as R, the wavelength of 550 nm is used as G, and the wavelength of 450 nm is used as B. The wavelengths of R, G and B are not always represented by those wavelengths, but they are thought to be appropriate wavelengths for defining the optical properties contributing to the effects of the invention.

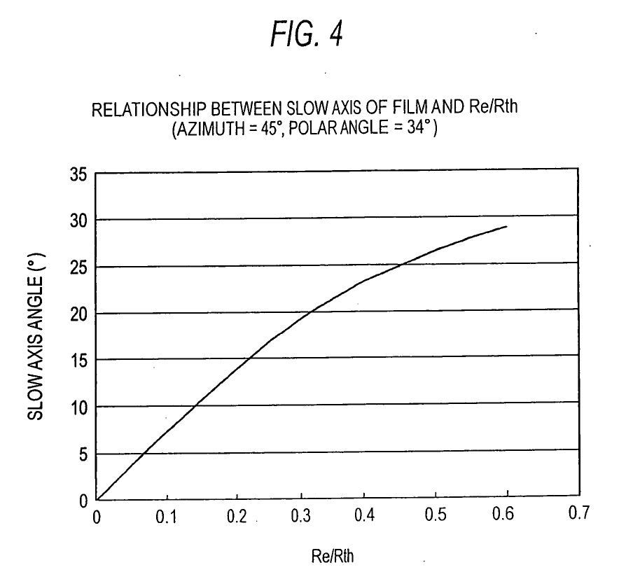

The invention focuses attention on a ratio between Re and Rth, Re/Rth, in particular. This is because the value Re/Rth is a factor determining two axes of intrinsic polarization in propagation of obliquely traveling light through a biaxial birefringent medium. FIG. 4 shows an example of a result of calculating the relationship between the direction of one axis of two axes present in intrinsic polarization and Re/Rth in the case where obliquely traveling light is incident on an optical compensation film used in the invention. Herein, an assumption about the propagation direction of light is made that the azimuth angle is 45 degrees and the polar angle is 34 degrees. The result shown in FIG. 4 reveals that one axis of intrinsic polarization is determined if Re/Rth is fixed. And what change is caused in the polarization state of incident light when the light passes through an optical compensation film is determined mainly by the direction of in-plane slow axis of the optical compensation film and the retardation values of the optical compensation film. In the invention, the in-plane slow axis and the retardation values as main determinant factors of a change in polarization state are optimized at each of the wavelengths R, G and B by specifying the relations between Re/Rth values at the wavelengths R, G and B. As a result, even when there are two factors that light incident from an oblique direction is influenced by the oblique-direction retardation in a liquid crystal layer and apparent transmission axes of the polarization plate 1 and the polarization plate 2 deviate from perpendicular alignment, perfect compensation by one optical compensation film becomes possible and the lowering of contrast is reduced. Determination of the film parameters on the premise that R, G and B represent the whole wavelength region of visible radiation results in attainment of nearly perfect compensation in the whole region of visible radiation.

In a VA-mode, since liquid crystal molecules are vertically aligned when no voltage is applied, or in a black-display state, it is preferable that the in-plane slow axis of the optical compensation film 4 is made perpendicular or parallel to the polarizing plate 1 or the polarizing plate 2 so that, in a black-display state, the polarization state of light incident from the direction of the normal is not influenced by retardation of the optical compensation film 4. Furthermore, the optical compensation film may be placed between the polarizing plate 2 and the liquid crystal cell 3. In this case, it is preferable that the in-plane slow axis of the optical compensation film is made perpendicular or parallel to the polarizing plate 1 or the polarizing plate 2.

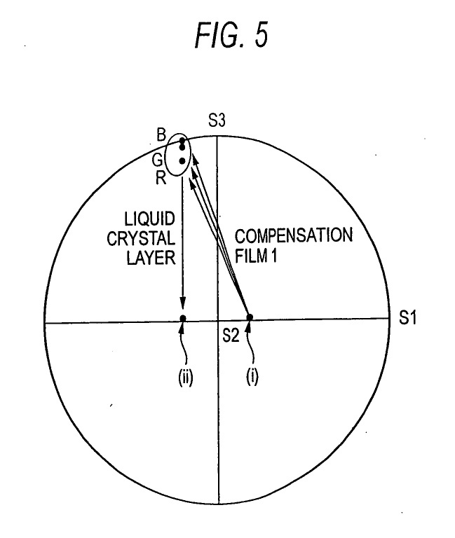

FIG. 5 shows a diagram illustrating a compensation mechanism in the configuration of FIG. 3 by use of a Poincaré sphere. Herein, light propagates in the direction of azimuth angle=45° and polar angle=34°. The S2 axis in FIG. 5 is an axis piercing through the paper plane vertically in the downward direction, and FIG. 5 is a diagram of Poincaré sphere drawn in viewing from the positive direction of the S2 axis. A displacement of a point which occurs between before and after a change in polarization state is indicated with a straight-line arrow in FIG. 5 since the figure is a plan view, but actually on a Poincaré sphere the change caused in polarization state by passage through the liquid crystal layer and the optical compensation film is expressed in rotation to a specified angle about a particular axis determined according to the optical characteristics of the liquid crystal layer and the optical compensation film through which light passes.

The polarization state of incident light having passed through the polarizing plate 1 in FIG. 3 corresponds to the point (i) in FIG. 5, the polarization state of light cut off by an absorption axis of the polarizing plate 2 in FIG. 3 corresponds to the point (ii) in FIG. 5. OFF-AXIS light leakage occurring in oblique directions in VA-mode liquid crystal display devices currently in use is traceable to a gap between the point (i) and the point (ii). In general, an optical compensation film is used for achieving the change of polarization state of incident light from the point (i) to the point (ii), also including a change of the polarization state in a liquid crystal layer. Since the liquid crystal layer in the liquid crystal cell 3 shows positive refractive-index anisotropy and liquid crystalline molecules therein are vertically aligned, the change caused in polarization state of incident light by passage through the liquid crystal layer is, on Poincaré sphere, indicated with the top-to-bottom arrow in FIG. 5 and expressed as rotation about the S1 axis. Therefore, in order that visible light after passage through the liquid crystal layer is cut off by the polarizing plate 2, it is required for the starting point with respect to each of R, G and B before rotation to lie on the line formed by rotating the point (ii) about the S1 axis. In addition, the angle of such rotation is proportional to the value obtained by dividing an effective retardation from an oblique direction in the liquid crystal layer Δn′d′ by a wavelength λ, namely Δn′d′/λ, so the rotation angles concerning R, G and B, which are different wavelengths, don't accord with one another. Accordingly, in order to bring all of polarization states at R, G and B to the point (ii) after rotation, as shown in FIG. 5, it is required that the polarization states at R, G and B, respectively, before rotation lie on the line formed by rotating the point (ii) about the S1 axis and they be situated in positions corresponding to their respective rotation angles. In the invention, optical compensation is carried out by placing an optical compensation film having specified relations between Re/Rth values at R, G and B, respectively, in order to bring the polarization states at R, G and B, respectively, after passage through the optical compensation film 4 and before the passage through the liquid crystal cell 3 to the aforementioned polarization states.

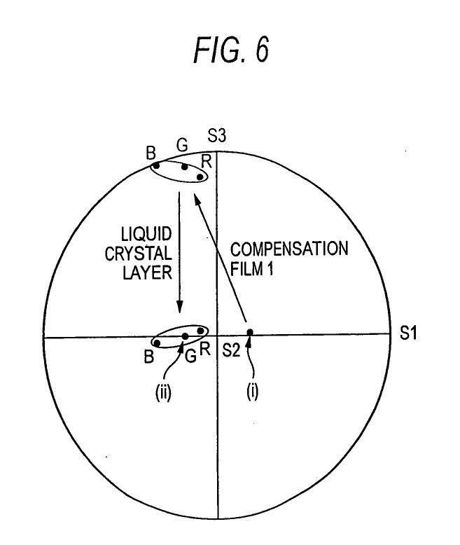

In a like manner, an example of background arts is shown in FIG. 6. The example shown in FIG. 6 is a case using an optical compensation film having an Re/Rth value not varying with the wavelength. In this case, even when the optical characteristics of the optical compensation film with respect to, e.g., G light are adjusted so that the starting point before rotation by the liquid crystal layer lies on the line formed by rotating the point (ii) about the S1 axis, it is impossible to make the starting points with respect to R light and B light lie on such a line. Therefore, the polarization states of R light and B light having passed through the liquid crystal layer are not changed into the polarization state represented by the point (ii), and R light and B light are not perfectly cut off by the absorption axis of the polarizing plate. Thus, leakage of R light and B light occurs to result in color drift at the time of black display. The same phenomenon occurs even when an optical compensation film optimized with respect to only R or B light is used.

Cellulose acylate film suitably used in the invention can be obtained by using a solution prepared by dissolving specific cellulose acylate and, if needed, additives in an organic solvent and making the solution into film.

From the viewpoint of reducing a tint change caused in a liquid crystal display device with the lapse of time, it is preferable to design the cellulose acylate film used to advantage in the invention so that the difference between the Re value at 25° C. and 10% RH and the Re value at 25° C. and 80% RH, ΔRe(=Re_{10%}−Re_{80%}), is from 0 to 10 nm and the difference between the Rth value at 25° C. and 10% RH and the Rth value at 25° C. and 80% RH, ΔRth(=Rth_{10%}−Rth_{80%}), is from 0 to 30 nm.

In addition, it is preferable from the viewpoint of reducing a tint change caused in a liquid crystal display device with the lapse of time that the cellulose acylate film used to advantage in the invention has an equilibrium water content of 3.2% or below at 25° C. and 80% RH.

The water content is determined as follows: Water content measurement according to Karl Fischer method is made on a cellulose acylate sample measuring 7 mm×35 mm by use of a moisture measuring device and a sample drying device (CA-03 and VA-05, made by Mitsubishi Chemical Corporation). And the water content was calculated by dividing the amount of water (g) by the mass of the sample (g).

It is further preferable from the viewpoint of reducing a tint change caused in a liquid crystal display device with the lapse of time that the cellulose acylate film used to advantage in the invention has moisture permeability of 400 g/m²·24 hr to 1,800 g/m²·24 hr (in 80-μm thickness terms) when allowed to stand for 24 hours at 60° C. and 95% RH.

The moisture permeability becomes small when cellulose acylate film is great in thickness, while it becomes great when the thickness of cellulose acylate film is small. So, it becomes necessary to fix a standard thickness and make thickness conversions no matter what the sample thickness is. In the invention, the standard thickness is taken as 80 μm, the film thickness conversion is made according to the following equation.

Moisture permeability in 80-μm terms=measured moisture permeability×measured thickness μm/80 μm Equation (13)

To measurement of moisture permeability can be applied the methods described in Kobunshi no Bussei II (Kobunshi Jikken Koza 4, published by Kyoritsu Shuppan), pp. 285-294: Measurements of amounts of vapors permeated (a mass method, a thermometer method, a vapor pressure method and a adsorbed amount method).

The elasticity modulus is measured under conditions that a cellulose acylate sample measuring 10 mm×150 mm in size is allowed to stand for 2 hours or more in the 25° C.-60% RH atmosphere for moisture control, and then extended with a tensile tester (Strography R2 made by Toyo Seiki Kogyo Co., Ltd.) at settings that the chuck-to-chuck distance is 100 nm, the temperature is 25° C. and the extension speed is 10 mm/min.

The hygroscopic expansion coefficient of cellulose acylate film is determined by measuring the dimension of film allowed to stand for 2 hours or more in the 25° C.-80% RH atmosphere with a pin gauge, L_{80%}, and the dimension of film allowed to stand for 2 hours or more in the 25° C.-10% RH atmosphere with a pin gauge, L_{10%}, and calculating from L80% and L10% by use of the following equation.

HYGROSCOPIC expansion coefficient=(L_{80%}−L_{10%})/(80% RH−10% RH)×10⁶ Equation (14)

Furthermore, it is preferable that the cellulose acylate film used to advantage in the invention has its haze in the range of 0.01 to 2%. Herein, the haze can be measured as follows.

Haze is measured in using a cellulose acylate film sample measuring 40 mm×80 mm in size and a haze meter (HGM-2DP, made by Suga Test Instruments Co., Ltd.) at 25° C. and 60% RH in accordance with JIS K6714.

Additionally, it is preferable that the cellulose acylate film used to advantage in the invention has its mass change in the range of 0 to 5 mass % when it is allowed to stand for 48 hours in the 80° C.-90% RH atmosphere.

Moreover, it is preferable that the cellulose acylate film used to advantage in the invention has its dimensional change in the range of 0 to 5% in both cases of 24-hour standing in the 60° C.-95% RH atmosphere and 24-hour standing in the 90° C.-5% RH atmosphere.

### (Cellulose Acylate)

The present Optical Films I, II and III preferably include cellulose acylate film. To begin with, cellulose as a starting material of cellulose acylate film which is one of preferred embodiments of the present optical film is described. Thereafter, polymers other than cellulose acylate are also described.

As raw cotton materials for cellulose acylate, known materials can be used (See, e.g., JIII Journal of Technical Disclosure No. 2001-1745, published by Japan Institute of Invention and Innovation). The synthesis of cellulose acylate can also be performed in accordance with known methods (See, e.g., Migita et al., Mokuzai Kagaku, pages 180-190, Kyoritsu Shuppan Co., Ltd. (1968)). The viscosity-average polymerization degree of cellulose acylate used in the invention is preferably from 200 to 700, far preferably from 250 to 500, particularly preferably from 250 to 350. And it is preferable that the number-average molecular weight (Mn) of cellulose acylate used in the invention is from 10,000 to 150,000, the weight-average molecular weight (Mw) is from 20,000 to 500,000 and the Z-average molecular weight (Mz) is from 5,000 to 550,000. Additionally, it is preferable that the cellulose acylate used in the invention is narrow in molecular weight distribution Mw/Mn (Mw: mass-average molecular weight, Mn: number-average molecular weight) measured by gel permeation chromatography. More specifically, the value Mw/Mn is preferably from 1.5 to 5.0, far preferably from 2.0 to 4.5, particularly preferably from 3.0 to 4.0.

Acyl groups in the cellulose acylate film are not limited to particular ones, but they are preferably acetyl groups, propionyl groups, butyryl groups or benzoyl groups. The substitution degree of whole acyl groups is preferably from 2.0 to 3.0, far preferably from 2.2 to 2.95. The term “acyl substitution degree” as used in this specification refers to a value calculated according to ASTM D817. It is most advantageous that the acyl groups in the cellulose acylate film are acetyl groups. When cellulose acetate is used as cellulose acylate, the acetylation degree is preferably from 57.0 to 62.5%, far preferably from 58.0 to 62.0%. When the acetylation degree is in such a range, there does not occur an increase of Re beyond the intended value by transport tension at the time of casting, in-plane variations are reduced, and changes in retardation values by temperature and humidity changes are also reduced.

When the cellulose acylate is obtained by substitution of acyl groups having 2 or more carbon atoms per each for hydroxyl groups of glucose units constituting the cellulose, and the acyl substitution degree on the 2-position hydroxyl groups of glucose units is denoted as DS2, the acyl substitution degree on the 3-position hydroxyl groups of glucose units is denoted as DS3 and the acyl substitution degree on the 6-position hydroxyl groups of glucose units is denoted as DS6, it is preferable that the following relations (III) and (IV) in particular are satisfied, because it becomes easy to deliver the desired Re and Rth values and variations of Re values by temperature and humidity changes become smaller.

2.0≦(DS2+DS3+DS6)≦3.0 Relation (III)

DS6/(DS2+DS3+DS6)≧0.315 Relation (IV)

The following are more suitable ranges.

2.2≦(DS2+DS3+DS6)≦2.9 Relation (III)

DS6/(DS2+DS3+DS6)≧0.322 Relation (IV)

Alternatively, when the substitution degree of acetyl groups is represented by A and the substitution degree of propionyl, butyryl or benzoyl group is represented by B, it is preferable that relations (V) and (VI) in particular are satisfied, because it becomes easy to deliver the desired Re and Rth values and to achieve high stretch ratio without rupture.

2.0≦A+B≦3.0 Relation (V)

0≦B Relation (VI)

The following are more suitable ranges.

2.6≦A+B≦3.0 Relation (V)

0.5≦B≦1.5 Relation (VI)

### (Polymer Other than Cellulose Acylate)

The method of obtaining film having favorable optical properties in accordance with the present manufacturing method characterized by including a process of stretching film and a process of shrinking film is applicable to the whole polymers usable for optical films, including but not limited to cellulose acylate, and polymers other than cellulose acylate promise to produce almost the same effects as cellulose acylate produces.

Examples of polymers usable for optical film include a polycarbonate copolymer and a polymer resin having a cyclic olefin structure.

An example of a polycarbonate copolymer is a polycarbonate copolymer made up of repeating units represented by the following formula (A) and repeating units represented by the following formula (B), wherein the repeating units represented by formula (A) constitute 80 to 30 mole % of the total repeating units.

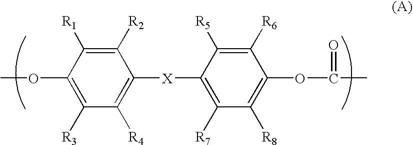

In the above formula (A), R₁ to R₈ are each independently chosen from a hydrogen atom, a halogen atom or 1-6C hydrocarbon groups. Examples of such 1-6C hydrocarbon groups include alkyl groups, such as a methyl group, an ethyl group, an isopropyl group and a cyclohexyl group, and aryl groups including a phenyl group. Of those recited above, a hydrogen atom and a methyl group are preferred over the others.

X is represented by the following formula (X), and R₉ and R₁₀ are independent of each other, each of which is a hydrogen atom, a halogen atom or a 1-3C alkyl group. Examples of the 1-3C alkyl group include the same ones as recited above.

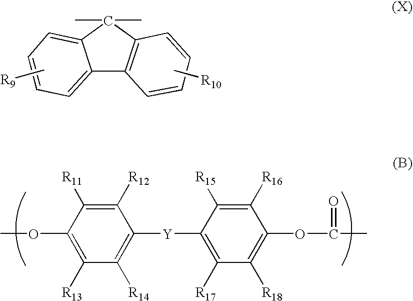

In the above formula (B), R₁₁ to R₁₈ are each independently chosen from a hydrogen atom, a halogen atom or 1-22C hydrocarbon groups. Examples of such 1-22C hydrocarbon groups include 1-9C alkyl groups, such as a methyl group, an ethyl group, an isopropyl group and a cyclohexyl group, and aryl groups, such as a phenyl group, a biphenyl group and a terphenyl group. Of those recited above, a hydrogen atom and a methyl group are preferred over the others.

Y is represented by any of the following formulae, and R₁₉ to R₂₁, R₂₃ and R₂₄ are each at least one group independently chosen from a hydrogen atom, a halogen atom or 1-22C hydrocarbon groups. Examples of such hydrocarbon groups include the same one as recited above. R₂₂ and R₂₅ are chosen independently from 1-20C hydrocarbon groups. Examples of such hydrocarbon groups include a methylene group, an ethylene group, a propylene group, a butylene group, a cyclohexylene group, a phenylene group, a naphthylene group and a terphenylene group. Examples of each of Ar₁ to Ar₃ include 6-10C aryl groups, such as a phenyl group and a naphthyl group.

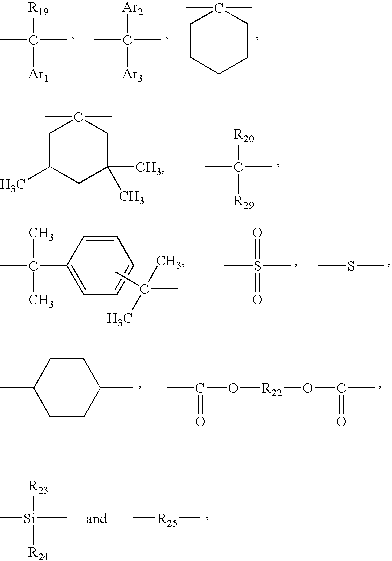

As to the polycarbonate copolymer, a polycarbonate copolymer constituted of 30 to 60 mol % of repeating units represented by the following formula (C) and 70 to 40 mol % of repeating units represented by the following formula (D) is preferable.

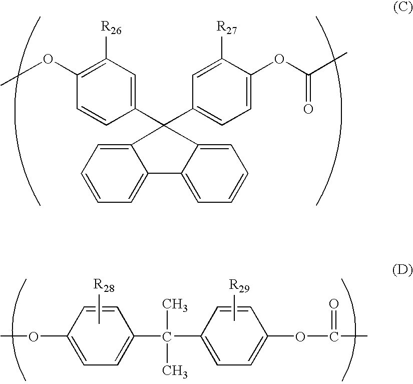

A polycarbonate copolymer constituted of 45 to 55 mol % of repeating units represented by the foregoing formula (C) and 55 to 45 mol % of repeating units represented by the foregoing formula (D) is preferable by far.

In the above formula (C), R₂₆ and R₂₇ are each a hydrogen atom or a methyl group independently. And a methyl group is preferable in point of easiness of handling.

In the above formula (D), R₂₈ and R₂₉ are each a hydrogen atom or a methyl group independently. And a hydrogen atom is preferable in point of cost efficiency and film properties.

As optical films in the invention, films using polycarbonate copolymers having fluorene skeletons as illustrated above are suitable. The polycarbonate copolymer preferred as such a polycarbonate copolymer is a blend of polycarbonate copolymers which, though constituted of repeating units represented by the foregoing formula (A) and repeating units represented by the foregoing formula (B), are different in ratio between these repeating units. The content of the repeating units of formula (A) in the total polycarbonate copolymers is preferably from 80 to 30 mol %, far preferably from 75 to 35 mol %, further preferably from 70 to 40 mol %.

Alternatively, the polycarbonate copolymer may be a copolymer made up of a combination of two or more varieties of repeating units represented by formula (A) and two or more varieties of repeating units represented by formula (B).

The foregoing molar ratios can be determined by examining polycarbonates forming the bulk of an optical film in their entirety by means of, e.g., nuclear magnetic resonance apparatus.

The polycarbonate copolymers as recited above can be synthesized by known methods. As to polycarbonate, a method of synthesizing polycarbonate by polycondensation of a dihydroxy compound and phosgene, or by melt polycondensation can be suitably used.

The limiting viscosity of a polycarbonate copolymer as recited above is preferably from 0.3 to 2.0 dl/g. When the limiting viscosity is lower than 0.3 dl/g, the film obtained becomes brittle and cannot retain mechanical strength; while, when the limiting viscosity is greater than 2.0 dl/g, the solution viscosity becomes too high to cause problems that die lines develop in film formation from the solution and purification at the conclusion of polymerization becomes difficult.

Alternatively, the present optical film may be formed of a composite (a blend) of the polycarbonate copolymer(s) as recited above and another high polymer compound. Since the high polymer compound herein is required to be optically transparent, it is suitable as such a compound to have compatibility with the polycarbonate copolymer(s) or refractive index nearly equal to those of the polycarbonate copolymers. An example of another high polymer compound is poly(styrene-co-maleic anhydride). As to the compositional ratio between the polycarbonate copolymer(s) and another high polymer compound, it is appropriate that the composite be constituted of 80 to 30 mass %, preferably 80 to 40 mass %, of polycarbonate copolymer(s) and 20 to 70 mass %, preferably 20 to 60 mass %, of high polymer compound. In the case of a blend also, each of the two types of repeating units in each polycarbonate copolymer may be a combination of two or more different varieties. In addition, the blend is preferably a compatible blend. However, even when components in the blend are not perfectly compatible, it is possible to suppress light scattering from the components and attain high transparency so long as the components are adjusted to have the same refractive index. Additionally, the blend may be a combination of three or more kinds of materials, and a plural kinds of polycarbonate copolymers and other high polymer compounds can be combined into a blend.

The mass-average molecular weight of polycarbonate copolymer is from 1,000 to 1,000,000, preferably from 5,000 to 500,000. On the other hand, the mass-average molecular weight of another high polymer compound is from 500 to 100,000, preferably from 1,000 to 50,000.

Examples of a polymer resin having a cyclic olefin structure (hereinafter referred to as “cyclic polyolefin resin” or “cyclic polyolefin”, too) include (1) a norbornene polymer, (2) a monocyclic olefin polymer, (3) a cyclic conjugated diene polymer, (4) a vinyl alicyclic hydrocarbon polymer, and hydrogenation products of the polymers (1) to (4). The polymers used to advantage in the invention are an addition (co)polymeric cyclic polyolefin containing at least one or more kinds of repeating units represented by the following formula (II) and an addition (co)polymeric cyclic polyolefin further containing at least one or more kinds of repeating units represented by formula (I) as appropriate. In addition, an addition (co)polymer containing at least one kind of cyclic repeating units represented by formula (III) (including an open-circular (co)polymer) is also used to advantage. Moreover, an addition (co)polymeric cyclic polyolefin further containing at least one kind of repeating units represented by formula (I) as appropriate in addition to at least one kind of repeating units represented by formula (III) can be used to advantage, too.

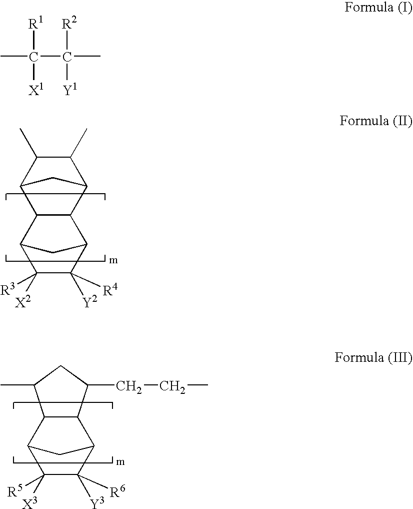

In the above formulae, m represents an integer of 0 to 4, R¹ to R⁶ each represent a hydrogen atom or a 1-10C hydrocarbon group, and X¹ to X³ and Y¹ to Y³ each represent a hydrogen atom, a 1-10C hydrocarbon group, a halogen atom, a 1-10C halogenated hydrocarbon group, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW. Alternatively, X¹ and Y¹, X² and Y², or X³ and Y³ may combine with each other to form (—CO)₂O or (—CO)₂NR¹⁵. In these groups, R¹¹, R¹², R¹³, R¹⁴ and R¹⁵ each represent a hydrogen atom or a 1-20C hydrocarbon group, Z represents a hydrocarbon group or a halogenated hydrocarbon group, W represents SiR¹⁶ₚD₃₋ₚ (wherein R¹⁶ represents a 1-10C hydrocarbon group, D represents a halogen atom, —OCOR¹⁷ or —OR¹⁷, p represents an integer of 0 to 3, and R¹⁷ has the same meaning as R¹⁶), and n represents an integer of 0 to 10.

By introducing functional groups having great polarity into substitutents of X¹ to X³ and Y¹ to Y³, the retardation of optical film in the thickness direction (Rth) is increased, and the ability of the film to develop in-plane retardation (Re) can be enhanced. The film great in ability to develop Re can realize a great Re value by undergoing stretching in its manufacturing process.

Norbornene addition (co)polymers are disclosed in JP-A-10-7732, JP-T-2002-504184 (the term “JP-T” as used herein means a published Japanese translation of a PCT patent application), US2004229157A1 and WO2004/070463A1. Those polymers can be synthesized by addition polymerization of norbornene polycyclic unsaturated compounds. In addition, if needed, it is possible to carry out addition copolymerization of norbornene polycyclic unsaturated compounds and conjugated dienes, such as ethylene, propylene, butene, butadiene and isoprene; nonconjugated dienes, such as ethylidene norbornene; or linear monoene compounds, such as acrylonitrile, acrylic acid, methacrylic acid, maleic anhydride, acrylates, methacrylates, maleimide, vinyl acetate and vinyl chloride. These norbornene addition (co)polymers are available from Mitsui Chemical Inc. under the trade name of APEL, which include products graded according to glass transition temperature (Tg), such as APL8008T (Tg 70° C.), APL6013T (Tg 125° C.) and APL6015T (Tg 145° C.). In addition, such (co)polymers are also available in the form of pellets from Polyplastics Co., Ltd. under the trade names of TOPAS8007, TOPAS6013 and TOPAS6015. Furthermore, they are available from Ferrania S.p.A. under the trade name of Appear 3000.

The hydrogenation products of norbornene polymers, as disclosed in JP-A-1-240517, JP-A-7-196736, JP-A-60-26024, JP-A-62-19801, JP-A-2003-159767 and JP-A-2004-309979, can be prepared by addition polymerization or metathesis ring-opening polymerization of polycyclic unsaturated compounds and subsequent hydrogenation. In the norbornene polymers for use in the invention, R⁵ and R⁶ are preferably hydrogen atoms or —CH₃ groups, X³ and Y³ are preferably hydrogen atoms, Cl atoms or —COOCH₃ groups, and other groups are chosen as appropriate. These norbornene resins are available from JSR Corporation under the trade names of ARTON G and ARTON F, or from ZEON Corporation under the trade names of ZEONOR ZF14, ZEONOR ZF16, ZEONEX 250 and ZEONEX 280, and these products can be used in the invention.

### (Re Control Method and Retardation Raising Agent having Maximum Absorption Wavelength (λmax) Shorter than 250 nm)

For controlling the absolute value of Re of the present cellulose acylate film, it is favorable to use as a retardation raising agent a compound whose solution exhibits an absorption maximum at a wavelength shorter than 250 nm in its ultraviolet absorption spectrum. By using such a compound, the absolute value of Re can be controlled without changing in a substantial sense Re's dependence on wavelength in the visible region.

The term “retardation raising agent” as used herein means an additive which, when added to cellulose acylate film, can raise Re of the cellulose acylate film measured at 550 nm by at least 20 nm (in 80-μm thickness terms), compared with Re of cellulose acylate film formed in the same manner as the above film, except that the additive is not added, as measured at 550 nm. The rise in Re is preferably 30 nm or greater, far preferably 40 nm or greater, particularly preferably 60 nm or greater.

In point of capability as a retardation raising agent, a rod-shaped compound is used to advantage, which preferably contains at least one aromatic compound and far preferably contains at least two aromatic compounds.

It is advantageous for the rod-shaped compound to have a linear molecular structure. The term “linear molecular structure” means that the molecular structure of a rod-shaped compound is linear in the thermodynamically most stable structural condition. The thermodynamically most stable structure can be determined by crystal structure analysis or molecular orbital calculation. For instance, the molecular orbital calculations can be made using a software program for molecular orbital calculations (e.g., WinMOPAC2000, produced by Fujitsu) and thereby the molecular structure capable of minimizing the heat for forming the intended compound can be determined. The expression “the molecular structure is linear” means that the main chain in the thermodynamically most stable molecular structure forms an angle of 140 degrees or above.

It is preferable that the rod-shaped compound shows liquid crystallinity. And it is preferable by far that the rod-shaped compound shows liquid crystallinity by heating (thermotropic liquid crystallinity). The liquid crystal phase is preferably a nematic phase or smectic phase.

Suitable examples of such a rod-shaped compound include those disclosed in JP-A-2004-4550, but not limited to them. Two or more of rod-shaped compounds having whose solutions exhibit their maximum absorption at wavelengths (λnm) shorter than 250 nm may be used in combination.

The rod-shaped compounds can be synthesized by reference to the methods described in documents. Examples of such documents include Mol. Cryst. Liq. Cryst., vol. 53, p. 229 (1979), ibid., vol. 89, p. 93 (1982), ibid., vol. 145, p. 111 (1987), ibid, vol. 170, p. 43 (1989), J. Am. Chem. Soc., vol. 113, p. 1349 (1991), ibid, vol. 118, p. 5346 (1996), ibid., vol. 92, p. 1582 (1970), J. Org. Chem., vol. 40, p. 420 (1975), and Tetrahedron, vol. 48, No. 16, p. 3437 (1992).

The amount of the retardation raising agent added is preferably 0.1 to 30 mass %, far preferably 0.5 to 20 mass %, of the amount of cellulose acylate used.

### (Rth Control Method and Retardation Raising Agent having Maximum Absorption Wavelength (λmax) Longer than 250 nm)

For developing the desired Rth, it is favorable to use a retardation raising agent.

The term “retardation raising agent” as used herein means an additive which, when added to cellulose acylate film, can raise Rth of the cellulose acylate film measured at 550 nm by at least 20 mm (in 80-μm thickness terms), compared with Rth of cellulose acylate film formed in the same manner as the above film, except that the additive is not added, as measured at 550 nm. The rise in Rth is preferably 30 nm or greater, far preferably 40 nm or greater, particularly preferably 60 nm or greater.

The retardation raising agent is preferably a compound having at least two aromatic rings. The retardation raising agent is used preferably in an amount of 0.01 to 20 parts by mass, far preferably in an amount of 0.1 to 10 parts by mass, further preferably in an amount of 0.2 to 5 parts by mass, particularly preferably in an amount of 0.5 to 2 parts by mass, per 100 parts by mass of cellulose acylate. Two or more of retardation raising agents may be used in combination.

It is preferable that the retardation raising agents have their maximum absorption in the wavelength region of 250 nm to 400 nm and have substantially no absorption in the visible region.

In addition, it is preferable that the retardation raising agents used for control of Rth have no influence upon the Re developed by stretching, so it is advantageous to use discotic compounds for such retardation raising agents.

In addition to aromatic hydrocarbon rings, it is preferable that such discotic compounds contain aromatic hetero rings. Herein, 6-membered rings (or benzene rings) in particular are preferred as the aromatic hydrocarbon rings.

The aromatic hetero rings are generally unsaturated hetero rings, and they are preferably 5-, 6- or 7-membered rings, far preferably 5- or 6-membered rings. In addition, the aromatic hetero rings generally have the greatest number of double bonds. As to the hetero atoms present therein, nitrogen, oxygen and sulfur atoms are preferred, and nitrogen atom is particularly preferred. Examples of aromatic hetero rings include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and 1,3,5-triazine ring.

The suitable as aromatic rings are a benzene ring, a furan ring, a thiophene ring, a pyrrole ring, an oxazole ring, a thiazole ring, an imidazole ring, a triazole ring, a pyridine ring, a pyrimidine ring, a pyrazine ring and 1,3,5-triazine ring. Of these rings, 1,3,5-triazine ring is used to particular advantage. To be concrete, the compounds disclosed in JP-A-2001-166144 are preferably used.

Such an aromatic compound is used in an amount of 0.01 to 20 parts by mass, preferably in an amount of 0.05 to 15 parts by mass, far preferably in an amount of 0.1 to 10 parts by mass, per 100 parts by mass of cellulose acylate. Two or more kinds of those compounds may be used in combination.

### (Rth Control Method Utilizing Optically Anisotropic Layer)

As a method for controlling Rth without affecting Re developed by stretching, the method of coating the optical film with an optically anisotropic layer formed from a liquid crystal layer is suitably used.

Examples of such a liquid crystal layer include a discotic liquid crystal layer provided on the optical film in a state that the disc planes of discotic liquid crystal molecules are aligned so as to form an angle smaller than 5 degrees with the optical film surface (JP-A-10-312166) and a rod-shaped liquid crystal layer provided on the optical film in a state that the long axes of rod-shaped liquid crystal molecules are aligned so as to form an angle smaller than 5 degrees with the optical film surface (JP-A-2000-304932).

The cellulose acylate film having an optically anisotropic layer (also referred to as “optical compensation film”) contributes to viewing angle-and-contrast enhancement of liquid crystal display devices, notably OCB-mode and VA-mode liquid crystal display devices, and reduction in color drift depending on viewing angle. The optical compensation film may be placed between a polarizing plate on the viewer side of a display and a liquid crystal cell, or between a liquid cell and a polarizing plate on the back of a display, or both sides of a liquid crystal cell. More specifically, the optical compensation film can be incorporated as an independent member into a liquid crystal display device, or a protective film which is designed to protect a polarizing film and function as a transparent film to which such an optical property is imparted is incorporated as a polarizing plate member into a liquid crystal display device. In addition, an oriented film which controls orientation of a liquid crystal compound in the optically anisotropic layer may be sandwiched between the cellulose acylate film and the optically anisotropic layer. Furthermore, each of the cellulose acylate film and the optically anisotropic layer may be made up of two or more layers so long as the optical characteristics mentioned hereinafter are satisfied. The optically anisotropic layer is described in more detail.

### [Optically Anisotropic Layer]

An optically anisotropic layer may be formed directly on the cellulose acylate film, or it may be formed on an oriented film provided on the cellulose acylate film. Alternatively, a liquid crystalline compound layer formed on a separate base material can be transferred on to the cellulose acylate film with the aid of a tackiness agent or an adhesive.

Examples of a liquid crystalline compound used for forming an optically anisotropic layer include rod-shaped liquid crystalline compounds and disc-shaped liquid crystalline compounds (which are also referred to as “discotic liquid crystalline compounds”). The rod-shaped liquid crystalline compounds and the discotic liquid crystalline compounds may be high molecular liquid crystals or low molecular liquid crystals. Additionally, the compounds eventually contained in the optically anisotropic layer are no longer required to show liquid crystallinity. For instance, it corresponds to a case where, when a low molecular liquid crystalline compound is used, the compound is cross-linked during the course of forming an optically anisotropic layer to result in loss of liquid crystallinity.

### (Rod-Shaped Liquid Crystalline Compound)

Suitable examples of a rod-shaped liquid crystal compound usable in the invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. In addition, metal complexes are also included in rod-shaped liquid crystalline compounds. Moreover, it is possible to use liquid crystalline polymers containing in their repeating units the molecular structures of rod-shaped liquid crystalline compounds. In other words, rod-shaped liquid crystalline compounds may be bonded to (liquid crystalline) polymer.

Descriptions of rod-shaped liquid crystalline compounds can be found, e.g., in Kikan Kagaku Sosetsu (Quarterly Review of Chemistry), volume 22 (entitled “Ekisho no Kagaku” (Chemistry of Liquid Crystals), chapters 4, 7 and 11, The Chemical Society of Japan (1994), and Ekisho Debaisu Handobukku (Handbook of Liquid Crystal Devices), chapter 3, The 142-th Committee of Japan Society for the Promotion of Science.

The birefringence factors of rod-shaped liquid crystalline compounds for use in the invention are preferably in the range of 0.001 to 0.7.

For fixation of their aligned state, it is appropriate that the rod-shape liquid crystalline compounds have polymerizable groups. The polymerizable groups are preferably unsaturated polymerizable groups or epoxy groups, far preferably unsaturated polymerizable groups, particularly preferably ethylenic unsaturated polymerizable groups.

### (Discotic Liquid Crystalline Compound)

The discotic liquid crystalline compounds include the benzene derivatives described in the research report of C. Destrade et al., Mol. Cryst., vol. 71, p. 111 (1981), the truxene derivatives described in the research reports of C. Destrade et al., Mol. Cryst., vol. 122, p. 141 (1985) and Physics lett. A, vol. 78, p. 82 (1990), the cyclohexane derivatives described in the research report of B. Kohne et al., Angew. Chem., vol. 96, p. 70 (1984), and the azacrown macrocycles and the phenylacetylene macrocycles described in the research report of J. M. Lehn et al., J. Chem. Commun., p. 1794 (1985), and the research report of J. Zhang et al., J. Am. Chem. Soc., vol. 116, p. 2655 (1994).

In those discotic liquid crystalline compounds are included compounds which each show liquid crystallinity by having a structure that linear alkyl, alkoxy or substituted benzoyloxy groups as side chains are attached radially to its individual mother nucleus situated in the molecular center. And it is preferable that those compounds are compounds whose individual molecules or molecular self-assembly have rotational symmetry, and to which a certain orientation can be given.

When an optically anisotropic layer is formed from a discotic liquid crystalline compound, as mentioned above, the compound contained finally in the optically anisotropic layer is no longer required to exhibit liquid crystallinity. For instance, when a low-molecular discotic liquid crystal compound having a group capable of reacting to heat or light is polymerized or cross-linked through reaction of the group by heat or light to form an optically anisotropic layer, the compound contained eventually in the optically anisotropic layer no longer need to retain liquid crystallinity. Suitable examples of discotic liquid crystalline compounds are disclosed in JP-A-8-50206. As to the polymerization of discotic liquid crystalline compounds, descriptions thereof can be found in JP-A-8-27284.

For fixation of a discotic liquid crystalline compound by polymerization, it is required to combine polymerizable groups as substitutents with the discotic core of the discotic liquid crystalline compound. However, direct binding of polymerizable groups to the discotic core makes it difficult to keep the aligned state of the discotic core during the polymerization reaction. Therefore, linkage groups are introduced between the discotic core and polymerizable groups.

In the invention, molecules of the rod-shaped or disc-shaped compound in the optically anisotropic layer are fixed to their aligned state. The angle at which the average orientation direction of symmetry axes of liquid crystalline compound molecules on the interface on the optical film side is intersected with the in-plane slow axis of the optical film is approximately 45 degrees. The expression “approximately 45 degrees” used herein is intended to include angles in the range of 45°±5°, preferably 42 to 48°, far preferably 43 to 47°.

The average orientation direction of symmetry axes of liquid crystalline compound molecules can be generally controlled by selection of an appropriate liquid crystalline compound or an appropriate material for the oriented film, or by choice of a proper rubbing treatment method.

In the case of manufacturing an optical compensation film for OCB mode in the invention, by making an oriented film for use in formation of an optically anisotropic layer by rubbing treatment and rubbing cellulose acylate film in the direction of 45° with respect to its slow axis, it becomes possible to form an optically anisotropic layer wherein the average orientation direction of symmetry axes of liquid crystalline compound molecules on the cellulose acylate film surface at the least forms an angle of 45° with the slow axis of the cellulose acylate film.

For instance, the optical compensation film can be made continuously by using the present long-length cellulose acylate film having a slow axis orthogonal to its longitudinal direction. More specifically, a coating solution for formation of an oriented film is continuously applied to the long-length cellulose acylate film surface to form a film, the surface of the film thus formed is continuously subjected to rubbing treatment in the direction of 45° with respect to the longitudinal direction to make an oriented film, the oriented film thus made is coated continuously with a coating solution containing a liquid crystalline compound for formation of an optically anisotropic layer, and the molecules of the liquid crystalline compound are made to align and the aligned state thereof is fixed to make an optically anisotropic layer, thereby making a long length of optical compensation film continuously. The thus made long-length optical compensation film is cut in desired shapes before incorporation into a liquid crystal display device.

As to the average orientation direction of symmetry axes of liquid crystalline compound molecules on the surface side (air side), on the other hand, the average orientation direction of symmetry axes of liquid crystalline compound molecules on the air interface side is preferably approximately 45°, far preferably from 42° to 48°, further preferably from 43° to 47°. In general, the average orientation direction of symmetry axes of liquid crystalline compound molecules on the air interface side can be controlled by properly selecting the species of a liquid crystalline compound or the kinds of additives with which the liquid crystalline compound is used in combination. Examples of additives usable in combination with the liquid crystalline compound include a plasticizer, a surfactant, a polymerizable monomer and a polymer. The degree of a change in orientation directions of molecular symmetry axes, similarly to the above, can be controlled by the selection of a liquid crystalline compound and additives. As to selection of a surfactant in particular, it is preferable to secure coordination with its surface tension controlling effect on a coating solution.

As to the plasticizer, the surfactant and the polymerizable monomer with which the liquid crystalline compound is used in combination, it is preferable that they have compatibility with the liquid crystalline compound and can impart a tilt angle change to the liquid crystalline compound or have no hindrance to alignment. Of these additives, the polymerizable monomer (such as a compound containing a vinyl group, a vinyloxy group, an acryloyl group or a methacryloyl group) is preferred. The addition amount of such a compound is generally from 1% to 50% by mass, preferably from 5% to 30% by mass, based on the liquid crystalline compound used. In addition, mixing of a monomer having 4 or more polymerizable functional groups in those additives can heighten adhesion between an oriented film and an optically anisotropic layer.

When the liquid crystalline compound used is a discotic liquid crystalline compound, it is preferable to use a polymer having a measure of compatibility with the discotic liquid crystalline compound and capable of imparting a tilt angle change to the discotic liquid crystalline compound.

As the polymer, cellulose ester is suitable. Suitable examples of cellulose ester include cellulose acetate, cellulose acetate propionate, hydroxypropyl cellulose and cellulose acetate butyrate. The addition amount of such a polymer is adjusted so as not to hinder alignment of discotic liquid crystalline compound molecules. Specifically, the amount of a polymer added is preferably from 0.1% to 10% by mass, far preferably from 0.1% to 8% by mass, further preferably from 0.1% to 5% by mass, based on the discotic liquid crystalline compound.

The temperature of discotic nematic liquid crystal phase-solid phase transition in the discotic liquid crystalline compound is preferably from 70° C. to 300° C., far preferably from 70° C. to 170° C.

In the invention, the Re(550) value of the optically anisotropic layer is preferably from 0 to 300 nm, far preferably from 0 to 200 nm, further preferably from 0 to 100 nm. The Rth(550) value of in the thickness direction of the optically anisotropic layer is preferably from 20 to 400 nm, far preferably from 50 to 200 nm. The thickness of the optically anisotropic layer is preferably from 0.1 to 20 microns, far preferably 0.5 to 15 microns, particularly preferably from 1 to 10 microns.

The cellulose acylate film used to advantage in the invention can be obtained by dissolving the cellulose acylate specified above and additives required in an organic solvent to prepare a solution, and making the solution into film.

### [Additives]

Examples of additives usable in the cellulose acylate solution include a plasticizer, a ultraviolet absorbent, a deterioration inhibitor, a retardation (optical anisotropy) developer, a retardation (optical anisotropy) decreasing agent, a wavelength dispersion adjuster, a dye, fine particles, a strip accelerator, and an IR absorbent. In the invention, the use of a retardation developer is preferable. In addition, it is also preferred to use at least one or more of a plasticizer, a ultraviolet absorbent and a strip accelerator.

These additives may be solid matter or oily matter. In other words, they have no particular restriction as to their melting points and boiling points. For instance, a mixture of a ultraviolet absorbent having a melting point lower than 20° C. and a ultraviolet absorbent having a melting point of 20° C. or above can be used, and in a like manner a mixture of plasticizers can also be used (as disclosed in JP-A-2001-151901).

### [Ultraviolet Absorbent]

Any types of ultraviolet absorbents can be chosen with reference to the intended purpose, and absorbents of salicylate type, benzophenone type, benzotriazole type, benzoate type, cyanoacrylate type and nickel complex type can be used. Of these types, absorbents of benzophenone type, benzotriazole type and salicylate type are preferred over the others.

Examples of a ultraviolet absorbent of benzophenone type include 2,4-dihydroxybenzene, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone.

Examples of a ultraviolet absorbent of benzotriazole type include
2(2′-hydroxy-3′-t-butyl-5′-methylphenyl)-5-chlorobenzotriazole,
2(2′-hydroxy-5′-t-butylphenyl)benzotriazole,
2(2′-hydroxy-3′,5′-di-t-amylphenyl)benzotriazole,
2(2′-hydroxy-3′,5′-di-t-butylphenyl)-5-chlorobenzotriazole and
2(2′-hydroxy-5′-t-octylphenyl)benzotriazole.

Examples of a ultraviolet absorbent of salicylic acid ester type include phenyl salicylate, p-octylphenyl salicylate and p-tert-butylphenyl salicylate.

Of the ultraviolet absorbents as recited above, 2-hydroxy-4-methoxybenzophenone,
2,2′-dihydroxy-4,4′-methoxybenzophenone,
2(2′-hydroxy-3′-t-butyl-5′-methylphenyl)-5-chlorobenzotriazole,
2(2′-hydroxy-3′,5′-di-t-amylphenyl)benzotriazole and
2(2′-hydroxy-3′,5′-di-t-butylphenyl)-5-chlorobenzotriazole are preferred over the others.

From the viewpoint of achieving high cut-off effect over a wide wavelength region, it is favorable to use a combination of two or more ultraviolet absorbents differing in absorption wavelength. Ultraviolet absorbents used suitably for liquid crystals are those which have high ability to absorb ultraviolet rays with wavelengths of 370 nm or shorter from the viewpoint of protection of liquid crystal from degradation and exhibit slight absorption of visible light with wavelengths of 400 nm or longer from the viewpoint of liquid crystal display performance. The ultraviolet absorbents used to particular advantage are benzotriazole compounds, benzophenone compounds and salicylate compounds as recited above. Of these compounds, benzotriazole compounds are preferred in hardly making undesired stains on cellulose ester.

Moreover, it is possible to use as ultraviolet absorbents the compounds disclosed in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173.

The amount of ultraviolet absorbents added is preferably from 0.001 to 5 mass %, far preferably from 0.01 to 1 mass %, based on cellulose acylate. The addition amount of 0.001 mass % or above is preferred in achieving sufficient addition effect, and that of 5 mass % or below is preferred in inhibiting the ultraviolet absorbents from bleeding out of the film surface.

Addition of ultraviolet absorbents may be carried out simultaneously with dissolution of cellulose acylate, or they may be added to the cellulose acylate-dissolved dope. The way in which a solution of ultraviolet absorbents is added to dope by means of a static mixer just before casting is particularly preferred in point of easy adjustment to spectral absorption characteristics.

### [Deterioration Inhibitor]

The deterioration inhibitor can prevent cellulose triacetate from deteriorating and decomposing. Examples of the deterioration inhibitor include butylamine, hindered amine compounds (JP-A-8-325537), guanidine compounds (JP-A-5-271471), UV absorbents of benzotriazole type (JP-A-6-235819), and UV absorbents of benzophenone type (JP-A-6-118233).

### [Plasticizer]

Plasticizers are preferably phosphates or carboxylates. Examples of plasticizers of phosphate type include triphenyl phosphate (TPP), tricresyl phosphate (TCP), crezylphenyl phosphate, octyldiphenyl phosphate, biphenyldiphenyl phosphate (BDP), trioctyl phosphate and tributyl phosphate, and examples of plasticizers of carboxylate type include dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetyl citrate (OACTE), tributyl O-acetyl citrate (OACTB), acetyltriethyl citrate, acetyltributyl citrate, butyl oleate, methylacetyl ricinoelate, dibutyl sebacate, triacetin, tributyrin, butylphthalylbutyl glycolate, ethylphthalylethyl glycolate, methylphthalylethyl glycolate and butylphthalyl glycolate. The plasticizers used to advantage in the invention are those chosen from the plasticizers recited above. In addition, it is also appropriate that the plasticizers be (di)pentaerythritol esters, glycerol esters or diglycerol esters.

### [Strip Accelerator]

Examples of a strip accelerator include ethyl esters of citric acid.

### [Infrared Absorbent]

Examples of an infrared absorbent include those disclosed in JP-A-2001-194522.

### [Addition Time]

The time at which those additives are added may be in any stage of dope-preparing process. Alternatively, the step of adding additives and proceeding with preparation may be added as the last step to the end of dope-preparing process. Moreover, the addition amounts of ingredients have no particular restrictions so long as their respective functions can develop.

When the cellulose acylate film has a multilayer structure, the kinds and amounts of additives added may vary from one layer to another, as described, e.g., in JP-A-2001-151902.

By proper selection of the kinds and addition amounts of additives, it is preferable that the glass transition temperature Tg measured with a dynamic viscoelasticity measuring equipment (Vibron DVA-225, made by I.T. Keisoku Seigyo K.K.) is adjusted to the range of 70 to 150° C., particularly 80 to 135°, and the elasticity modulus measured with a tensile tester (Strography R2 made by Toyo Seiki Kogyo Co., Ltd.) is adjusted to the range of 1,500 to 4,000 MPa, particularly 1,500 to 3,000 MPa. In other words, in point of processing suitability for working of polarizing plates and assembly of liquid crystal display devices, it is preferred that the cellulose acylate film used to advantage in the invention has its Tg and elasticity modulus in the ranges specified above.

As other additives, those described in detail in JIII Journal of Technical Disclosure No. 2001-1745, on and after p. 16, published by Japan Institute of Invention and Innovation in Mar. 15, 2001.

### [Retardation Decreasing Agent]

Retardation decreasing agents used for decreasing the optical anisotropy of cellulose acylate film are described below.

By use of a compound capable of inhibiting cellulose acylate molecules in film from orienting in the in-plane and thickness directions of the film, the optical anisotropy of the film can be decreased to a sufficient degree and both Re and Rth can be decreased to zero or close to zero. For this purpose, it is advantageous for such a compound to have sufficient compatibility with cellulose acylate and to be neither rodlike nor planar in its own structure. To be concrete, when a compound has a plurality of planar functional groups, such as aromatic groups, it is advantageous for the compound to have a conformation that the functional groups are not present in the same plane, but arranged in different planes.

### (Log P Value)

Among the foregoing compounds which can decrease the optical anisotropy of cellulose acylate film by inhibiting cellulose acylate molecules in the film from orienting in the in-plane and thickness directions, compounds having their octanol-water partition coefficients (log P value) in a range of 0 to 7 are preferably used for making cellulose acylate film having low optical anisotropy. This is because, when such compounds have log P values of 7 or below, they have good compatibility with cellulose acylate and hardly cause problems such as white muddiness and bloom of the film made; while, when they have log P values of 0 or above, they have no adverse effect on water resistance of the film made since their hydrophilicity is not so high. The more suitable range as the log P value is from 1 to 6, particularly from 1.5 to 5.

Octanol-water partition coefficient (log P value) measurement can be carried out in accordance with the flask shaking method described in JIS Z-7260-107 (2000). Instead of actual measurement of octanol-water partition coefficients (log P values), it is possible to estimate them by a computational chemical approach or an empirical method.

Examples of a computation method which can be suitably used herein include the Crippen's fragmentation method described in J. Chem. Inf. Comput. Sci., vol. 27, p. 21 (1987), the Viswanadhan's fragmentation method described in J. Chem. Inf. Comput. Sci., vol. 29, p. 163 (1989), and the Broto's fragmentation method described in Eur. J. Med. Chem.-Chim. Theor., vol. 19, p. 71 (1984). Of these methods, the Crippen's fragmentation method described in J. Chem. Inf. Comput. Sci., vol. 27, p. 21 (1987), is preferred over the others.

When the log P value of some compound varies depending on the measurement or computation method adopted, it is preferable that judgment on whether or not the compound in question has its log P value in the foregoing range is made by the Crippen's fragmentation method.

### (Physical Properties of Optical Anisotropy Decreasing Compound)

An optical anisotropy decreasing compound may contain an aromatic group, or needn't. The molecular weight of an optical anisotropy decreasing compound is preferably from 150 to 3,000, far preferably from 170 to 2,000, particularly preferably from 200 to 1,000. And such a compound may have a monomer structure, or an oligomer or polymer structure formed by linking two or more of its monomer units to one another so long as the compound has its molecular weight in the foregoing ranges.

The optical anisotropy decreasing compound is preferably in a liquid state at 25° C., or solid matter having a melting point of 25 to 250° C., and far preferably it is in a liquid state at 25° C. or solid matter having a melting point of 25 to 200° C. Furthermore, it is preferable that the optical anisotropy decreasing compound neither vaporizes nor becomes scattered during dope-casting and drying processes for formation of cellulose acylate film.

The addition amount of an optical anisotropy decreasing compound is preferably from 0.01 to 30 mass %, far preferably from 1 to 25 mass %, particularly preferably from 5 to 20 mass %, based on cellulose acylate.

An optical anisotropy decreasing compound may be used alone, or two or more of optical anisotropy decreasing compounds, which may be mixed in arbitrarily proportions, may be used in combination.

As to the time at which optical anisotropy decreasing compounds are added, they may be added at any stage in the process of dope preparation, including the last stage in the dope preparation.

The average content of an optical anisotropy decreasing compound in a part ranging from the film surface on at least one side to up to 10% of the whole thickness is preferably 80 to 99% of the average content of the compound in the central part of the cellulose acylate film. What quantity of optical anisotropy decreasing compound is present can be determined by measuring its quantities in the film surface and central parts in accordance with the method using infrared spectra as disclosed in JP-A-8-57879.

### [Dye]

In the invention, dyes may be added for the purpose of hue adjustment. The mass proportion of dyes in cellulose acylate is preferably from 10 to 1,000 ppm, far preferably from 50 to 500 ppm. By incorporation of dyes in such proportions, the cellulose acylate film can be reduced in light piping and improved in yellow tint. These compounds may be added together with cellulose acylate or a solvent at the start of preparation of a cellulose acylate solution, or during the preparation, or after the preparation. Alternatively, they may be added to an ultraviolet absorbent solution for in-line addition. The dyes disclosed in JP-A-5-34858 can be used in the invention also.

### [Fine Particles as Matting Agent]

It is preferable to add fine particles as a matting agent to the cellulose acylate film used to advantage in the invention. Examples of fine particles suitably used in the invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. The fine particles in which silicon is contained are preferable in point of low turbidity, and silicon dioxide in particular is preferred.

Fine particles of silicon dioxide having an average primary particle diameter of 20 nm or below and an apparent specific gravity of 70 g/L are preferable. And fine particles whose primary particles have a small diameter of 5 to 16 nm are far preferred because they can ensure low haze in the film. The apparent specific gravity of those particles is preferably from 90 to 200 g/L, far preferably from 100 to 200 g/L. This is because the greater apparent specific gravity makes it possible to prepare a dispersion of the higher concentration and contributes to improvements in haze and aggregate.

The amount of fine particles of silicon dioxide used as a matting agent is preferably from 0.01 to 0.3 parts by mass per 100 parts by mass of the polymer component including cellulose acylate.

These fine particles form secondary particles generally having an average particle diameter of 0.1 to 3.0 μm, and they are present in the film as aggregates of primary particles to form asperities of 0.1 to 3.0 μm on the film surface. The average particle size of secondary particles is preferably from 0.2 to 1.5 μm, far preferably from 0.4 to 1.2 μm, particularly preferably from 0.6 to 1.1 μm. This is because the secondary particles having an average particle size of 1.5 μm or below don't cause too thick haze, while those having an average particle size of 0.2 μm or above can fully achieve their effect on prevention of friction.

The primary and secondary particle sizes of fine particles are defined as the diameters of circles circumscribing particles in the film observed under a scanning electron microscope. Observations of 200 particles present in different positions of the film are made, and the mean of the observations on each of primary and secondary particles is taken as each average particle size.

As the fine particles of silicon dioxide, commercially available products, such as AEROSIL R972, R972V, R974, R812, 200, 200V, 300, R202, OX50 and TT600, produced by Nippon Aerosil Co., Ltd., can be used. Fine particles of zirconium oxide are commercially available from Nippon Aerosil Co., Ltd. under the trade names of AEROSIL R976 and R811, and these products can be used in the invention.

Of those products, AEROSIL 200V and AEROSIL R972V are each fine particles of silicon dioxide having an average primary particle diameter of 20 nm or below and an apparent specific gravity of 70 g/L or above, and can be used to particular advantage because they are highly effective in reducing the friction coefficient of optical film while retaining low turbidity of the film.

In the invention, some techniques for preparation of a fine-particle dispersion are conceivable in order to obtain cellulose acylate film containing particles small in average secondary particle size. For instance, there is a method in which a fine-particle dispersion is prepared in advance by mixing a solvent and fine particles with stirring, and this fine particle dispersion is added to a small amount of cellulose acylate solution prepared separately and dissolved into the solution with stirring and further mixed with a main dope solution of cellulose acylate. This method is a suitable preparation method from the viewpoint of ensuring good dispersibility of fine particles of silicon dioxide and further controlling re-aggregation of fine particles of silicon dioxide. Alternatively, there is a method in which a small amount of cellulose ester is added to a solvent with stirring to prepare a solution, then fine particles are added to the solution and dispersed with a disperser to prepare a dispersion for fine particle addition, and this dispersion for addition is fully mixed with a dope solution with an in-line mixer. In the invention, preparation of fine particle dispersion is not limited to such a method, but the concentration of silicon dioxide at the time when fine particles of silicon oxide are mixed and dispersed in a solvent is preferably from 5 to 30 mass %, far preferably from 10 to 25 mass %, particularly preferably from 15 to 20 mass %.

The higher concentration of the dispersion is preferable because the liquid turbidity relative to the addition amount becomes low to result in improvement of haze and aggregates. The final addition amount of matting agent in a cellulose acylate dope solution is preferably from 0.01 to 1.0 g per square meter, far preferably from 0.03 to 0.3 g per square meter, particularly preferably from 0.08 to 0.16 g per square meter.

Suitable examples of lower alcohol used as a solvent for the foregoing dispersion include methyl alcohol, ethyl alcohol, propyl alcohol, isopropyl alcohol and butyl alcohol. As to solvents other than lower alcohol, there is no particular restriction, but it is preferable to use a solvent used at the time of formation of cellulose ester film.

Then, organic solvents usable for dissolution of the cellulose acylate used to advantage in the invention are described.

In the invention, any of chlorinated solvents mainly containing chlorinated organic solvents and non-chlorinated solvents containing no chlorinated organic solvents can be used as the organic solvent.

### (Chlorinated Solvent)

When a solution of cellulose acylate used to advantage in the invention is prepared, a chlorinated organic solvent is preferably used as the main solvent of the solution. In the invention, no particular restriction is imposed on the chemical species of a chlorinated organic solvent used so long as the cellulose acylate can dissolve in the chlorinated organic solvent and the resulting solution can satisfactorily attain the purposes of casting and film formation. Such a chlorinated organic solvent is preferably dichloromethane or chloroform, particularly preferably dichloromethane. Additionally, it doesn't matter to mix a chlorinated organic solvent with other organic solvents. In this case, it is preferable that dichloromethane is used in a proportion of at least 50 mass % to the total amount of organic solvents.

Organic solvents used in combination with chlorinated organic solvents in the invention are described below.

As the other organic solvents, solvents chosen from 3-12C esters, ketones, ethers, alcohol compounds or hydrocarbons are suitable. These esters, ketones, ethers and alcohol compounds may have cyclic structures. Compounds which each contain any two or more of functional groups included in ether, ketone and ester (namely, —O—, —CO— and —COO—) can be used as the solvents, and other functional groups, such as alcoholic hydroxyl group, may further be contained therein. In the case of a solvent having two or more kinds of functional groups, the allowed number of carbon atoms present therein is within the specified range of the compound having any one of the functional groups. Examples of 3-12C esters include ethyl formate, propyl formate, pentyl formate, methyl acetate, ethyl acetate and pentyl acetate. Examples of 3-12C ketones include acetone, methyl ethyl ketone, diethyl ketone, diisobutyl ketone, cyclopentanone, cyclohexanone and methylcyclohexanone. Examples of 3-12C ethers include diisopropyl ether, dimethoxymethane, dimethoxyethane, 1,4-dioxane, 1,3-dioxolane, tetrahydrofuran, anisole and phenetole. Examples of organic solvents having two or more kinds of functional groups per molecule include 2-ethoxyethyl acetate, 2-methoxyethanol and 2-butoxyethanol.

Alcohol suitably used in combination with chlorinated organic solvents may have a linear, branched or cyclic structure, but it is preferably a derivative of a saturated aliphatic hydrocarbon. The hydroxyl group of alcohol may be any of primary, secondary and tertiary ones. Examples of alcohol include methanol, ethanol, 1-propanol, 2-propanol, 1-butanol, 2-butanol, t-butanol, 1-pentanol, 2-methyl-2-butanol and cyclohexanol. In addition, fluorinated alcohol can also be used as alcohol. Examples of such alcohol include 2-fluoroethanol, 2,2,2-trifluoroethanol and 2,2,3,3-tetrafluoro-1-propanol. On the other hand, hydrocarbons used as organic solvent may have linear, branched or cyclic structures, and they may be aromatic hydrocarbons or aliphatic hydrocarbons. The aliphatic hydrocarbons may be saturated or unsaturated ones. Examples of hydrocarbons include cyclohexane, hexane, benzene, toluene and xylene.

Examples of a combination of a chlorinated organic solvent and another organic solvent include the following compositions, but not limited to these compositions.

Dichloromethane/methanol/ethanol/butanol=80/10/5/5 (by mass parts)

Dichloromethane/acetone/methanol/propanol=80/80/5/5 (by mass parts)

Dichloromethane/methanol/butanol/cyclohexane=80/10/5/5 (by mass parts)

Dichloromethane/methyl ethyl ketone/methanol/butanol=80/10/5/5 (by mass parts)

Dichloromethane/acetone/methyl ethyl ketone/ethanol/isopropanol=75/8/5/5/7 (by mass parts)

Dichloromethane/cyclopentanone/methanol/isopropanol=80/7/5/8 (by mass parts)

Dichloromethane/methyl acetate/butanol=80/10/10 (by mass parts)

Dichloromethane/cyclohexanone/methanol/hexane=70/20/5/5 (by mass parts)

Dichloromethane/methyl ethyl ketone/acetone/methanol/ethanol=50/20/20/5/5 (by mass parts)

Dichloromethane/1,3-dioxolane/methanol/ethanol=70/20/5/5 (by mass parts)

Dichloromethane/dioxane/acetone/methanol/ethanol=60/20/10/5/5 (by mass parts)

Dichloromethane/acetone/cyclopentanone/ethanol/isobutanol/cyclohexane=65/10/10/5/5/5 (by mass parts)

Dichloromethane/methyl ethyl ketone/acetone/methanol/ethanol=70/10/10/5/5 (by mass parts)

Dichloromethane/acetone/ethyl acetate/ethanol/butanol/hexane=65/10/10/5/5/5 (by mass parts)

Dichloromethane/methyl acetoacetate/methanol/ethanol=65/20/10/5 (by mass parts)

Dichloromethane/cyclopentanone/ethanol/butanol=65/20/10/5 (by mass parts)

### (Non-Chlorinated Solvent)

A non-chlorinated organic solvent suitably used for preparation of a solution of cellulose acylate used to advantage in the invention is described below. In the invention, no particular restriction is imposed on the chemical species of a non-chlorinated organic solvent used so long as the cellulose acylate can dissolve in the chlorinated organic solvent and the resulting solution can satisfactorily attain the purposes of casting and film formation. The non-chlorinated organic solvent used in the invention is preferably a solvent chosen from 3-12C esters, ketones or ethers. These esters, ketones, and ethers may have cyclic structures. Compounds which each contain any two or more of the functional groups included in ether, ketone and ester (namely, —O—, —CO— and —COO—) can be used as main solvents, and other functional groups, such as alcoholic hydroxyl group, may further be present therein. In the case of a solvent having two or more kinds of functional groups, the allowed number of carbon atoms present therein is within the specified range of the compound having any one of the functional groups. Examples of 3-12C esters include ethyl formate, propyl formate, pentyl formate, methyl acetate, ethyl acetate and pentyl acetate. Examples of 3-12C ketones include acetone, methyl ethyl ketone, diethyl ketone, diisobutyl ketone, cyclopentanone, cyclohexanone, methylcyclohexanone and methyl acetylacetate. Examples of 3-12C ethers include diisopropyl ether, dimethoxymethane, dimethoxyethane, dimethoxyethane, 1,4-dioxane, 1,3-dioxolane, tetrahydrofuran, anisole and phenetole. Examples of organic solvents having two or more kinds of functional groups per molecule include 2-ethoxyethyl acetate, 2-methoxyethanol and 2-butoxyethanol.

Non-chlorinated organic solvents used suitably for cellulose acylate, though the choice thereof is made from various viewpoints as mentioned above, are the following.

More specifically, the suitable non-chlorinated solvent is a mixed solvent containing the foregoing non-chlorinated organic solvents as main components, namely a mixture of at least three solvents differing in kind, wherein the first solvent is a single solvent or a mixture of two or more solvents chosen from methyl acetate, ethyl acetate, methyl formate, ethyl formate, acetone, dioxolane or dioxane, the second solvent is chosen from 4-7C ketones or acetoacetates, and the third solvent is chosen from 1-10C alcohol or hydrocarbons, preferably from 1-8C alcohol. When the first solvent is a mixture of two or more of the solvents, the second solvent may be absent. The first solvent is preferably methyl acetate, acetone,

methyl formate, ethyl formate or a mixture of two or more thereof, and the second solvent is preferably methyl ethyl ketone, cyclopentanone, cyclohexanone or methyl acetylacetate, or it may be a mixture of two or more thereof.

The hydrocarbon chain of alcohol as the third solvent may be linear, branched or cyclic, and it is preferably a saturated aliphatic hydrocarbon chain. The hydroxyl group of alcohol may be any of primary, secondary and tertiary ones. Examples of alcohol include methanol, ethanol, 1-propanol, 2-propanol, 1-butanol, 2-butanol, t-butanol, 1-pentanol, 2-methyl-2-butanol and cyclohexanol. In addition, fluorinated alcohol prepared by substitution of fluorine atom(s) for part or all of hydrogen atoms on the hydrocarbon chain can also be used as the alcohol. Examples of such fluorinated alcohol include 2-fluoroethanol, 2,2,2-trifluoroethanol and 2,2,3,3-tetrafluoro-1-propanol.

On the other hand, hydrocarbons usable as the third solvent may have linear, branched or cyclic structures. Any of aromatic hydrocarbons and aliphatic hydrocarbons can be used. The aliphatic hydrocarbons may be saturated or unsaturated ones. Examples of hydrocarbons include cyclohexane, hexane, benzene, toluene and xylene.

These alcohol and hydrocarbons as the third solvent may be used alone or as combinations of two or more thereof, and have no particular restrictions. Suitable examples of alcohol as the third solvent include methanol, ethanol, 1-propanol, 2-propanol, 1-butanol, 2-butanol and cyclohexanol, and those of hydrocarbons include cyclohexane and hexane. Of these solvents, methanol, ethanol, 1-propanol, 2-propanol and 1-butanol are particularly preferred as the third solvent.

As to the mixing proportions of three kinds of solvents, it is preferable that the proportion of the first solvent in the total solvents mixed is from 20 to 95 mass %, that of the second solvent is from 2 to 60 mass % and that of the third solvent is from 2 to 20 mass %, and it is preferable by far that the proportion of the first solvent in the total solvents mixed is from 30 to 90 mass %, that of the second solvent is from 3 to 50 mass % and that of alcohol as the third solvent is from 3 to 25 mass %. Especially suitable mixing proportions are cases where the first solvent constitutes 30 to 90 mass % of the total solvents mixed, the second solvent constitutes 3 to 30 mass % and the third solvent is alcohol and constitutes 3 to 15 mass %.

Details of non-chlorinated organic solvents usable in the invention are descried in JIII Journal of Technical Disclosure No. 2001-1745, pp. 12-16, published by Japan Institute of Invention and Innovation in Mar. 15, 2001.

Examples of a suitable combination of non-chlorinated organic solvents include the following compositions, but not limited to these combinations.

Methyl acetate/acetone/methanol/ethanol/butanol=75/10/5/5/5 (by mass parts)

Methyl acetate/acetone/methanol/ethanol/propanol=75/10/5/5/5 (by mass parts)

Methyl acetate/acetone/methanol/butanol/cyclohexane=75/10/5/5/5 (by mass parts)

Methyl acetate/acetone/ethanol/butanol=81/8/7/4 (by mass parts)

Methyl acetate/acetone/ethanol/butanol=82/10/4/4 (by mass parts)

Methyl acetate/acetone/ethanol/butanol=80/10/4/6 (by mass parts)

Methyl acetate/methyl ethyl ketone/methanol/butanol=80/10/5/5/5 (by mass parts)

Methyl acetate/acetone/methyl ethyl ketone/ethanol/isopropanol=75/8/5/5/7 (by mass parts)

Methyl acetate/cyclopentanone/methanol/isopropanol=80/7/5/8 (by mass parts)

Methyl acetate/acetone/butanol=85/10/5 (by mass parts)

Methyl acetate/cyclopentanone/acetone/methanol/butanol=60/15/14/5/6 (by mass parts)

Methyl acetate/cyclohexanone/methanol/hexane=70/20/5/5 (by mass parts)

Methyl acetate/methyl ethyl ketone/acetone/methanol/ethanol=50/20/20/5/5 (by mass parts)

Methyl acetate/1,3-dioxane/methanol/ethanol=70/20/5/5 (by mass parts)

Methyl acetate/dioxane/acetone/methanol/ethanol=60/20/10/5/5 (by mass parts)

Methyl acetate/acetone/cyclopentanone/ethanol/isobutanol/cyclohexane=65/1/10/5/5/5 (by mass parts)

Methyl formate/methyl ethyl ketone/acetone/methanol/ethanol=50/20/20/5/5 (by mass parts)

Methyl formate/acetone/ethyl acetate/ethanol/butanol/hexane=65/10/10/5/5/5 (by mass parts)

Acetone/methyl acetoacetate/methanol/ethanol=65/20/10/5 (by mass parts)

Acetone/cyclopentanone/ethanol/butanol=65/20/10/5 (by mass parts)

Acetone/1,3-dioxolane/ethanol/butanol=65/20/10/5 (by mass parts)

1,3-Dioxolane/cyclohexanone/methyl ethyl ketone/methanol/butanol=55/20/10/5/5/5 (by mass parts)

Furthermore, it is also possible to use cellulose acylate solutions prepared in the following manners.

In one manner, a cellulose acylate solution is prepared using a 81:8:7:4, by mass parts, mixture of methyl acetate, acetone, ethanol and butanol, filtered and concentrated, and then additional 2 parts by mass of butanol is added to the resulting cellulose acylate solution.

In another manner, a cellulose acylate solution is prepared using a 84:10:4:2, by mass parts, mixture of methyl acetate, acetone, ethanol and butanol, filtered and concentrated, and then additional 4 parts by mass of butanol is added to the resulting cellulose acylate solution.

In still another manner, a cellulose acylate solution is prepared using a 84:10:6, by mass parts, mixture of methyl acetate, acetone and ethanol, filtered and concentrated, and then 5 parts by mass of butanol is further added to the resulting cellulose acylate solution.

In addition to the non-chlorinated organic solvents as recited above, dichloromethane may also be mixed in the dope used in the invention in an amount accounting for 10 mass % or below of the total amount of organic solvents used.

### (Cellulose Acylate Solution Characteristics)

The cellulose acylate solution is a solution prepared by dissolving cellulose acylate in any of the organic solvents as recited above and, in point of suitability for casting in film formation, the concentration thereof is preferably in a range of 10 to 30 mass %, far preferably in a range of 13 to 27 mass %, particularly preferably in a range of 15 to 25 mass %.

As to the method of adjusting the concentration of a cellulose acylate solution to the range as specified above, the intended concentration may be attained at the stage of dissolving cellulose acylate, or a cellulose acylate solution prepared in advance in a low concentration (e.g., 9 to 14 mass %) may be concentrated so as to have the intended high concentration by a concentration operation as described below. Alternatively, a cellulose acylate solution may be prepared in advance in a high concentration and the high concentration may be reduced to the intended low concentration by addition of various additives. There occurs no particular problem so far as the solution of cellulose acylate used to advantage in the invention is prepared so as to have its concentration in the range as specified above no matter what method is used for.

Furthermore, in point of cellulose acylate solubility in a solvent, it is preferable that molecular clusters of cellulose acylate in a dilute solution, which is prepared by diluting a cellulose acylate solution used in the invention to 0.1 to 5 mass % with an organic solvent having the same composition, have their molecular weight in a range of one hundred fifty thousand to fifteen million. And it is preferable by far that the molecular weight of such molecular clusters ranges from one hundred eighty thousand to nine million. The molecular weight of molecular clusters can be determined by a static light-scattering method. For this measurement, it is appropriate to dissolve cellulose acylate so that the inertial radii determined at the same time ranges from 10 to 200 nm, preferably from 20 to 200 nm. Moreover, it is preferable that cellulose acylate is dissolved so that the second virial coefficient is from −2×10⁻⁴ to 4×10⁻⁴ particularly from −2×10⁻⁴ to 2×10⁻⁴.

Now, definitions that the molecular cluster's molecular weight, inertial radius and second virial coefficient have in the invention are mentioned. These values are determined using a static light-scattering method under the following procedure. Although the measurements are made in a dilute concentration range on account of the apparatus used, the measured values reflect behaviors of the dope in a high concentration range according to the invention.

First, cellulose acylate is dissolved in a solvent for dope use to prepare solutions having concentrations of 0.1 mass %, 0.2 mass %, 0.3 mass % and 0.4 mass %, respectively. In order to avoid taking up moisture, cellulose acylate dried at 120° C. for 2 hours is used, and the weighting thereof is made under a 25° C.-10% RH condition. The thus dried cellulose acylate is dissolved in accordance with the method adopted in the dope dissolution (a room-temperature dissolution method, a cooling dissolution method or a high-temperature dissolution method). Successively thereto, the solutions obtained and the same solvent as used therein are filtered through a 0.2-μm filter made of Teflon®. The solutions thus filtered are examined for static light scattering at 10-degree intervals from 30 degrees to 140 degrees under a temperature of 25° C. by use of a light-scattering measurement device (DLS-700, made by Otsuka Electronics Co., Ltd.). The data thus obtained are analyzed in accordance with Berry plot method. As the refractive index required for this analysis, the solvent's refractive index value determined with an Abbe refractometer is used. And the concentration gradient (dn/dc) of refractive index is determined using the solvent and the solutions used in the light-scattering measurement and a differential refractometer (DRM-1021, made by Otsuka Electronics Co., Ltd.).

### (Preparation of Dope)

Next, preparation of a cellulose acylate solution (dope) for film formation by casting is described.

There is no particular restrictions as to the method of dissolving cellulose acylate, so the dissolution of cellulose acylate may be carried out using a room-temperature dissolution method, a cooling dissolution method, a high-temperature dissolution method, or a combination of two or more thereof. These methods are described as the methods for preparation of cellulose acylate solutions, e.g., in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017 and JP-A-11-302388.

As far as those methods for dissolving cellulose acylates in organic solvents are within the scope of the invention, the techniques described therein can be also applied to the invention as appropriate. Details thereof, notably details of no-chlorinated solvents, are described in JIII Journal of Technical Disclosure No. 2001-1745, pages 22 to 25, Japan Institute of Invention and Innovation (Mar. 15, 2001), and the dissolution can be performed according to the methods described therein. Further, although the dope solution of cellulose acylate used to advantage in the invention is generally concentrated and filtered, methods for these operations are also described in detail in JIII Journal of Technical Disclosure No. 2001-1745, page 25, Japan Institute of Invention and Innovation (Mar. 15, 2001). Additionally, in most of the cases where the dissolution is carried out at a high temperature, the temperature required is higher than the boiling point of an organic solvent used. So the dissolution is performed under a pressurized condition.

It is preferable in point of easiness of casting that the cellulose acylate solution has its viscosity and dynamic storage elasticity modulus in the following ranges specified individually. These physical properties are measured as follows: Measurement is made on a 1-mL sample solution by means of a rheometer (CLS 500) equipped with a Steel Cone having a diameter of 4 cm/2° (which are both products of TA Instruments). Under a measurement condition that the temperature is changed from 40° C. to −10° C. at a rate of 2° C./min by means of Oscillation Step/Temperature Ramp, a static non-Newtonian viscosity at 40° C., n (Pa·s), and a storage elasticity modulus at −5° C., G(Pa) are determined. Additionally, the sample solution is previously kept at the measurement starting temperature until the solution temperature becomes constant, and then the measurement is made to start.

It is preferable in the invention that the viscosity at 40° C. is from 1 to 400 Pa·s and the dynamic storage elasticity modulus at 15° C. is 500 Pa or above, and it is preferable by far that the viscosity at 40° C. is from 10 to 200 Pa·s and the dynamic storage elasticity modulus at 15° C. is from 100 to 100×10⁴. Furthermore, the greater the dynamic storage elasticity moduli at low temperatures, the better the results obtained. For instance, the dynamic storage elastic modulus in the case of using a casting support kept at −5° C. is preferably from 1×10⁴ to 100×10⁴ Pa at −5° C., and that in the case of using a casting support kept at −50° C. is preferably from 1×10⁴ to 500×10⁴ Pa at −50° C.

Since the foregoing specific cellulose acylate is used in the invention, the dope obtained is characterized by its high concentration, and a cellulose acylate solution of high concentration and high stability can be obtained without recourse to concentration. For easier dissolution, cellulose acylate may be dissolved in a low concentration first, and then concentrated according to a concentration method. No particular restriction is imposed on the concentration method, but following methods are feasible. For instance, the method in which a solution of a low concentration is introduced into a space between a cylinder and a rotation trajectory of the perimeter of blades installed in the cylinder and rotating in the peripheral direction of the cylinder, and the solvent thereof is evaporated as a temperature difference is given between the solution and the space, thereby preparing a high concentration of solution (as disclosed, e.g., in JP-A-4-259511), or methods in which a heated solution of a low concentration is blown into a vessel from a nozzle, the solvent therein is flash-evaporated while the solution travels from the nozzle to the inner wall of the vessel and, at the same time, the solvent vapor is purged from the vessel and a high concentration of solution is drawn from the bottom of the vessel (as disclosed, e.g., in U.S. Pat. Nos. 2,541,012, 2,858,229, 4,414,341 and 4,504,355) can be adopted.

Prior to casting, it is preferable that the solution is filtered with an appropriate filter material, such as gauze or flannel, to eliminate extraneous matter, including undissolved matter, dirt and impurities. For filtration of the cellulose acylate solution, it is advantageous to use a filter with an absolute filtration accuracy of 0.1 to 100 μm, preferably 0.5 to 25 μm. The thickness of a filter used is preferably from 0.1 to 10 mm, far preferably from 0.2 to 2 mm. In this case, it is appropriate that the filtration be performed under a pressure of 1.6 MPa or below, preferably 1.2 MPa or below, far preferably 1.0 MPa or below, particularly preferably 0.2 MPa or below. Suitable examples of a filter material used herein include hitherto known materials, such as glass fiber, cellulose fiber, filter paper, fluoropolymers including tetrafluoroethylene resin. And ceramics and metals in particular can be used to advantage. As far as the cellulose acylate solution having its viscosity in a range in question can be cast at the time of film formation, the viscosity of the solution immediately before the film formation may be in that range. In general, the viscosity of the solution is adjusted preferably to the range of 10 Pa·s to 2,000 Pa·s, far preferably to the range of 30 Pa·s to 1,000 Pa·s, further preferably to the range of 40 Pa·s to 500 Pa·s. In addition, there is no particular restriction on the temperature just before casting so long as it is a temperature at which casting is carried out. The temperature just before casting is preferably from −5 to 70° C., far preferably from −5 to 55°.

### (Film Formation)

Cellulose acylate film used to advantage in the invention can be obtained by film formation using the cellulose acylate solution (dope) as mentioned above. As to a film formation method and apparatus, the solution-casting film formation method and apparatus currently in use for formation of cellulose triacetate film can be utilized. More specifically, the dope (cellulose acylate solution) prepared in a dissolving machine (boiler) is once stored in a storage pot in order to eliminate foams in the dope, and thereby the dope preparation is finished. The dope is fed from a dope outlet into a pressure die through a pressure metering gear pump ensuring a quantitative feed of high accuracy by the number of its revolutions, and cast evenly from a mouthpiece (slit) of the pressure die on to an endlessly running metal support in a casting section. At the strip-off point where the metal support makes a nearly one circuit, half-dried dope film (referred to as web, too) is stripped off the metal support. The web obtained is dried as it is conveyed with a tenter in a condition that the width of the web is kept by both web edges being pinched with clips, and then the web is conveyed with a group of rolls installed in a drier and thereby the drying thereof is completed. The completely dried web is taken up in a desired length with a winder. The combination of a tenter and a group of rolls in a drier varies depending on its intended use. In the solution-casting film formation method applied to functional protective films for electronic displays, coating apparatus for surface treatment of film, such as formation of a subbing layer, an antistatic layer, an antihalation layer and a protective layer, is often added in addition to the solution-casting film formation apparatus. Each of manufacturing processes is briefly described below, but the scope of the invention is not limited to this description.

In the case of making cellulose acylate film by a solvent casting method, to begin with, the cellulose acylate solution (dope) is cast over a drum or a band and the solvent is made to evaporate, thereby forming a film. As to the dope before casting, it is preferable that the dope concentration is adjusted to the range of 5 to 40 mass % on a solids basis. The drum surface or the band surface is preferably polished to a mirror-smooth surface. In addition, the dope is preferably cast over a drum or band having a surface temperature of 30° C. or below, and it is particularly preferred that the metal support temperature is in the range of −10° C. to 20° C. Alternatively, the methods disclosed in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650 can be applied to the invention.

### (Multilayer Casting)

The cellulose acylate solution may be cast as a single-layer solution over a smooth band or drum as a metal support, or a plurality of cellulose acylate solutions may be cast in a multilayer form. When a plurality of cellulose acylate solutions are cast, film may be formed as the solutions are cast respectively from a plurality of casting ports provided at intervals along the traveling direction of the metal support so that one solution layer is superposed on another solution layer. To this case, the methods disclosed, e.g., in JP-61-158414, JP-A-1-122419 and JP-A-11-198285 are applicable. Alternatively, cellulose acylate solutions may be formed into a film by casting from two casting ports, and this film formation can be performed, e.g., according to the methods disclosed in JP-B-60-27562, JP-A-61-94724, JP-A-61-947245, JP-A-61-104813, JP-A-61-158413 and JP-A-6-134933. On the other hand, as disclosed in JP-A-56-162617, cellulose acylate film may be formed using the method in which a flow of high-viscosity cellulose acylate solution is wrapped up in a low-viscosity cellulose acylate solution and both the high- and low-viscosity cellulose acylate solutions are extruded at the same time. Furthermore, as disclosed in JP-A-61-94724 and JP-A-61-94725, it is also a preferred mode that the outer solution contains an alcohol component as a poor solvent in a greater amount than the inner solution. In still another mode, multilayer film can be made by using two casting ports, forming film on a metal support by using a solution from the first casting port and stripping the film off the support, and casting another solution from the second casting port over the film surface having undergone contact with the metal support. Such film making can be performed using the method as disclosed in JP-B-44-20235. The cellulose acylate solutions used for casting may be the same or different, and there is no particular restriction thereon. In order to impart functions to a plurality of cellulose acylate layers, it is enough to extrude cellulose acylate solutions having the corresponding functions from their respective casting ports. Additionally, the cellulose acylate solution can be cast simultaneously with solutions for other functional layers (e.g., an adhesive layer, a dye layer, an antistatic layer, an antihalation layer, a UV absorbing layer, a polarization layer).

For achieving the required film thickness by a single-layer solution currently in use, it is necessary to extrude a cellulose acylate solution of high concentration and high viscosity. Since such a cellulose acylate solution is likely to be poor in stability, solid matter develops therein and often causes a problem that the film formed has pimple trouble or poor planarity. An answer to such a problem consists in that a plurality of cellulose acylate solutions are cast in relatively small amounts from a plurality of casting ports, and thereby not only solutions of high viscosity can be extruded on to a metal support at the same time to result in formation of film with improved planarity and excellent surface quality, but also thick cellulose acylate solutions can be used to result in reduction in drying load and enhancement of film production speed.

In the case of co-casting, the inner thickness and the outer thickness have no particular limitations, but it is appropriate that the outer thickness constitute 1 to 50%, preferably 2 to 30%, of the total film thickness. Herein, the outer thickness is defined as the sum total of the thickness of the layer brought into contact with a metal support and the thickness of the layer brought into contact with the air. In the co-casting, cellulose acylate solutions differing in concentration of each additive, such as a plasticizer, a ultraviolet absorbent or a matting agent, can also be cast together, thereby forming a cellulose acylate film having a multilayer structure. For instance, it is possible to make a cellulose acylate film having a skin layer/core layer/skin layer structure. Herein, a matting agent, for example, can be added in a greater amount to the skin layers, or added only to the skin layers. On the other hand, a plasticizer and an ultraviolet absorbent can be added in greater amounts to the core layer than the skin layers, or added to the core layer alone. Furthermore, the plasticizers added to the core layer and the skin layer may be different in type and the ultraviolet absorbent added thereto may also be different in type. For instance, it is possible to incorporate at least either a low-volatility plasticizer or ultraviolet absorbent into the skin layers and add a highly plastic plasticizer or a highly efficient ultraviolet absorbent to the core layer. It is also a preferred mode that a stripping accelerator is incorporated in only the skin layer on the metal support side. For gelling the solution by cooling the metal support in a cooled drum method, it is also favorable to add alcohol as a poor solvent in a greater amount to the skin layer. The skin layer and the core layer may have different Tg values, and it is preferable that the Tg of the core layer is lower than that of the skin layer. In addition, the viscosity of the cellulose acylate solution at casting-time may differ between the skin layer and the core layer, and it is preferable that the viscosity of the skin layer is lower than that of the core layer, but the viscosity of the core layer may be lower than that of the skin layer.

### (Casting Method)

Examples of a solution casting method include a method of extruding prepared dope evenly on to a metal support from a pressure die, a doctor blade method in which the thickness of dope once cast over a metal support is adjusted with the blade, and a method of using a reverse roll coater in which thickness adjustment is made with a roll rotating reversely. Of these methods, the method of using a pressure die is preferable. The pressure die includes a coat hanger type and a T-die type, and both types are favorably used. In addition to those methods, various known methods for forming cellulose triacetate solutions into films by casting can be applied, and the same effects as described in documents can be achieved by setting conditions with consideration given to differences, e.g., in boiling points of solvents used.

An endlessly-running metal support used in forming the cellulose acylate film used to advantage in the invention is a drum whose surface is mirror-finished by chromium plating, or a stainless belt (which may be referred to as “band”) whose surface is mirror-finished by surface polishing. As to the pressure die used, only one or more than one pressure die may be placed above the metal support, but it is appropriate that one or two pressure dies be placed. When two or more pressure dies are placed, the dope may be allocated in different proportions to the respective dies, and fed to the pressure dies from a plurality of high-precision metering gear pumps in their respective proportions. The temperature of cellulose acylate solution(s) used for casting is preferably from −10° C. to 55° C., far preferably from 25° C. to 50° C. In the casting process, the temperature may be the same throughout the process, or different from one point to another in the process. In the case of differing in temperature, it is adequate for the purpose that the dope just before casting has the intended temperature.

### (Drying)

As to general methods for drying dope on a metal support, which is concerned with making a cellulose acylate film, there are known a method of giving a hot air to the front side of the metal support (a drum or a belt), or the surface of web on a metal support, a method of giving a hot air to the back of a drum or a belt, and a back liquid heat transfer method in which a drum or a belt is heated by heat transfer from a temperature-controlled liquid brought into contact with the back of the belt or the drum, or the side opposite to the dope-cast side of the drum or the belt, and thereby the surface temperature is controlled. Of these methods, the back liquid heat transfer method is preferred over the others. The surface temperature of a metal support before casting may be set at any value as far as it is below the boiling points of all solvents used for the dope. For increasing a drying speed or making flowability on the metal support disappear, however, it is favorable that the surface temperature is set at a temperature 1-10° lower than the lowest boiling point among those of all solvents used. Incidentally, the case of cooling the cast dope and stripping it off without drying is free from such a restriction.

In order to obtain film having a great thermal shrinkage ratio, as mentioned above, the highest temperature during the drying is preferably adjusted to 120° C. or below.

In order to suppress light leakage in the case of viewing a polarizing plate from an oblique direction, it is required that the transmission axis of a polarizer and the in-plane slow axis of a cellulose acylate film are arranged in parallel with each other. In order to perform continuous lamination of the polarizer in roll film form and a protective film formed of the cellulose acylate film in roll film form, it becomes necessary for the in-plane slow axis of the protective film in roll film form to be parallel to the width direction of the film since the transmission axis of a polarizer continuously manufactured in the form of a roll film is generally parallel to the width direction of the roll film. Therefore, it is preferable that the cellulose acylate film is stretched more in the width direction. The stretching treatment may be carried out during the film formation process, or it may be given to web wound into a roll after film formation. In the former case, the film in a state of containing residual solvents may be stretched, and the stretching can be favorably performed when the content of residual solvents is from 2 to 30 mass %.

The suitable thickness of the thus dried cellulose acylate film which can be used to advantage in the invention, though depends on the intended purposes, is generally from 5 to 500 μm, preferably from 20 to 300 μm, particularly preferably from 30 to 150 μm. The film thickness may be adjusted to a desired value by appropriately controlling the concentrations of solid components in the dope, the gap in the slit of a die mouthpiece, the pressure of extrusion from a die and the running speed of a metal support.

The width of the thus obtained cellulose acylate film is preferably from 0.5 to 3 m, far preferably from 0.6 to 2.5 m, further preferably from 0.8 to 2.2 m. The per-roll length thereof is preferably from 100 to 10,000 m, far preferably from 500 to 7,000 m, further preferably from 1,000 to 6,000 m. Prior to winding into a roll, it is favorable to knurl at least one edge of the film. The width of the knurled edge is from 3 mm to 50 mm, preferably from 5 mm to 30 mm, and the height is preferably from 0.5 to 500 μm, far preferably from 1 to 200 μm. This knurling may be made by one-sided embossment or both sided-embossment.

Variations in Re(590) values in the width direction of film is preferably ±5 nm, far preferably ±3 nm. And variations in Rth(590) values in the thickness direction is preferably ±10 nm, far preferably ±5 nm. In addition, variations in Re values and Rth values in the longitudinal direction is preferably within the range of variations in those in the width direction.

### (Optical Characteristics of Cellulose Acylate Film)

The present cellulose acylate film is usable as a protective film of a polarizing plate, and can also be used to particular advantage as a retardation film adaptable to various modes of liquid crystal display devices.

When the present cellulose acylate film is used as a retardation film, suitable optical characteristics of cellulose acylate film vary depending on the liquid crystal modes.

When the present cellulose acylate film is used in an OCB-mode liquid crystal display device, the Re value thereof is preferably from 10 to 100 nm, far preferably from 20 to 70 nm, and the Rth value thereof is preferably from 50 to 300 nm, far preferably from 100 to 250 nm.

For use in a TN-mode liquid crystal display device, the Re value is preferably from 0 to 50 nm, far preferably from 2 to 30 nm, and the Rth value is preferably from 10 to 200 nm, far preferably from 30 to 150 nm.

For use in an IPS-mode liquid crystal display device, the Re value is preferably from 0 to 5 nm, far preferably from 0 to 2 nm, and the Rth value is preferably from −20 to 20 nm, far preferably from −10 to 10 nm.

In the COB mode and the TN mode, the cellulose acylate film having its retardation values in the foregoing ranges can be used as an optical compensation film by being coated with an optically anisotropic layer.

The birefringence factor (Δn: nx−ny) of the cellulose acylate film is preferably from 0.00 to 0.002. And the birefringence factor in the thickness direction [(nx+ny)/2−n] of support and opposed films each is preferably from 0.00 to 0.04.

As to the cellulose acylate film used to advantage, variations in angle of its in-plane slow axis with respect to the reference direction of roll film is preferably in the range of −2° to +2°, far preferably in the range of −1° to +1°, particularly preferably in the range of −0.5° to +0.50. The term “reference direction” as used herein means the longitudinal direction of the roll film in the case of longitudinal stretching of the cellulose acylate film, while it means the width direction of the roll film in the case of transverse stretching.

### (Melt Film Formation)

To a method of manufacturing the present optical film, melt film formation may be applied. More specifically, raw materials including polymer and additives may be molten by heating and made into film by extrusion injection molding, or they may be sandwiched between 2 plates and made into film by presswork.

The temperature for heat melting has no particular limitations so long as it is a temperature at which the polymer as a raw material is molten uniformly. To be concrete, the heating is carried out at a temperature equal to or higher than the melting or softening temperature of the raw material polymer. In order to obtain uniform film, it is preferable to carry out the heat melting at a temperature higher, preferably 5 to 40° C. higher, particular 8 to 30° C. higher, than the melting point of the raw material polymer.

### (Oriented Film)

An optical compensation film may have an oriented film between the present cellulose acylate film and an optically anisotropic layer. On the other hand, it is also feasible that an oriented film is utilized only for making an optically anisotropic layer and, after the optically anisotropic layer is formed on the oriented film, the optically anisotropic layer alone is transferred to the present cellulose acylate film.

In the invention, the oriented film is preferably a layer made up of cross-linked polymers. The polymers used in the oriented film may be either polymers cross-linkable by themselves or polymers cross-linked by a cross-linking agent. The oriented film can be made by forming cross-links between polymers having functional groups or polymers having undergone introduction of functional groups through application of light or heat, or change in pH; or by forming cross-links between polymers through introduction of binding groups originated from a cross-linking agent as a highly reactive compound.

The oriented film made up of cross-linked polymers can generally be formed by coating on a substrate a solution containing a polymer or a mixture of a polymer and a cross-linking agent, and then heating the solution coated.

For preventing the oriented film from developing dust during the rubbing process described blow, it is appropriate that the cross-linking degree of the oriented film be heightened in advance. When the value obtained by subtracting a ratio of the amount of a cross-linking agent remaining after cross-linking treatment (Ma) to the amount of the cross-linking agent added to a coating solution (Mb), an Ma/Mb ratio, from 1, namely the value of (1−(Ma/Mb)), is defined as a cross-linking degree, the cross-linking degree is preferably from 50% to 100%, far preferably from 65% to 100%, particularly preferably from 75% to 100%.

As polymers used for the oriented film in the invention, any of polymers cross-linkable by themselves and polymers cross-linked with a cross-linking agent can be used. Of course, polymers having both functions can also be used. Examples of these polymers include polymers such as polymethyl methacrylate, acrylic acid-methacrylic acid copolymer, styrene-maleimide copolymer, polyvinyl alcohol, modified polyvinyl alcohol, poly(N-methylolacrylamide), styrene-vinyl toluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, carboxymethyl cellulose, gelatin, polyethylene, polypropylene and polycarbonate; and compounds such as silane coupling agents. Suitable polymers are water-soluble polymers, such as poly(N-methylolacrylamide), carboxymethyl cellulose, gelatin, polyvinyl alcohol and modified polyvinyl alcohol. Of these polymers, gelatin, polyvinyl alcohol and modified polyvinyl alcohol are preferred over the others, and polyvinyl alcohol and modified polyvinyl alcohol in particular can be used to advantage.

In the case of applying polyvinyl alcohol or modified polyvinyl alcohol directly to the cellulose acylate film in the invention, it is preferable to provide a hydrophilic subbing layer or to carry out saponification treatment.

Of the polymers recited above, polyvinyl alcohol and modified polyvinyl alcohol are used to advantage.

For instance, there is polyvinyl alcohol having its saponification degree in the range of 70 to 100%. In general, the saponification degree is preferably from 80 to 100%, far preferably from 82 to 98%. The polymerization degree of polyvinyl alcohol is preferably in the range of 100 to 3,000.

Examples of modified polyvinyl alcohol include polyvinyl alcohol modified by copolymerization (wherein the modifying group introduced is, e.g., COONa, Si(OX)₃, N(CH₃)₃.Cl, C₉H₁₉COO, SO₃Na or C₁₂H₂₅), polyvinyl alcohol modified by chain transfer (wherein the modifying group introduced is, e.g., COONa, SH or SC₁₂H₂₅) and polyvinyl alcohol modified by block polymerization (wherein the modifying group introduced is, e.g., COOH, CONH₂, COOR or C₆H₅). The suitable polymerization degree is also from 100 to 3,000. Of those polymers, unmodified or modified polyvinyl alcohol having a saponification degree of 80 to 100% is preferred,

and unmodified or modified polyvinyl alcohol having a saponification degree of 85 to 95% is preferred by far.

In order to impart adhesiveness of the optically anisotropic layer to the cellulose acylate film, introduction of a cross-linking or polymerization active group is preferred, and suitable examples of such a case are described in detail in JP-A-8-338913.

When a hydrophilic polymer like polyvinyl alcohol is used in the oriented film, it is appropriate to control the percentage of moisture content from the viewpoint of film hardness. The percentage of moisture content is preferably from 0.4% to 2.5%, far preferably from 0.6% to 1.6%. The percentage of moisture content can be measured with a commercially available moisture-percentage measuring device utilizing the Karl Fischer technique.

It is preferable that the oriented film has a thickness of 10 μm or below.

### (Polarizing Plate)

The invention provides a polarizing plate having a polarizing film and a pair of protective films between which the polarizing film is sandwiched, wherein at least one of the protective films includes the cellulose acylate film as described above. For instance, the polarizing plate usable herein can be prepared by dyeing a polarizing film formed of, e.g., polyvinyl alcohol film with iodine, stretching the dyed film and laminating protective films on both sides of the stretched film. The polarizing plate is placed outside a liquid crystal cell. And it is preferable that a pair of polarizing plates, which each have a polarizing film and a pair of protective films between which the polarizing film is sandwiched, are arranged so that a liquid crystal cell is sandwiched between them. Additionally, the protective film located on the side of a liquid crystal cell is preferably the cellulose acylate film or optical compensation film according to the invention.

### <<Adhesive>>

An adhesive for bonding the polarizing film and the protective film together is not particularly limited, but aqueous solutions of PVA resins (including PVA modified with acetoacetyl groups, sulfonic acid groups, carboxyl groups or oxyalkylene groups) and boron compounds can be given as examples thereof. Of such additives, PVA resins are preferred over the others. The thickness of an additive layer after drying is preferably from 0.01 to 10 microns, particularly preferably from 0.05 to 5 microns.

### <<Through Process for Manufacturing Polarizing Film and Protective Film>>

The manufacturing process of a polarizing plate usable in the invention includes a drying step in which the film stretched for polarizing film use is shrunken to reduce the content of volatile component therein. After or during the drying step, it is preferable that a protective film is laminated on at least one side of the polarizing film and then subjected to heating. As a concrete method for lamination, it is possible to adopt the method in which a protective film is laminated on a polarizing film with the aid of an adhesive while holding both edges of the polarizing film in the drying step, and then deckle edges of the laminate obtained are cut away; or the method in which the film for polarizing film use is released from its both-edges-holding member after drying, the both edges of the film is cut away, and then a protective film is laminated. For cutting deckle edges, usual techniques, such as a technique of using a cutting tool including a cutter and a technique of using laser, can be adopted. After the lamination, it is preferable to carry out heating for the purpose of drying the adhesive and enhancing polarization capability. The heating condition, though varies depending on the adhesive used, is preferably 30° C. or above, far preferably from 40° C. to 100° C., further preferably from 50° C. to 90° C., in the case of a water-based adhesive. In point of performance and manufacturing efficiency, it is much preferable that operations in those steps are performed in a through process.

### <<Performance of Polarizing Plate>>

As to the optical properties and durability (short-term and long-term keeping qualities), it is preferable that the polarizing plate according to the invention has performance equal to or superior to those of commercially available superhigh contrast products (e.g., HLC2-5618, a product of Sanritz Corporation). More specifically, it is advantageous for the present polarizing plate to have a visible light transmittance of 42.5% or above and a polarization degree [{(Tp−Tc)/(Tp+Tc)}^{1/2}] of 0.9995 or above (wherein Tp stands for parallel transmittance and Tc stands for cross transmittance). When the present polarizing plate is allowed to stand for 500 hours in the 60° C.-90% RH atmosphere or the dry atmosphere at 80° C., the rate of light transmittance change occurring in the plate before and after the storage is preferably 3% or below, far preferably 1% or below, as expressed in absolute value, and the rate of polarization degree change occurring in the plate before and after the storage is preferably 1% or below, far preferably 0.1% or below, as expressed in absolute value.

### (Surface Treatment of Cellulose Acylate Film)

In some cases, the cellulose acylate film used to advantage in the invention can improve its adhesion to various functional layers (e.g., an undercoat layer and a backing layer) by undergoing surface treatment. As the surface treatment, glow discharge treatment, ultraviolet irradiation treatment, corona treatment, flame treatment, acid treatment or alkali treatment can be used. The glow discharge treatment used herein may be either low temperature plasma generated under low-pressure gas of 10⁻³ to 20 Torr, or plasma generated under atmospheric pressure. The plasma excitation gas is a gas that undergoes plasma excitation under the conditions as mentioned above, with examples including argon, helium, neon, krypton, xenon, nitrogen, carbon dioxide, CFCs, such as tetrafluoromethane, and mixtures of two or more thereof. Details of such treatment are described in JIII Journal of Technical Disclosure No. 2001-1745, pp. 30-32, Japan Institute of Invention and Innovation (Mar. 15, 2001). Additionally, in the plasma treatment under atmospheric pressure, on which attention has focused in recent years, irradiation energy of 20 to 500 kGy under 10 to 1,000 KeV, preferably irradiation energy of 20 to 300 kGy under 30 to 500 KeV, is used. Of those surface treatments, alkali saponification treatment is preferred over the others and exceedingly effective as surface treatment of the cellulose acylate film.

### (Alkali Saponification Treatment)

The alkali saponification treatment is preferably carried out using a method of immersing the cellulose acylate film directly in a saponifying solution tank or a method of coating the cellulose acylate film with a saponifying solution. Examples of a coating method usable herein include a dip coating method, a curtain coating method, an extrusion coating method, a bar coating method and an E-type coating method. As a solvent used in a coating solution for alkali saponification treatment, it is preferable to choose a solvent which has good ability to wet the cellulose acylate film since the saponification solution is applied to the cellulose acylate film and ensures a good surface condition without roughening the cellulose acylate film surface. More specifically, alcohol solvents, notably isopropyl alcohol, are used to advantage. Alternatively, an aqueous solution of surfactant can be used as a solvent. As the alkali used in a coating solution for alkali saponification, alkalis soluble in the solvents recited above are suitable, and KOH and NaOH are more suitable. The pH of a coating solution for saponification is preferably 10 or higher, far preferably 12 or higher. The reaction time for alkali saponification at room temperature is preferably from 1 second to 5 minutes, far preferably from 5 seconds to 5 minutes, particularly preferably from 20 seconds to 3 minutes. After the alkali saponification reaction, it is preferable that the saponifying solution-coated surface is rinsed with water or acid, and further washed with water.

Furthermore, it is preferable that the polarizing plate relating to the invention has an optically anisotropic layer on its protective film.

The optically anisotropic layer has no particular restriction as to the material thereof, but it may be made from any material chosen from liquid-crystalline compounds, liquid-noncrystalline compounds, inorganic compounds or inorganic-organic complex compounds. As to the liquid-crystalline compounds, low molecular compounds having polymerizable groups are usable. In this case, they are brought into an oriented state and the oriented state thereof is fixed through the polymerization by light or heat. And high-molecular liquid-crystalline compounds can also be used. In this case, they are brought into a oriented state by heating and their orientation is fixed in a glassy state by cooling. The structures of usable liquid-crystalline compounds may be any of discotic structures, rod-shape structures and structures showing optical biaxiality. As to the liquid-noncrystalline compounds, high polymers having aromatic rings, such as polyimide and polyester, can be used.

The optically anisotropic layer can be formed using various techniques, such as coating, vapor deposition and sputtering techniques.

When the optically anisotropic layer is provided on the protective film of the polarizing plate, a tacky layer is provided outside the optically anisotropic layer when viewed from the side of the polarizer.

In addition, it is advantageous for the polarizing plate relating to the invention to have at least one of a hard coating layer, an antiglare layer and an antireflective layer on the surface of the protective film provided on at least one side thereof. In other words, when the polarizing plate is used in a liquid crystal display device, it is preferable that the protective film arranged on the side opposite to a liquid crystal cell is provided with a functional layer, such as an antireflective layer. The functional layer to be provided is at least one of a hard coating layer, an antiglare layer and an antireflective layer. Incidentally, it is not necessary to provide these layers as separate layers. For instance, an antiglare function may be imparted to a hard coating layer or an antireflective layer and, instead of providing two layers, e.g., an antireflective layer and an antiglare layer, one layer may be made to function as an antiglare antireflective layer.

### (Antireflective Layer)

In the invention, it is appropriate that on the protective film of the polarizing plate be provided an antireflective layer formed by laminating a light-scattering layer and a low refractive index layer in the order of mention or by laminating a medium refractive index layer, a high refractive index layer and a low refractive index layer in the order of mention. Suitable examples of these layers are described below. In the former layer structure, the specular reflectivity generally becomes 1% or above, so the resulting film is referred to as “Low Reflection (LR) Film”. In the latter layer structure, on the other hand, it becomes possible to achieve the specular reflectivity of 0.5% or below, so the resulting film is referred to as “Anti Reflection Film (AR)”.

### (LR Film)

Suitable examples of an antireflective layer having a light-scattering layer and a low refractive index layer (LR film), which are provided on the protective film of the polarizing plate, are mentioned below.

In the light-scattering layer, it is preferable that matting particles are dispersed and the refractive index of a material forming the matting particles-free region of light-scattering layer is from 1.50 to 2.00. The refractive index of the low refractive index layer is preferably from 1.20 to 1.49. In the invention, the light-scattering layer combines anti-glaring properties with hard coating properties, and it may be a single layer or may be constituted of a plurality of layers, e.g., two to four layers.

From the viewpoint of achieving sufficient anti-glaring properties and a visually uniform matte feeling, it is preferable that the antireflective layer is designed to have such a surface asperity profile that the center-line average roughness Ra is from 0.08 to 0.40 μm, the ten-point average roughness Rz is at most 10 times as great as Ra, the average mountain-valley distance Sm is from 1 to 100 μm, the standard deviation of the convexity heights from the deepest point of asperity is 0.5 μm or below, the standard deviation of average mountain-valley distance Sm based on the center line is 20 μm or below and the proportion of faces having a slope angle of 0 to 5° is 10% or above.

In addition, it is preferable because the tint of reflected light becomes neutral that the chromaticity of reflected light under the light source of CIE type C is adjusted to a* value range of −2 to 2 and b* value range of −3 to 3, and beside, the ratio between the minimum reflectivity and the maximum reflectivity in the wavelength range of 380 nm to 780 nm is adjusted to a range of 0.5 to 0.99. Furthermore, when the antireflective layer is used in a liquid crystal display device, adjustment of the b* value of transmitted light under the C light source to the range of 0 to 3 is preferable because a yellow tint in white-display sate is reduced. Additionally, when brightness distribution is measured on the film under a condition that 120 μm×40 μm mesh is inserted between a planar light source and the film, the standard deviation of 20 or below with respect to the brightness distribution is favorable because glare is reduced by application of the present polarizing plate to a high-definition panel.

As to the optical characteristics of the antireflective layer usable in the invention, adjustments of the specular reflectivity to 2.5% or below, the transmittance to 99% or above and the 60-degree glossiness to 70% or below are favorable because reflection of extraneous light can be controlled and the viewability can be enhanced. As to the specular reflectivity in particular, adjustment to 1% or below, especially 0.5% or below, is preferred. Furthermore, it is favorable from the viewpoint of achieving glare prevention and reduction in blurred letters on a high-definition LCD panel that the haze is adjusted to a range of 20% to 50%, the inside haze/total haze ratio to a range of 0.3 to 1, the drop in haze value to 15% or below when comparison is made between the haze value up to the light-scattering layer and the haze value after forming a low refractive index layer, the transmission image definition in the comb width of 0.5 mm to a range of 20% to 50% and the transmittance ratio of light transmitted vertically to the antireflective layer surface to light transmitted in the direction slanting at an angle of 20 from the vertical direction to a range of 1.5 to 5.0.

### (Low Refractive Index Layer)

The refractive index of a low refractive index layer which can be used in the invention is preferably from 1.20 to 1.49, far preferably from 1.30 to 1.44. Further, it is advantageous from the viewpoint of reducing the reflectivity that the low refractive index layer satisfies the following mathematical expression (19).

(m/4)λ×0.7<n_{L}d_{L}<(m/4)λ×1.3 Expression (19)

In the above expression, m is a positive odd number, n_{L} is the refractive index of the low refractive index layer and d_{L} is the thickness (nm) of the layer of a low refractive index. In addition, λ is a wavelength and a value ranging from 500 to 550 nm.

Materials forming the low refractive index layer are described below.

The low refractive index layer preferably contains a fluorine-containing polymer as a binder with a low refractive index. Fluorine-containing polymers used suitably as the binder are those which have their kinetic friction coefficients in the range of 0.03 to 0.20, their contact angles to water in the range of 90° to 120° and their purified-water sliding angles in the range of 70° or below and can form cross-links when heat or ionizing radiation is applied. When the polarizing plate according to the invention is inserted into an image display unit, it is favorable that the strength to peel a commercially available adhesive tape off the low refractive index layer is adjusted to as small a value as possible, preferably 500 gf (4.9N) or below, far preferably 300 gf (2.94N) or below, particularly preferably 100 gf (0.98N) or below, as measured with a tension tester. By doing so, a sticker and a memo affixed to the layer are easy to peel away. Furthermore, the higher the surface hardness measured with a microhardness meter, the less scratch-prone the low refractive index layer. So the surface hardness is preferably 0.3 GPa or above, far preferably 0.5 GPa or above.

Examples of a fluorine-containing polymer usable in the low refractive index layer include hydrolysis products and dehydration condensation products of silane compounds containing perfluoroalkyl groups (e.g., heptadecafluoro-1,1,2,2-tetrahydrodecyl)triethoxysilane), and fluorine-containing copolymers having as constituents fluorine-containing monomer units and constitutional units for imparting cross-linking reactivity.

Examples of a fluorine-containing monomer include fluoroolefins (such as fluoroethylene, vinylidene fluoride, tetrafluoroethylene, perfluorooctylethylene, hexafluoropropylene and perfluoro-2,2-dimethyl-1,3-dioxol), partially or completely fluorinated alkyl ester derivatives of (meth)acrylic acid (such as Biscoat 6FM, a product of Osaka Organic Chemical Industry Ltd., and M-2020, a product of Daikin Industries, Ltd.) and completely or partially fluorinated vinyl ethers. Of these monomers, perfluoroolefins are preferred over the others, and hexafluoropropylene in particular can be used to advantage from the viewpoints of refractive index, solubility, transparency and availability.

Examples of a constitutional unit for imparting cross-linking reactivity include constitutional units obtained by polymerization of monomers having in advance self-cross-linking functional groups in their individual molecules, such as glycidyl (meth)acrylate and glycidyl vinyl ether, constitutional units obtained by polymerization of monomers having carboxyl, hydroxyl, amino or sulfo groups (e.g., (meth)acrylic acid, methylol (meth)acrylate, hydroxylalkyl (meth)acrylate, allyl acrylate, hydroxyethyl vinyl ether, hydroxybutyl vinyl ether, maleic acid, crotonic acid), and constitutional units obtained by introducing groups capable of causing cross-linking reaction, such as (meth)acryloyl group, into the constitutional units as recited above by macromolecular reaction (wherein such groups can be introduced by use of, e.g., a technique of reacting acrylic acid chloride with hydroxyl group).

Besides copolymerizing the fluorine-containing monomer units and the constitutional units for imparting cross-linking reactivity, it is also possible to copolymerize fluorine-free monomers as appropriate in view of transparency of the coating formed. The monomer units usable in combination with the foregoing constitutional units have no particular restrictions, so examples thereof can include olefins (such as ethylene, propylene, isoprene, vinyl chloride and vinylidene chloride), acrylic acid esters (such as methyl acrylate, ethyl acrylate and 2-ethylhexyl acrylate), methacrylic acid esters (such as methyl methacrylate,

ethyl methacrylate, butyl methacrylate and ethylene glycol dimethacrylate), styrene derivatives (such as styrene, divinylbenzene, vinyltoluene and α-methylstyrene), vinyl ethers (such as methyl vinyl ether, ethyl vinyl ether and cyclohexyl vinyl ether), vinyl esters (such as vinyl acetate, vinyl propionate and vinyl succinate), acrylamides (such as N-t-butylacrylamide and N-cyclohexylacrylamide), methacrylamides, and acrylonitrile derivatives.

In combination with the polymers recited above, curing agents may be used, if needed, as disclosed in JP-A-10-25388 and JP-A-10-147739.

### (Light-Scattering Layer)

A light-scattering layer is formed for the purposes of giving the film light diffusivity coming from its surface and/or internal scattering and properties of a hard coating for enhancement of scratch resistance. Accordingly, the light-scattering layer formed contains a binder for imparting thereto properties of a hard coating, matting particles for imparting thereto light diffusivity and, if needed, inorganic fillers for an increase in refractive index, prevention of shrinkage by cross-linking and enhancement of strength. By providing such a light-scattering layer, the light-scattering layer can function as an anti-glare layer also, so the polarizing plate results in possession of an anti-glare layer.

The thickness of the light-scattering layer is preferably from 1 to 10 μm, far preferably from 1.2 to 6 μm, from the viewpoint of imparting properties of a hard coating to the layer. This is because, when the thickness of the light-scattering layer is the lower limit or above, the layer hardly causes a hardness-shortage problem; while, when the thickness is the upper limit or below, the layer can avoid worsening of curling and brittleness and thereby hardly develops the trouble of having a want of working suitability.

The binder in the scattering layer is preferably a polymer having as its main chain a saturated hydrocarbon chain or a polyether chain, far preferably a polymer having as its main chain a saturated hydrocarbon chain. Furthermore, it is advantageous for the binder polymer to have a cross-linking structure. The binder polymer having a saturated hydrocarbon chain as its main chain is preferably a polymer prepared from an ethylenic unsaturated monomer. As a binder polymer having a saturated hydrocarbon chain as its main chain and a cross-linked structure, a (co)polymer prepared from a monomer having two or more ethylenic unsaturated groups is suitable. For making the binder polymer have a high refractive index, it is also possible to choose a monomer having in its molecular structure an aromatic ring and at least one atom selected from a halogen atom other than a fluorine atom, a sulfur atom, a phosphorus atom or a nitrogen atom.

Examples of a monomer having at least two ethylenic unsaturated groups include polyhydric alcohol esters of (meth)acrylic acid [such as ethylene glycol di(meth)acrylate, butanediol di(meth)acrylate, hexanediol di(meth)acrylate, 1,4-cyclohexane diacrylate, pentaerythritol tetra(meth)acrylate], pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexanetetramethacrylate, polyurethane polyacrylate and polyester polyacrylate], ethylene oxide modification products of the esters as recited above, vinylbenzene and derivatives thereof [such as 1,4-divinylbenzene, 2-acryloylethyl 4-vinylbenzoate and 1,4-divinylcyclohexanone], vinyl sulfones (such as divinyl sulfone), acrylamides (such as methylenebisacrylamide) and methacrylamides. These monomers may be used as combinations of two or more thereof.

Examples of a monomer with a high reflective index include bis(4-methacryloylthiophenyl) sulfide, vinylnaphthalene, vinyl phenyl sulfide, and 4-methacryloxyphenyl-4′-methoxyphenylthioether. These monomers also may be used as combinations of two or more thereof.

These monomers having ethylenic unsaturated groups can be polymerized by irradiation with ionizing radiation or heating in the presence of a photo-radical initiator or a thermo-radical initiator. Accordingly, the antireflective film can be formed by preparing a coating solution containing a monomer having an ethylenic unsaturated group as recited above, a photo-radical initiator or a thermo-radical initiator, matting particles and an inorganic filler, applying the coating solution to the protective film surface, and then curing the coating solution through polymerization reaction caused by ionizing radiation or heat. As these photo-radical and thermo-radical initiators, known initiators can be used.

Polymers having polyether chains as their respective main chains are preferably polymers obtained by ring opening polymerization of multifunctional epoxy compounds. The ring opening polymerization of multifunctional epoxy compounds can be performed by irradiation with ionizing radiation or heating in the presence of a photo-acid generator or a thermo-acid generator. Accordingly, it is also possible to form the antireflective film by preparing a coating solution containing a multifunctional epoxy compound, a photo-acid generator or a thermo-acid generator, matting particles and an inorganic filler, applying the coating solution to the protective film surface, and then curing the coating solution through polymerization reaction caused by ionizing radiation or heat.

A cross-linked structure may be introduced into a binder polymer by using a monomer having a cross-linkable functional group in place of or in addition to a monomer having two or more ethylenic unsaturated groups in order to introduce cross-linkable functional groups into the binder polymer, and further by allowing these cross-linkable functional groups to undergo reaction.

Examples of such a cross-linkable functional group include an isocyanate group, an epoxy group, an aziridine group, an oxazoline group, an aldehyde group, a carbonyl group, a hydrazino group, a carboxyl group, a methylol group and an active methylene group. In addition, vinylsulfonic acid, acid anhydrides, cyanoacrylate derivatives, melamine, etherified methylol, ester and urethane, and further metal alkoxides, such as tetramethoxysilane, can be utilized as monomers for introduction of cross-linked structures. Furthermore, functional groups showing a cross-linking property as a result of decomposition reaction, such as blocked isocyanate groups, may be used. In other words, cross-linkable functional groups used in the invention needn't cause reaction immediately but may be those showing reactivity as a result of decomposition.

Binder polymers having those cross-linkable functional groups can form cross-linked structures by heating after they are coated.

In the light-scattering layer, for the purpose of imparting thereto antiglare properties, matting particles, such as particles of an inorganic compound or particles of a resin, having an average particle diameter of 1 to 10 μm, preferably from 1.5 to 7.0 μm, which is greater than that of filler particles, are incorporated. Suitable examples of such matting particles include particles of an inorganic compound, such as silica particles and TiO₂ particles; and resin particles, such as acrylic resin particles, cross-linked acrylic resin particles, polystyrene particles, cross-linked polystyrene particles, melamine resin particles and benzoguanamine resin particles. Of these particles, cross-linked polystyrene particles, cross-linked acrylic resin particles, cross-linked acrylic styrene resin particles and silica particles are preferred over the others. As to the shape of the matting particles, a spherical shape and an indefinite shape are both usable.

Two or more types of matting particles differing in particle diameter may be used together. It is possible to impart an antiglare property by use of matting particles greater in particle diameter and other optical properties by use of matting particles smaller in particle diameter.

As to the particle diameter distribution of the matting particles, a monodisperse distribution is best. The closer their particle sizes are to one another, the more suitable the particles are for use. For instance, when the particles whose diameters are at least 20% greater than the average particle diameter are defined as coarse particles, it is preferable that the proportion of such coarse particles to all the particles used is 1% or below by number, preferably 0.1% or below by number, far preferably 0.01% or below by number. The matting particles having such a narrow particle diameter distribution can generally be obtained by size classification after synthesis reaction. The more favorable distribution can be achieved by increasing the number of classifications or by making the degree of classification stricter.

The matting particles are incorporated in a light-scattering layer so that the amount of matting particles in the light-scattering layer formed is preferably from 10 to 1,000 mg/m², far preferably from 100 to 700 mg/m².

The size distribution of matting particles is measured according to the Coulter Counter method, and the distribution measured is converted to the number distribution of particles.

In addition to the matting particles, it is favorable for further heightening the refractive index of the light-scatting layer to incorporate in the layer an inorganic filler including at least one metal oxide chosen from oxides of titanium, zirconium, aluminum, indium, zinc, tin and antimony and having an average particle diameter of 0.2 μm or below, preferably 0.1 μm or below, far preferably 0.06 μm or below.

Contrary to the above, it is also preferable in the light-scattering layer using matting particles with a high refractive index that silicon oxide is used for the purpose of widening a difference in refractive index from the matting particles and keeping the refractive index of the layer rather low. The suitable particle size range of silicon oxide is the same as that of the foregoing inorganic filler.

Examples of an inorganic filler usable in the light-scattering layer include TiO₂, ZrO₂, Al₂O₃, In₂O₃, ZnO, SnO₂, Sb₂O₃, ITO and SiO₂. Of these fillers, TiO₂ and ZrO₂ are preferred over the others from the viewpoint of heightening the refractive index. It is also preferable that the surface of such an inorganic filler is treated with a silane coupling agent or a titanate coupling agent, and a surface treatment agent having a functional group capable of reacting with the binder is applied favorably to the filler surface.

The addition amount of such inorganic fillers is preferably from 10 to 90%, far preferably from 20 to 80%, particularly preferably from 30 to 75%, of the total mass of the light-scattering layer.

Since the particle sizes of those inorganic fillers are sufficiently smaller than the wavelengths of light, no scattering is caused, and the dispersion of those inorganic fillers in the binder polymer can behave like an optically uniform material.

The bulk refractive index of a binder-inorganic filler mixture in the light-scattering layer is preferably from 1.50 to 2.00, far preferably from 1.51 to 1.80. For adjusting the refractive index to such a range, it is adequate that the kinds of the binder and the inorganic filler and the mixing proportions thereof are chosen properly. How to make a proper choice can be experimentally found in advance.

In order to ensure uniformity in surface condition of the light-scattering layer, especially by avoiding unevenness of coating, unevenness of drying and point defects, either of a fluorine-containing surfactant, or a silicon-containing surfactant, or both are incorporated into a coating solution for forming the light-scattering layer. A fluorine-containing surfactant in particular is used to advantage because even its addition in a smaller amount can produce effect of lessening troubles on the surface of an antireflective film used favorably in the invention, such as unevenness of coating, unevenness of drying and point defects. These surfactants are added with the intention of increasing productivity by imparting high-speed coating suitability to the coating solution while enhancing uniformity in surface condition.

### (AR Film)

The antireflective layer provided on the protective film in a state that a medium refractive index layer, a high refractive index layer and a low refractive index layer are laminated in the order of description (AR film) is described below.

The antireflective layer having at least a layer structure that a medium refractive index layer, a high refractive index layer and a low refractive index layer (outermost layer) are laminated on the protective film in the order of description is designed to have refractive indices satisfying the following relation.

Refractive index of high refractive index layer>Refractive index of medium refractive index layer>Refractive index of protective film>Refractive index of low refractive index layer

In addition, a hard coating layer may be provided between the protective film and the medium refractive index layer. Alternatively, the antireflective layer may be made up of a medium refractive index layer, a hard coating layer, a high refractive index layer and a low refractive index layer. Examples of such an antireflective layer include those disclosed in JP-A-8-12504, JP-A-8-110401, JP-A-10-300902, JP-A-2002-243906 and JP-A-2000-111706.

Furthermore, another function may be given to each layer. Examples of such a layer include a soil-resistant low refractive index layer and an antistatic high refractive index layer (as disclosed, e.g., in JP-A-10-206603 and JP-A-2002-243906).

The haze of the antireflective layer is preferably 5% or below, far preferably 3% or below. The surface strength of the film is preferably H or higher, far preferably 2H or higher, particularly preferably 3H or higher, as determined by the pencil hardness test according to JIS K-5400.

### (High Refractive Index Layer and Medium Refractive Index Layer)

In the antireflective layer, the layer having a high refractive index is formed of a curable film containing at least a matrix binder and fine particles of an inorganic compound having a high refractive index and an average particle size of 100 nm or below.

The fine particles of an inorganic compound having a high refractive index is fine particles of an inorganic compound having a refractive index of, e.g., 1.65 or higher, preferably 1.9 or higher. Examples of such a compound include oxides of Ti, Zn, Sb, Sn, Zr, Ce, Ta, La and In, and compound oxides which each contain two or more of the metal atoms recited above.

Such fine particles can be obtained by treating particle surfaces with a surface treatment agent (with examples including the silane coupling agents disclosed in JP-A-11-295503, JP-A-11-153703 or JP-A-2000-9908, and the anionic compounds and the organometallic coupling agents disclosed in JP-A-2001-310432), or by forming particles of core/shell structure in which high refractive index particles are incorporated as their cores (as disclosed in JP-A-2001-166104), or by using inorganic compounds in combination with specific dispersing agents (as disclosed in JP-A-11-153703, U.S. Pat. No. 6,210,858 and JP-A-2002-2776069).

Examples of a material that forms the matrix include thermoplastic resin and setting resin films hitherto known.

As an example of a far preferred material is given at least one composition selected from a composition containing a multifunctional compound which contains at least two of radical polymerizable groups or cationic polymerizable groups, a composition containing an organometallic compound having a hydrolyzable group, or a composition containing a partial condensate of such a compound. Examples of such a composition include the compositions disclosed in JP-A-2000-47004, JP-A-2001-315242, JP-A-2001-31871 and JP-A-2001-296401.

In addition, curable films formed from a colloidal metal oxide obtained from metal alkoxide hydrolysis condensates and a metal alkoxide composition are also used to advantage. Descriptions thereof can be found, e.g., in JP-A-2001-293818.

The refractive index of the high refractive index layer is preferably in a range of 1.70 to 2.20. The thickness of the high refractive index layer is preferably from 5 nm to 10 μm, far preferably from 10 nm to 1 μm.

The refractive index of the medium refractive index layer is adjusted so as to lie some where between the refractive index of the low refractive index layer and that of the high refractive index layer. The suitable refractive index of the medium refractive index layer is from 1.50 to 1.70. The suitable thickness of the medium refractive index layer is from 5 nm to 10 μm, preferably from 10 nm to 1 μm.

### (Low Refractive Index Layer)

The low refractive index layer is laminated on the high refractive index layer. The refractive index of the low refractive index layer is preferably from 1.20 to 1.55, far preferably from 1.30 to 1.50.

It is appropriate that the low refractive-index layer be structured as the outermost layer having scratch resistance and soil resistance. For substantial enhancement of scratch resistance, it is effective to impart slippability to the layer surface, and heretofore known thin-film layer techniques which include introduction of a silicone or fluorine-containing compound can be adopted.

As the fluorine-containing compound used therein, a compound having a cross-linkable or polymerizable functional group containing fluorine atoms in a proportion of 35 to 80 mass % is suitable. Examples of such a fluorine-containing compound include the compounds disclosed in JP-A-9-222503, paragraph numbers [0018] to [0026]; JP-A-11-38202, paragraph numbers [0019] to [0030]; JP-A-2001-40284, paragraph numbers [0027] to [0028]; and JP-A-2000-284102.

The refractive index of the fluorine-containing compound is preferably from 1.35 to 1.50, far preferably from 1.36 to 1.47.

The silicone compound usable therein is a compound having a polysiloxane structure, the macromolecular chain of which preferably contains curable functional groups or polymerizable functional groups to form a bridged structure in a film formed. Examples of such a compound include reactive silicones (e.g., Silaplain, produced by Chisso Corporation) and polysiloxanes containing silanol groups at their respective both ends (as disclosed in JP-A-11-258403).

It is preferable that the low refractive index layer is formed by performing cross-linking or polymerizing reaction of at least either fluoropolymer or siloxane polymer containing cross-linkable or polymerizing groups under light exposure or heating simultaneously with or subsequently to the application of a coating composition which is formulated for outermost layer use and contains a polymerization initiator and a sensitizer.

Alternatively, it is also preferable to form a cured film by sol-gel conversion, wherein curing is performed by causing condensation reaction between an organometallic compound, such as a silane coupling agent, and a specific silane coupling agent containing a fluorohydrocarbon group in the presence of a catalyst.

Examples of such a specific silane coupling agent include polyfluoroalkyl-containing silane compounds or partial hydrolysis condensates thereof (such as the compounds disclosed in JP-A-58-142958, JP-A-58-147483, JP-A-58-147484, JP-A-9-157582 and JP-A-11-106704) and silyl compounds containing poly(perfluoroalkyl ether) groups as fluorine-containing long-chain groups (such as the compounds disclosed in JP-A-2000-117902, JP-A-2001-48590 and JP-A-2002-53804).

As additives other than the above, the low refractive index layer can contain a filler (e.g., an inorganic compound having a low refractive index and an average primary-grain size of 1 to 150 nm, such as silicon dioxide (silica) or fluoride grains (magnesium fluoride, calcium fluoride or barium fluoride grains), the organic fine particles disclosed in JP-A-11-3820, paragraph numbers [0020] to [0038]), a silane coupling agent, a slipping agent and a surfactant.

When the low refractive index layer is situated underneath the outermost layer, it may be formed by use of a vapor-phase method (such as vacuum evaporation method, a sputtering method, an ion plating method or a plasma CVD method). In point of low-priced production, coating methods are preferable.

The thickness of the low refractive index layer is preferably from 30 to 200 nm, far preferably from 50 to 150 nm, particularly preferably from 60 to 120 nm.

### (Hard Coating Layer)

The hard coating layer is provided on the surface of the protective film in order to impart physical strength to the protective film on which the antireflective layer is formed. And it is especially preferable that the hard coating layer is provided between the protective film and the high refractive index layer. The hard coating layer is preferably formed by cross-linking reaction or polymerizing reaction of a light- and/or heat-curable compound. The curable functional groups in the curable compounds are preferably photopolymerizable functional groups. In addition, organometallic compounds containing hydrolyzable functional groups and organic alkoxysilyl compounds are also used suitably.

Examples of such compounds include the same ones as recited in the descriptions of the high refractive index layer. Examples of a composition constituting the hard coating layer include those disclosed in JP-A-2002-144913, JP-A-2000-9908 and WO 00/46617 brochure.

The high refractive index layer can serve as a hard coating layer. In this case, it is preferable that the hard coating layer is formed so as to contain fine particles in a finely dispersed state by use of any technique offered in the description of the high refractive index layer.

The hard coating layer can function also as an antiglare layer when an antiglare function is imparted thereto by addition of particles having an average size of 0.2 to 10 μm.

The hard coating layer can be designed to have a proper thickness according to the intended purpose. The thickness of the hard coating layer is preferably from 0.2 to 10 μm, far preferably from 0.5 to 7 μm.

The strength of the hard coating layer is preferably H or higher, far preferably 2H or higher, particularly preferably 3H or higher, as determined by the pencil hardness test according to JIS K5400. In addition, the hard coating layer is more useful the smaller is the amount of abrasion that a sample piece thereof suffers by Taber test according to JIS K_{5400.}

### (Layers Other than Antireflective Layer)

Furthermore, a forward scattering layer, a primer layer, an antistatic layer, an undercoat layer and a protective layer may be provided.

### (Antistatic Layer)

In the case of providing an antistatic layer, it is preferable that the antistatic layer can impart a conductivity expressed as a volume resistivity of 10⁻⁸ (Ωcm⁻³) or below. It is possible to impart the volume resistivity of 10⁻⁸ (Ωcm⁻³) by use of a hygroscopic substance, a water-soluble inorganic salt, some type of surfactant, a cationic polymer, an anionic polymer or colloidal silica, but the conductivity imparted by such a compound varies greatly depending on ambient temperature and humidity. In low-humidity surroundings, there occurs a problem that sufficient conductivity cannot be secured. Accordingly, metal oxides are suitable as materials for a conductive layer. However, some of metal oxides are colored, and colored metal oxides are unsuitable because the film to which they are added is colored throughout. Examples of a metal producing colorless metal oxide include Zn, Ti, Al, In, Si, Mg, Ba, Mo, W and V, and it is preferable to use metal oxides containing these metals as their respective main components.

Suitable examples of a colorless metal oxide include ZnO, TiO₂, SnO₂, Al₂O₃, In₂O₃, SiO₂, MgO, BaO, MoO₃, WO₃, V₂O₅, and compound oxides thereof. Of these oxides, ZnO, TiO₂ and SnO₂ are used to particular advantage. In the case of adding atoms of different kinds to these oxides, addition of Al and In to ZnO, addition of Sb, Nb and halogen elements to SnO₂ and addition of Nb and Ta to TiO₂ are effective.

Furthermore, as disclosed in JP-B-59-6235, materials prepared by depositing the metal oxides recited above on crystalline metal grains or fibrous materials (e.g., titanium oxide) may be used. Although volume resistance and surface resistance are different physical property values and a simple comparison cannot be drawn between them, it is adequate for securing the conductivity expressed as a volume resistance of 10⁻⁸ (Ωcm⁻³) or below that the antistatic layer has a surface resistance of about 10⁻¹⁰ (Ω/□) or below, preferably 10⁻⁸ (Ω/□). The surface resistance of the antistatic layer is required to be determined as the value in the case of arranging the antistatic layer as the outermost layer, and can be measured at a stage during the process of multilayer film formation according to the invention.

### (Liquid Crystal Display Device)

The cellulose acylate film or the polarizing plate obtained by lamination of the cellulose acylate film and a polarizing film is used to advantage in liquid crystal display devices, especially in a transmission liquid crystal display device.

The transmission liquid crystal display device includes a liquid crystal cell and two polarizing plates placed on both sides of the cell. Each polarizing plate includes a polarizing film and two transparent protective films put on both sides of the film. The liquid crystal cell holds liquid crystal between two electrode substrates.

As to the polarizing plate according to the invention, one plate is put on one side of a liquid crystal cell, or two plates are put on both sides of a liquid crystal cell.

The liquid crystal cell is preferably a VA-mode, OCB-mode, IPS-mode or TN-mode liquid crystal cell.

In the VA-mode liquid crystal cell, rod-shaped liquid crystalline molecules are aligned vertically in a substantial sense when no voltage is applied.

Examples of the VA-mode liquid crystal cell include (1) a strictly VA-mode liquid crystal cell in which rod-shaped liquid crystalline molecules are aligned in a substantially vertical direction when no voltage is applied thereto, but they are forced to align in a substantially horizontal direction by application of a voltage thereto (as disclosed in JP-A-2-176625), (2) a liquid crystal cell of a multi-domain VA mode (MVA mode) designed for wide-angle view (as described in SID 97, Digest of Tech. Papers (preprints) 28, p. 845 (1997)), (3) an n-ASM-mode liquid crystal cell in which rod-shaped liquid crystalline molecules are aligned in a substantially vertical direction when no voltage is applied thereto, but they are brought into a twisted multi-domain alignment by application of a voltage thereto (as described in preprints of Nippon Ekisho Toronkai (Symposium on Liquid crystal), pp. 58-59 (1998)), and (4) a SURVAIVAL-mode liquid crystal cell (announced at LCD International 98).

When only one polarizing plate according to the invention is used in a VA-mode liquid crystal display device, it is preferably disposed on the backlight side.

The OCB-mode liquid crystal cell is a liquid crystal cell of bend alignment mode in which rod-shaped liquid crystalline molecules in the upper part of the liquid crystal cell and those in the lower part are forced to align in substantially opposite directions (symmetrically). Liquid crystal display devices using cells of such an OBC mode are disclosed in U.S. Pat. Nos. 4,583,825 and 5,410,422. Since the rod-shaped liquid crystal molecules are symmetrically aligned in the upper part and the lower part of the liquid crystal cell, the bend alignment mode of liquid crystal cell has an optically self-compensation function. Therefore, this liquid crystal mode is also referred to as an OCB (Optically Compensatory Bend) liquid crystal mode. The liquid crystal display device of the bend alignment mode has an advantage of high response speed.

In a TN-mode liquid crystal cell, rod-shape liquid crystalline molecules are aligned in a substantially horizontal direction, and that in a state of being twisted by 60 to 120 degrees, when no voltage is applied thereto.

TN-mode crystal cells are prevailingly utilized in color TFT liquid crystal display devices and described in abundant technical literature.

### EXAMPLES

The invention will now be illustrated in more detail by reference to the following examples and comparative examples. However, the invention should not be construed as being limited to the following examples in any way.

### Example 1

### <<Formation of Cellulose Acylate Film>>

### (1) Cellulose Acylate

Cellulose acylate was prepared through acylation reaction carried out by adding sulfuric acid as a catalyst to a cellulose material and further adding thereto carboxylic acid anhydrides as starting materials of acyl substitutents, and subsequent neutralization and ripening by saponification. Therein, cellulose acylate samples differing in kind of acyl group, substitution degree, bulk density and polymerization degree were prepared by controlling the amount of catalyst used, the kinds and amounts of carboxylic acid anhydrides used, the amount of neutralizing agent added, the amount of water added, the reaction temperature and the ripening temperature. In addition, the cellulose acylate samples thus prepared were cleaned with acetone to remove their low molecular components.

From the thus prepared samples, cellulose acylate having the acetyl substitution degree of 2.79 and DS6/(DS2+DS3+DS6)=0.322 was selected, and subjected to the dope preparation described below.

### (2) Dope Preparation

### <1-1> Cellulose Acylate Solution

The following ingredients were charged into a mixing tank, made into a solution by stirring, and further heated at 90° C. for about 10 minutes. The resulting solution was filtered through a filter paper with an average pore size of 34 μm and a sintered metal filter with an average pore size of 10 μm.

Cellulose Acylate Solution

| | |
|---|---|
| Cellulose acylate | 100.0 parts by mass |
| Triphenyl phosphate | 8.0 parts by mass |
| Biphenyldiphenyl phosphate | 4.0 parts by mass |
| Methylene chloride | 403.0 parts by mass |
| Methanol | 60.2 parts by mass |

### <1-2> Matting Agent Dispersion

The following ingredients including the cellulose acylate solution prepared in the foregoing manner were charged into a dispersing machine, thereby preparing a dispersion of matting agent.

Matting Agent Dispersion

| | |
|---|---|
| Silica particles having an average size of | 2.0 parts by mass |
| 16 nm (AEROSIL R972, produced by | |
| Nippon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution

The following ingredients including the cellulose acylate solution prepared in the foregoing manner were charged into a mixing tank, and made into a solution by stirring under heating. Thus, a retardation developer solution was prepared.

Retardation Developer Solution

| | |
|---|---|
| Retardation Developer A | 20.0 parts by mass |
| (Compound illustrated below) | |
| Methylene chloride | 58.3 parts by mass |
| Methanol | 8.7 parts by mass |
| Cellulose acylate solution | 12.8 parts by mass |

A dope for film formation was prepared by mixing 100 parts by mass of the cellulose acylate solution with 1.35 parts by mass of the matting agent dispersion, and further with the retardation developer solution in an amount that the content of the retardation developer A in the cellulose acylate film to be formed became 5.1 parts by mass.

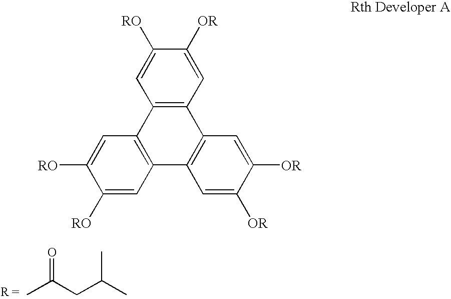

### (Casting)

Casting of the dope was carried out using glass-plate casting apparatus. In Example 1-1, the cast dope was dried for 10 minutes with hot air of a charge air temperature of 45° C., and the film stripped off the glass plate was fixed to a frame and dried for 30 minutes with hot air of a charge air temperature of 70° C. and further dried for 40 minutes with hot air of a charge air temperature of 100° C. In Examples 1-2 and 1-3, those drying operations were performed under the conditions shown in Table 1-1. Thus, cellulose acylate films 108 μm in thickness were formed. The glass transition temperatures of these films were found to be 140° C.

Each of these films was grasped by its four sides and underwent a stretching-and-shrinking process under the condition as shown in Table 1-1 by means of a biaxial stretching tester (made by Toyo Seiki Seisaku-Sho, Ltd.). As to a common condition, each film before stretching was subjected to 3-minute preheating at a charge air temperature specified individually, and it was confirmed that the film surface temperature measured with a noncontact infrared thermometer was within ±1° C. of the charge air temperature. After stretching, each film was cooled for 5 minutes by air blasting as it was grasped with clips. The term “MD” in the table means the casting direction during the glass-plate casting, and the term “TD” means the width direction orthogonal to the MD.

### <Photoelastic Coefficient of Film>

Photoelasticity coefficients of the films obtained were measured. The results thereof are shown in Table 1-1. As can be seen from the data shown therein, every film according to the invention is 0.8 or below in the ratio of a photoelastic coefficient in the width direction to a photoelastic coefficient in the longitudinal direction, C(TD)/C(MD).

### <Re and Rth of Film at Wavelengths 450 nm, 550 nm and 650 nm>

Re and Rth values of each film at wavelengths of 450 nm, 550 nm and 650 nm were measured according to the method described hereinbefore and using KOBRA 21ADH (made by Oji Scientific Instruments).

The results obtained are shown in Table 1-1. As can be seen from Table 1-1, the Re and Rth values of every film manufactured according to the present method at the wavelengths of 450 nm, 550 nm and 650 nm satisfy the relations (I) to (III) specified in the invention.

### <Making of Polarizing Plate>

A polarizing film was prepared by making a stretched polyvinyl alcohol film to adsorb iodine.

Each of the cellulose acylate films formed in Examples 1-1 to 1-3, Comparative Examples 1-1 to 1-3 and Reference Example was laminated on one side of the polarizing film with the aid of an adhesive of polyvinyl alcohol type. Incidentally, saponification treatment for these films was performed under the following condition.

A 1.5 mole/liter of aqueous sodium hydroxide solution was prepared, and kept at 55° C. A 0.01 mole/liter of diluted aqueous sulfuric acid solution was prepared, and kept at 35° C. After the cellulose acylate films formed were immersed for 2 minutes in the aqueous sodium hydroxide solution, they were immersed in water and the sodium hydroxide was thoroughly washed away from the films. Then, the films were immersed for 1 minute in the diluted aqueous sulfuric acid solution, and thereafter they were immersed in water and the sulfuric acid was thoroughly washed away from the films. Finally, these film samples were fully dried at 120° C.

A commercially available cellulose triacylate film (FUJI TAC TD80UF, produced by Fuji Photo Film Co., Ltd.) was saponified, and laminated on the other side of the polarizing film with the aid of the adhesive of polyvinyl alcohol type, and further dried at 70° C. for at least 10 minutes.

The polarizing film was placed so that its transmission axis became parallel to the slow axis of each of the cellulose acylate films formed in the foregoing manners. On the other hand, the commercially available cellulose acylate film was placed so that its slow axis became orthogonal to the transmission axis of the polarizing film.

### <Making of Liquid Crystal Cell>

A liquid crystal cell was made by infusing a liquid crystal material having negative permittivity anisotropy (MLC6608, produced by Merck & Co.) into a cell gap kept at 3.6 μm between substrates and sealing the liquid crystal material in between the substrates to form a liquid crystal layer. The retardation of the liquid crystal layer (the product of a thickness d (μm) and a refractive-index anisotropy Δn of the liquid crystal layer, namely d·Δn) was adjusted to 300 nm. Additionally, the liquid crystal material was oriented so as to have vertical molecular alignment.

### <Mounting in VA Panel>

As an upper side (viewer side) polarizing plate of a liquid crystal display device using the foregoing vertical alignment liquid crystal cell, a commercially available superhigh contrast product (HLC2-5618, produced by Sanritz Corporation) was used. As a lower side (backlight side) polarizing plate, the polarizing plate including each of the cellulose acylate films made in Examples 1-1 to 1-3, Comparative Examples 1-1 to 1-3 and Reference Example was arranged so that the cellulose acylate film lay on the side of the liquid crystal cell. The upper side polarizing plate and the lower side polarizing plate were bonded to both sides of the liquid crystal cell, respectively, via a tackiness adhesive. Herein, these two polarizing plates were placed in the crossed Nicol arrangement so that the transmission axis of the upper side polarizing plate was oriented in a vertical direction and that of the lower side polarizing plate in a lateral direction.

55 Hz rectangular wave voltage was applied to the liquid crystal cell. And the cell was adjusted to a normally black mode in which the voltage was 5V in a white-display state and 0V in a black-display state. The black-display transmittance (%) at the viewing angle in the direction of 45° azimuth and 60° polar angle under the state of black display, and a color drift Δx between the direction of 45° azimuth and 60° polar angle and the direction of 180° azimuth and 60° polar angle were measured. Results obtained are shown in Table 1-1. In addition, the transmittance ratio (white display/black display) was regarded as a contrast ratio, and the viewing angles (the polar angle ranges in which the contrast ratio is 10 or above and there is no tone reversal in the black side) in 8 steps from the black display (L1) to the white display (L8) were measured with an instrument (EZ-Contrast 160D, made by ELDIM). Results obtained are also shown in Table 1-1. As a result of observing each of the liquid crystal display devices made, it was ascertained that neutral black display was achieved in both frontal and viewing-angle directions when the cellulose acylate films made in Examples 1-1 to 1-3 and Comparative Example 1-3 were used.

Furthermore, evaluation of unevenness on the perimeter of the screen (hereinafter abbreviated as “unevenness on the perimeter”) was made, and it was found that the liquid crystal display devices using the cellulose acylate films made in Examples 1-1 to 1-3 were reduced in unevenness on the perimeter, compared with those using the cellulose acylate films made in Comparative Examples and Reference Example.

Evaluation criteria employed herein are as follows.

### Viewing Angle (Polar angle range in which the contrast ratio is 10 or above and there is no tone reversal in the black side)

A: The polar angle is 80° or above in all of the upward, downward, rightward and leftward directions

B: The polar angle is 80° or above in three of the upward, downward, rightward and leftward directions

C: The polar angle is 80° or above in two of the upward, downward, rightward and leftward directions

F: The polar angle is 80° or above in none or one of the upward, downward, rightward and leftward directions

### Color Drift (Δx)

A: Smaller than 0.02

B: 0.02 to 0.04

C: 0.04 to 0.06

F: Greater than 0.06

### Unevenness on Perimeter (Evaluations under hot condition and hot, humid condition)

(Hot Condition)

As to the forced conditions employed, a 20-inch liquid crystal panel having the polarizing plate laminated throughout its either side was stored for 48 hours under a hot condition (temperature: 80° C., humidity: 10% or below), and mounted on backlights within 10 minutes thereafter, and then the backlights were switched on. By the degree of light leakage observed on the perimeter of the panel at the time of backlighting, unevenness on the perimeter was evaluated.

(Hot, Humid Condition)

As to the forced conditions employed, a 20-inch liquid crystal panel having the polarizing plate laminated throughout its either side was stored for 48 hours under a hot, humid condition (temperature: 60° C., humidity: 90%), then stored for 24 hours in the 25° C.-60% RH atmosphere, and thereafter mounted on backlights, and the backlights were switched on.

By the degree of light leakage observed on the perimeter of the panel at the time of backlighting, unevenness on the perimeter was evaluated.

The following are evaluation criteria employed in both cases of storage under the hot condition and storage under the hot, humid condition.

(Evaluation of Light Leakage as Unevenness on Perimeter)

A: Almost no light leakage is observed

B: Although light leakage is observed, it is acceptable because the intensity and area thereof is small

F: Light leakage is observed, and it is unacceptable because the intensity and area thereof is great

TABLE 1-1

| | Drying after | | | | | | | | | | | | | |
|---|---|---|---|---|---|---|---|---|---|---|---|---|---|---|
| | Casting | | After Stripping-off | | | | Stretching and Shrinking | | | | | Photoelastic Coefficient | | |
| | Charge air | | Drying | | | | Charge | | | | Shrink | (×10⁻¹³ cm²/dyne) | | |
| | Temp. | Time | Temp. | Time | Temp. | Time | Air Temp | Stretch | Stretch | Shrink | Rate | | | C (TD)/ |
| | (° C.) | (min) | (° C.) | (min) | (° C.) | (min) | (° C.) | Direction | Rate (%) | Direction | (%) | C (TD) | C (MD) | C (MD) |
| Ex. 1-1 | 45 | 10 | 70 | 30 | 100 | 40 | 160 | TD | 20 | MD | 12 | 10.1 | 14 | 0.72 |
| Ex. 1-2 | 50 | 8 | 80 | 20 | 100 | 40 | 180 | TD | 30 | MD | 34 | 7.7 | 13.5 | 0.57 |
| Ex. 1-3 | 50 | 8 | 80 | 20 | 110 | 30 | 180 | TD | 25 | MD | 17 | 11 | 14.2 | 0.77 |
| Compar. | 65 | 8 | 80 | 20 | 100 | 40 | 160 | TD | 20 | MD | Fixed | 16.3 | 16.1 | 1.01 |
| EX. 1-1 | | | | | | | | | | | width | | | |
| Compar. | 70 | 8 | 120 | 15 | 160 | 10 | 180 | TD | 35 | MD | Fixed | 15.2 | 16.5 | 0.92 |
| EX. 1-2 | | | | | | | | | | | width | | | |
| Compar. | 70 | 6 | 130 | 10 | 160 | 10 | 180 | TD | 25 | MD | 17 | 12.8 | 14.5 | 0.88 |
| EX. 1-3 | | | | | | | | | | | | | | |
| Ref. Ex. | 60 | 8 | 80 | 20 | 100 | 40 | 180 | TD | 15 | MD | Free | 13.2 | 13.8 | 0.96 |
| | | | | | | | | | | | width | | | |

| | | | | | | | | | | Unevenness on | |
|---|---|---|---|---|---|---|---|---|---|---|---|
| | | | | | | | | | | Perimeter | |
| | (@550 nm) | | Relation | Relation | Relation | Relation | (@550 nm) | | | | Hot, |
| | Re (nm) | Rth (nm) | (I)*¹ | (I)*² | (II) | (III) | ΔRth | Viewing Angle | Color Drift | Hot Cond. | Humid Cond. |
| Ex. 1-1 | 45 | 160 | 0.8 | 1.15 | 0.92 | 1.1 | A | B | B | A | A |
| Ex. 1-2 | 68 | 190 | 0.68 | 1.3 | 0.86 | 1.23 | A | A | A | A | A |
| Ex. 1-3 | 60 | 115 | 0.57 | 1.65 | 0.7 | 1.45 | A | F | C | A | A |
| Compar. | 41 | 145 | 1 | 1 | 1.05 | 0.95 | F | C | F | F | F |
| Ex. 1-1 | | | | | | | | | | | |
| Compar. | 55 | 185 | 1 | 1 | 1.05 | 0.95 | F | A | F | F | F |
| Ex. 1-2 | | | | | | | | | | | |
| Compar. | 50 | 180 | 0.5 | 1.6 | 0.55 | 1.4 | A | A | B | F | F |
| Ex. 1-3 | | | | | | | | | | | |
| Ref. Ex. | 51 | 160 | 0.68 | 1.25 | 0.72 | 1.23 | A | B | B | F | F |

In Table 1-1, Ex. stands for Example, Compar. Ex. stands for Comparative Example, and Ref. Ex. stands for Reference Example. In Reference Example, the shrinking was carried out in the direction shown in the table while letting the film width take its natural course. Re and Rth stands for Re(550) and Rth(550), respectively. The value of Relation (I)*¹ is a value of {(Re(450)/Rth(450))/(Re(550)/Rth(550))}, and the value of Relation (I)*² is a value of {(Re(650)/Rth(650))/(Re(550)/Rth(550))}. “@550 nm” in the table is abbreviation of the expression “measurement at a wavelength of 550 nm”.

In the next place, cellulose acylate films were made in the same manner as in Example 1-2, except that the acyl substitution degree on the 2-position hydroxyl groups of glucose units, DS2, the acyl substitution degree on the 3-position hydroxyl groups of glucose units, DS3, and the acyl substitution degree on the 6-position hydroxyl groups of glucose units, DS6, were changed as shown in Table 1-2, worked into polarizing plates, mounted in VA panels, and then evaluated. Evaluation results obtained are shown in Table 1-2. Example 1-4 enabled achievement of neutral black display in both frontal and viewing-angle directions. Examples 1-5 to 1-7 also ensured small color drift and enabled achievement of neutral black display in both frontal and viewing-angle directions, but they were inferior to Example 1-4 in at least either humidity dependence or viewing angle. These results indicate that the factors concerning acyl substitution degrees on the hydroxyl groups of glucose units in cellulose acylate film, (DS2+DS3+DS6) and SS6/(DS2+DS3+DS6), are of importance to improving those qualities.

TABLE 1-2

| | | | Drying after | | | | | | | | |
|---|---|---|---|---|---|---|---|---|---|---|---|
| | | | Casting | | After Stripping-off | | | | | | |
| | Cellulose Acylate | | Charge air | | Drying | | | | Photoelastic Coefficient | | |
| | DS2 + | DS6/ | Temp. | Time | Temp. | Time | Temp. | Time | (×10⁻¹³ cm²/dynr) | | |
| | DS3 + DS6 | (DS2 + DS3 + DS6) | (° C.) | (min) | (° C.) | (min) | (° C.) | (min) | C (TD) | C (MD) | C (TD)/C (MD) |
| Ex. 1-4 | 2.5 | 0.34 | 50 | 8 | 80 | 20 | 100 | 40 | 7.7 | 13.4 | 0.57 |
| Ex. 1-5 | 1.9 | 0.33 | 50 | 8 | 80 | 20 | 100 | 40 | 7.6 | 13.2 | 0.57 |
| Ex. 1-6 | 2.75 | 0.28 | 50 | 8 | 80 | 20 | 100 | 40 | 7.8 | 13.7 | 0.57 |
| Ex. 1-7 | 1.8 | 0.3 | 50 | 8 | 80 | 20 | 100 | 40 | 7.7 | 13.5 | 0.57 |

| | | | | | | | | | | | Unevenness on | |
|---|---|---|---|---|---|---|---|---|---|---|---|---|
| | (@550 nm) | | Relation | Relation | | | (@550 nm) | | View- | Color | Perimeter | |
| | Re | Rth | (I)*¹ | (I)*² | Relation (II) | Relation (III) | ΔRth | ΔRe | ing Angle | Drift | Hot Cond. | Hot, Humid Cond. |
| Ex. 1-4 | 57 | 180 | 0.82 | 1.2 | 0.86 | 1.12 | A | A | B | A | A | A |
| Ex. 1-5 | 40 | 170 | 0.95 | 1.25 | 0.87 | 1.15 | A | C | C | B | A | A |
| Ex. 1-6 | 35 | 150 | 0.72 | 1.12 | 1.05 | 1.15 | A | A | C | B | A | A |
| Ex. 1-7 | 21 | 130 | 1 | 1.21 | 0.82 | 1.23 | A | C | C | B | A | A |

In Table 1-2, Ex. stands for Example. Re and Rth stands for Re(550) and Rth(550), respectively. The value of Relation (I)*₁ is a value of {(Re(450)/Rth(450))/(Re(550)/Rth(550))}, and the value of Relation (I)*² is a value of {(Re(650)/Rth(650))/(Re(550)/Rth(550))}. “@550 nm” in the table is abbreviation of the expression “measurement at a wavelength of 550 nm”.

### Example 1-8

### <Evaluation of Mounting in OCB Panel>

### (Alkali Treatment)

A 1.0N potassium hydroxide solution (solvent: water/isopropyl alcohol/propylene glycol=69.2 parts by mass/15 parts by mass/15.8 parts by mass) was applied at a coverage of 10 cc/m² to the cellulose acylate film made in Example 1-1, and kept in a condition of about 40° C. for 30 seconds. Then, the alkali solution was scraped off the film, and the resulting film was washed with purified water. The drops of water remaining were eliminated with an air knife. Thereafter, the film was dried at 100° C. for 15 seconds.

The contact angle of the alkali-treated film surface with respect to purified water was found to be 42°.

### (Formation of Oriented Film)

An oriented film coating solution having the following composition was applied at a coverage of 28 ml/m² to the alkali-treated surface of the film by means of a #16 wire bar coater. The solution applied was dried with 60° C. hot air for 60 seconds, and further with 90° C. hot air for 150 seconds, thereby forming an oriented film.

Composition of Coating Solution for Oriented Film

| | |
|---|---|
| Modified polyvinyl alcohol illustrated | 10 parts by mass |
| below | |
| Water | 371 parts by mass |
| Methanol | 119 parts by mass |
| Glutaraldehyde (cross-linking agents) | 0.5 parts by mass |
| Citric acid ester (AS3, produced by | 0.35 parts by mass |
| Sankyo Chemical Co., Ltd.) | |
| Modified polyvinyl alcohol | |

| | | |
|---|---|---|
| 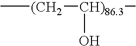 | 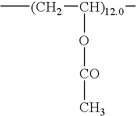 | 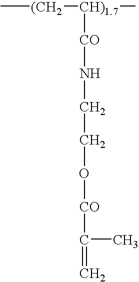 |

### (Rubbing Treatment)

A transparent substrate (the cellulose acylate film made in Example 1-1, alkali-treated and provided with the oriented film) was fed at a speed of 20 m/min, and rubbing treatment was given to the surface of the oriented film under a condition that a rubbing roll (measuring 300 mm in diameter) was adjusted to rub against the oriented film surface at an angle of 45° with respect to the direction of the length while rotating at 650 rpm. The length of contact between the rubbing roll and the transparent substrate was adjusted to 18 mm.

### (Formation of Optically Anisotropic Layer)

In 102 Kg of methyl ethyl ketone were dissolved 41.01 Kg of a disc-shaped liquid crystalline compound (discotic liquid crystalline compound illustrated below), 4.06 Kg of ethylene oxide-modified trimethylolpropane triacrylate (V#360, produced by Osaka Organic Chemical Industry Ltd.), 0.35 Kg of cellulose acetate butyrate (CAB531-1, produced by Eastman Chemical Company), 1.35 Kg of a photopolymerization initiator (Irgacure 907, produced by Ciba-Geigy) and 0.45 Kg of a sensitizer (Kayacure DETX, produced by Nippon Kayaku Co., Ltd.). To this solution, 0.1 Kg of a copolymer having fluorinated aliphatic groups (Megafac F780, produced by Dainippon Ink and Chemicals, Incorporated) was added to prepare a coating solution. The coating solution thus prepared was applied continuously to the oriented film surface of the transparent substrate, which was transported at a speed of 20 m/min, while rotating a #3.2 wire bar at 391 rpm in the same direction as the transport direction of the film.

### Discotic Liquid Crystalline Compound

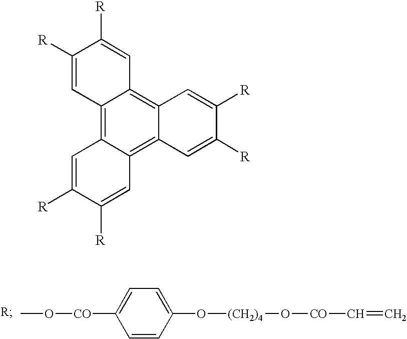

The coating solution applied was heated at temperatures raised continuously up to 100° C. from room temperature to evaporate the solvent, and then the discotic liquid crystalline compound was oriented by further heating for about 90 seconds in a 130° C. drying zone where the wind velocity at the filmy surface of the discotic, optically-anisotropic coating was adjusted to 2.5 m/sec. Subsequently thereto, the resulting film was transported into a 80° C. drying zone, and irradiated with ultraviolet rays at a illumination of 600 mW for 4 seconds by use of ultraviolet irradiation apparatus (ultraviolet lamp: output of 160 W/cm, light-emitting length of 1.6 m) in a condition that the surface temperature of the film was about 100° C. By this operation, cross-linking reaction progressed and the orientation of the discotic liquid crystal compound was fixed. Thereafter, the film was cooled to room temperature, and wound around a cylindrical-shaped core to take a roll form. In this way, roll-form optical compensation film (KH-3) was made.

When the viscosity of the optically anisotropic layer was measured at the film surface temperature of 127° C., it was found to be 695 cp (695 mPas). This viscosity value was a result of measurement made on a liquid crystal layer having the same composition (except for the solvent) as the optically anisotropic layer with a heating E-type viscometer.

A sample piece was cut from the thus made roll-form optical compensation film KH-3, and measured for optical characteristics. The Re retardation value of the optically anisotropic layer was found to be 38 nm as measured at the wavelength of 546 nm. In addition, it was found that the angles (tilt angles) which the disc planes of discotic liquid crystalline compound molecules in the optically anisotropic layer formed with the substrate surface varied continuously in the direction of the layer's depth and the average thereof was 28°. Furthermore, when the optically anisotropic layer alone was peeled off the sample piece and an average direction of the molecular symmetry axes in the optically anisotropic layer was determined, the average direction was found to be 45° with respect to the direction of the length of the optical compensation film.

### (Making of Polarizing Plate)

Iodine was adsorbed to a stretched polyvinyl alcohol film to make a polarizing film, and the film (KH-3) made in the foregoing manner was laminated on one side of the polarizing film with the aid of an adhesive of polyvinyl alcohol type. Therein, the transmission axis of the polarizing plate and the slow axis of the retardation film (KH-3) were arranged so as to become parallel.

A commercially available cellulose triacetate film (FUJI TAC TD80UF, produced by Fuji Photo Film Co., Ltd.) was saponified, and laminated on the other side of the polarizing film with the aid of the adhesive of polyvinyl alcohol type. Thus, a polarizing plate was made.

### (Making of Bend Alignment Liquid Crystal Cell)

A polyimide film as an oriented film was provided on a glass substrate equipped with ITO electrodes, and rubbing treatment was given to the oriented film. Two sheets of the glass substrate thus obtained were placed so that they faced each other and their rubbing directions became parallel, and a cell gap was adjusted to 4.7 μm. A liquid crystalline compound having Δn of 0.1396 (ZLI132, produced by Merck & Co., Inc.) was injected into the cell gap, thereby making a bend alignment liquid crystal cell.

Two sheets of the polarizing plate made in the foregoing manner were laminated so that the bend alignment liquid crystal cell was sandwiched between them. Therein, each sheet of the polarizing plate was arranged so that its optically anisotropic layer faced each cell substrate and the rubbing direction of the liquid crystal cell and the rubbing direction of the oriented film on which the optically anisotropic layer was formed became anti-parallel.

55 Hz rectangular wave voltage was applied to the liquid crystal cell. And the cell was adjusted to a normally white mode in which the voltage was 2V in a white-display state and 5V in a black-display state. When the liquid crystal display device thus made was observed in a condition that the voltage under which the transmittance in the frontal direction became a minimum, namely black voltage, was applied thereto, it was ascertained that neutral black display was achieved in both frontal and viewing-angle directions. In addition, the display was reduced in unevenness on the perimeter and delivered excellent performance.

### Examples 1-14 and 1-15, and Comparative Examples 1-4 to 1-6

From the cellulose acylate samples prepared, the cellulose acylate having an acetyl substitution degree of 2.00, a propionyl substitution degree of 0.60 and a viscosity-average polymerization degree of 350 was selected, and 100 parts by mass of the cellulose acylate selected, 5 parts by mass of ethylphthalylethyl glycolate, 3 parts by mass of triphenyl phosphate, 290 parts by mass of methylene chloride and 60 parts by mass of ethanol were placed in an airtight container. While slowly agitating the mixture, the container temperature was raised gradually up to 80° over a period of 60 minutes, thereby preparing a solution. The pressure inside the container went up to 1.5 atmospheres. The thus prepared dope was filtered with Azumi Filter Paper No. 244 (made by Azumi Filter Paper Co., Ltd.), and allowed to stand for 24 hours to eliminate foams therein.

Separately, 5 parts by mass of the cellulose acylate, 5 parts by mass of TINUVIN 109 (a product of Ciba Specialty Chemicals), 15 parts by mass of TINUVIN 326 (a product of Ciba Specialty Chemicals), 0.5 parts by mass of AEROSIL R972V (a product of Nippon Aerosil Co., Ltd.), 94 parts by mass of methylene chloride and 8 parts by mass of ethanol were mixed with stirring and made into a solution of ultraviolet absorbents. The ingredient R972V was dispersed in the ethanol in advance, and then mixed with the other ingredients.

The solution of ultraviolet absorbents was added in a proportion of 6 parts by mass to 100 parts by mass of the dope, and mixed thoroughly by means of a static mixer.

### (Casting)

The thus prepared dope was cast in accordance with the same method as described in the paragraph headed “(Casting)” in the description of Example 1-1 to be made into a 108 μm-thick cellulose acylate film. The glass transition temperature of the thus made cellulose acylate film was 140° C. This film was grasped by its four sides in the biaxial stretching tester according to the same method as described in the foregoing paragraph headed “<Casting>”, and subjected to stretching and shrinking processes under the same conditions as shown in Table 1-3.

Re and Rth measurements were made on the thus stretched and shrunken film in accordance with the same method as described in the paragraph headed “<Re and Rth of Film at Wavelengths 450 nm, 550 nm and 650 nm>” in the description of Example 1-1, and a polarizing plate was made using the thus stretched and shrunken film in the same manner as described in the paragraph headed “<Making of Polarizing Plate>” in the description of Example 1-1. Furthermore, mounting evaluation was performed in the same steps as described in the paragraphs headed “<Making of Liquid Crystal Cell>” and “<Mounting in VA Panel>” in the description of Example 1-1. Results obtained are shown in Table 1-3.

TABLE 1-3

| | Drying after | | | | | | | | | | | | | |
|---|---|---|---|---|---|---|---|---|---|---|---|---|---|---|
| | Casting | | After Stripping-off | | | | Stretching and Shrinking | | | | | Photoelastic Coefficient | | |
| | Charge air | | Drying | | | | Charge | | | | Shrink | (×10⁻¹³ cm²/dyne) | | |
| | Temp. | Time | Temp. | Time | Temp. | Time | Air Temp | Stretch | Stretch | Shrink | Rate | | | C (TD)/ |
| | (° C.) | (min) | (° C.) | (min) | (° C.) | (min) | (° C.) | Direction | Rate (%) | Direction | (%) | C (TD) | C (MD) | C (MD) |
| Ex. 1-14 | 50 | 8 | 80 | 20 | 100 | 40 | 160 | TD | 15 | MD | 12 | 11.9 | 16 | 0.79 |
| Ex. 1-15 | 50 | 8 | 80 | 20 | 100 | 40 | 180 | TD | 25 | MD | 17 | 11.2 | 15.3 | 0.73 |
| Compar. | 65 | 8 | 80 | 20 | 100 | 40 | 160 | TD | 20 | MD | Fixed | 13 | 15 | 0.87 |
| Ex. 1-4 | | | | | | | | | | | width | | | |
| Compar. | 70 | 8 | 130 | 10 | 160 | 10 | 180 | TD | 20 | MD | Fixed | 13.5 | 14.8 | 0.91 |
| Ex. 1-5 | | | | | | | | | | | width | | | |
| Compar. | 70 | 8 | 140 | 10 | 160 | 10 | 180 | TD | 25 | MD | 16 | 12.8 | 15.2 | 0.84 |
| Ex. 1-6 | | | | | | | | | | | | | | |

Unevenness on Perimeter

| | (@550 nm) | | | | | | | | Hot | |
|---|---|---|---|---|---|---|---|---|---|---|
| | Re | Rth | Relation (I)^{*1} | Relation (I)^{*2} | Relation (II) | Relation (III) | Viewing Angle | Color Drift | Cond. | Hot, Humid Cond. |
| Ex. 1-14 | 45 | 127 | 0.9 | 1.1 | 0.9 | 1.15 | A | A | A | A |
| Ex. 1-15 | 60 | 116 | 0.85 | 1.15 | 0.8 | 1.2 | A | A | A | A |
| Compar. | 40 | 120 | 1 | 1 | 1.05 | 0.95 | A | F | F | F |
| Ex. 1-4 | | | | | | | | | | |
| Compar. | 55 | 110 | 1.05 | 0.9 | 1.1 | 1 | A | F | F | F |
| Ex. 1-5 | | | | | | | | | | |
| Compar. | 55 | 120 | 0.78 | 1.1 | 0.72 | 1.08 | A | B | F | B |
| Ex. 1-6 | | | | | | | | | | |

### Examples 1-16 to 1-18

Cellulose acylate film samples were made in the same manner as in Example 1-14, except that the substitution degrees of acetyl groups (abbreviated as “Ac”), propionyl groups (abbreviated as “Pr”), butyryl groups (abbreviated as “Bt”) and benzoyl groups (abbreviated as “Bz”) were changed as shown in Table 1-4, respectively. The measurements and evaluations of mounting of these films were made in the same manners as adopted in Example 1-14.

TABLE 1-4

| | | | | | Drying after | | | | | | | | |
|---|---|---|---|---|---|---|---|---|---|---|---|---|---|
| | Cellulose Acylate | | | | Casting | | After Stripping-off | | | | Photoelastic Coefficient | | |
| | Ac Sub- | Pr Sub- | Bt Sub- | | Charge Air | | Drying | | | | (×10⁻¹³ cm²/dyne) | | |
| | stitution | stitution | stitution | Bz Substitution | Temp. | Time | Temp. | Time | Temp. | Time | | | C (TD)/ |
| | Degree | Degree | Degree | Degree | (° C.) | (min) | (° C.) | (min) | (° C.) | (min) | C (TD) | C (MD) | c (MD) |
| Ex. 1-16 | 1.98 | 0.72 | 0 | 0 | 50 | 8 | 80 | 20 | 100 | 40 | 12 | 15.3 | 0.78 |
| Ex. 1-17 | 2 | 0 | 0.7 | 0 | 50 | 8 | 80 | 20 | 100 | 40 | 11.9 | 15.2 | 0.78 |
| Ex. 1-18 | 2 | 0 | 0 | 0.7 | 50 | 8 | 80 | 20 | 100 | 40 | 12.1 | 15.4 | 0.79 |

| | (@550 | | | | | | | | Unevenness on | |
|---|---|---|---|---|---|---|---|---|---|---|
| | nm) | | Relation | Relation | | | | | Perimeter | |
| | Re | Rth | (I)*¹ | (I)*² | Relation (II) | Relation (III) | Viewing Angle | Color Drift | Hot Cond. | Hot, Humid Cond. |
| Ex. 1-16 | 45 | 128 | 0.9 | 1.11 | 0.84 | 1.12 | A | A | A | A |
| Ex. 1-17 | 41 | 122 | 0.81 | 1.16 | 0.92 | 1.21 | A | A | A | A |
| Ex. 1-18 | 50 | 130 | 0.86 | 1.21 | 0.81 | 1.17 | A | A | A | A |

As can be seen from Table 1-4, the cellulose acylate films each having a substitution degree B, or a propionyl, butyryl or benzoyl substitution degree, of greater than 0 in accordance with the invention were successful without addition of any retardation developer in achieving viewing angle and color drift qualities equivalent to those achieved in Examples 1-14 and 1-15 by using cellulose acylate films whose substitutents are all acetyl groups. In addition, they were also successful in reducing unevenness on the perimeter.

### Example 2

### <<Formation of Cellulose Acylate Film>>

### (1) Cellulose Acylate

Cellulose acylate was prepared through acylation reaction carried out by adding sulfuric acid as a catalyst to a cellulose material and further adding thereto carboxylic acid anhydrides as starting materials of acyl substitutents, and subsequent neutralization and ripening by saponification. Therein, cellulose acylate samples differing in kind of acyl group, substitution degree, bulk density and polymerization degree were prepared by controlling the amount of catalyst used, the kinds and amounts of carboxylic acid anhydrides used, the amount of neutralizing agent added, the amount of water added, the reaction temperature and the ripening temperature. In addition, the cellulose acylate samples thus prepared were cleaned with acetone to remove their low molecular components.

From the thus prepared samples, cellulose acylate having the acetyl substitution degree of 2.79 and DS6/(DS2+DS3+DS6)=0.322 was selected, and subjected to the dope preparation described below.

### (2) Dope Preparation

### <1-1> Cellulose Acylate Solution

The following ingredients were charged into a mixing tank, made into a solution by stirring, and further heated at 90° C. for about 10 minutes. The resulting solution was filtered through a filter paper with an average pore size of 34 μm and a sintered metal filter with an average pore size of 10 μm.

Cellulose Acylate Solution

| | |
|---|---|
| Cellulose acylate | 100.0 parts by mass |
| Triphenyl phosphate | 8.0 parts by mass |
| Biphenyldiphenyl phosphate | 4.0 parts by mass |
| Methylene chloride | 403.0 parts by mass |
| Methanol | 60.2 parts by mass |

### <1-2> Matting Agent Dispersion

The following ingredients including the cellulose acylate solution prepared in the foregoing manner were charged into a dispersing machine, thereby preparing a dispersion of matting agent.

Matting Agent Dispersion

| | |
|---|---|
| Silica particles having an average size of | 2.0 parts by mass |
| 16 nm (AEROSIL R972, produced by | |
| Nippon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution

The following ingredients including the cellulose acylate solution prepared in the foregoing manner were charged into a mixing tank, and made into a solution by stirring under heating. Thus, a retardation developer solution was prepared.

Retardation Developer Solution

| | |
|---|---|
| Retardation Developer A | 20.0 parts by mass |
| (Compound illustrated below) | |
| Methylene chloride | 58.3 parts by mass |
| Methanol | 8.7 parts by mass |
| Cellulose acylate solution | 12.8 parts by mass |

A dope for film formation was prepared by mixing 100 parts by mass of the cellulose acylate solution with 1.35 parts by mass of the matting agent dispersion, and further with the retardation developer solution in an amount that the content of the retardation developer A in the cellulose acylate film to be formed became 5.1 parts by mass.

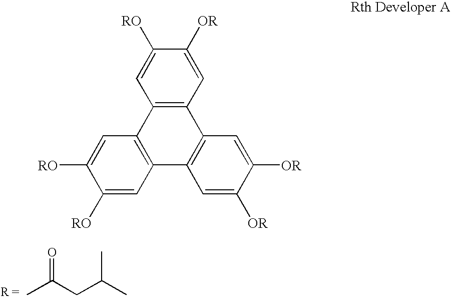

### (Casting)

Casting of the dope was carried out using glass-plate casting apparatus. The cast dope was dried for 6 minutes with hot air of a charge air temperature of 70° C., and the film stripped off the glass plate was fixed to a frame and dried for 10 minutes with hot air of a charge air temperature of 100° C. and further dried for 20 minutes with hot air of a charge air temperature of 140° C. Thus, 108 μm-thick cellulose acylate film was formed. The glass transition temperature of the cellulose acylate film was found to be 140° C.

This film was grasped by its four sides and underwent a stretching-and-shrinking process under different conditions shown in Table 2-1, respectively, by means of a biaxial stretching tester (made by Toyo Seiki Seisaku-Sho, Ltd.). As to a common condition for the stretching-and-shrinking process, the film before the process was subjected to 3-minute preheating at a charge air temperature specified for each process case, and it was confirmed that the film surface temperature measured with a noncontact infrared thermometer was within ±1° C. of each individual charge air temperature. After stretching, each film was cooled for 5 minutes by air blasting as it was grasped with clips. The term “MD” in the table means the casting direction during the glass-plate casting, and the term “TD” means the width direction orthogonal to the MD.

### <Sound Velocity in Film>

Sound velocities in each of the thus made films were measured with the sound wave meter SST-110 mentioned hereinbefore. Measurement results are shown in Table 2-1. The films according to the invention were found to be 1.2 or above in sound velocity ratio C(TD)/C(MD).

### <Re and Rth of Film at Wavelengths 450 nm, 550 nm and 650 nm>

Re and Rth values of each film at wavelengths of 450 nm, 550 nm and 650 nm were measured according to the method described hereinbefore and using KOBRA 21ADH (made by Oji Scientific Instruments).

The results obtained are shown in Table 2-1. As can be seen from Table 2-1, the Re and Rth values of every film manufactured according to the present method at the wavelengths of 450 nm, 550 nm and 650 nm satisfy the relations (I) to (III) specified in the invention.

### <Surface Condition of Film>

The surface conditions of the thus made films were evaluated according to the following method and criteria. Evaluation results are shown in Table 2-1. As shown therein, the surface conditions of the present films were found to be excellent. The film having undergone the high-speed shrinking in Comparative Example 2-4 had wrinkles throughout its surface, and the surface condition thereof was unsuitable for use as protective film of a polarizing plate.

### (Surface Condition Evaluation of Film)

A film sample measuring 20 cm by 20 cm is sandwiched between two polarizing plates placed in the crossed Nicol arrangement, mounted on a light box switched on, and examined for its surface condition in a darkroom. Under this situation, evaluations are made.

A: Neither unevenness nor wrinkles are observed, and the surface is in an excellent condition

B: Although unevenness or wrinkles are noticed, both area and intensity thereof are slight and on acceptable levels.

F: Unevenness or wrinkles are perceived clearly, and both area and intensity thereof are on unacceptable levels.

### <Making of Polarizing Plate>

A polarizing film was prepared by making a stretched polyvinyl alcohol film to adsorb iodine.

Each of the cellulose acylate films formed in Examples 2-1 to 2-3, Comparative Examples 2-1 to 2-4 and Reference Example was laminated on one side of the polarizing film with the aid of an adhesive of polyvinyl alcohol type. Incidentally, saponification treatment for these films was performed under the following condition.

A 1.5 mole/liter of aqueous sodium hydroxide solution was prepared, and kept at 55° C. A 0.01 mole/liter of diluted aqueous sulfuric acid solution was prepared, and kept at 35° C. After the cellulose acylate films formed were immersed for 2 minutes in the aqueous sodium hydroxide solution, they were immersed in water and the sodium hydroxide was thoroughly washed away from the films. Then, the films were immersed for 1 minute in the diluted aqueous sulfuric acid solution, and thereafter they were immersed in water and the sulfuric acid was thoroughly washed away from the films. Finally, these film samples were fully dried at 120° C.

A commercially available cellulose triacylate film (FUJI TAC TD80UF, produced by Fuji Photo Film Co., Ltd.) was saponified, and laminated on the other side of the polarizing film with the aid of the adhesive of polyvinyl alcohol type, and further dried at 70° C. for at least 10 minutes.

The polarizing film was placed so that its transmission axis became parallel to the slow axis of each of the cellulose acylate films made in the foregoing manners. On the other hand, the commercially available cellulose acylate film was placed so that its slow axis became orthogonal to the transmission axis of the polarizing film.

### <Making of Liquid Crystal Cell>

A liquid crystal cell was made by infusing a liquid crystal material having negative permittivity anisotropy (MLC6608, produced by Merck & Co.) into a cell gap kept at 3.6 μm between substrates and sealing the liquid crystal material in between the substrates to form a liquid crystal layer. The retardation of the liquid crystal layer (the product of a thickness d (μm) and a refractive-index anisotropy Δn of the liquid crystal layer, namely d·Δn) was adjusted to 300 nm. Additionally, the liquid crystal material was oriented so as to have vertical molecular alignment.

### <Mounting in VA Panel>

As an upper side (viewer side) polarizing plate of a liquid crystal display device using the foregoing vertical alignment liquid crystal cell, a commercially available superhigh contrast product (HLC2-5618, produced by Sanritz Corporation) was used. As a lower side (backlight side) polarizing plate, the polarizing plate including each of the cellulose acylate films made in Examples 2-1 to 2-3, Comparative Examples 2-1 to 2-4 and Reference Example was arranged so that the cellulose acylate film lay on the side of the liquid crystal cell. The upper side polarizing plate and the lower side polarizing plate were bonded to both sides of the liquid crystal cell, respectively, via a tackiness adhesive. Herein, these two polarizing plates were placed in the crossed Nicol arrangement so that the transmission axis of the upper side polarizing plate was oriented in a vertical direction and that of the lower side polarizing plate in a lateral direction.

55 Hz rectangular wave voltage was applied to the liquid crystal cell. And the cell was adjusted to a normally black mode in which the voltage was 5V in a white-display state and 0V in a black-display state. The black-display transmittance (%) at the viewing angle in the direction of 45° azimuth and 60° polar angle under the state of black display, and a color drift Δx between the direction of 45° azimuth and 60° polar angle and the direction of 180° azimuth and 60° polar angle were measured. Results obtained are shown in Table 2-1. In addition, the transmittance ratio (white display/black display) was regarded as a contrast ratio, and the viewing angles (the polar angle ranges in which the contrast ratio is 10 or above and there is no tone reversal in the black side) in 8 steps from the black display (L1) to the white display (L8) were measured with an instrument (EZ-Contrast 160D, made by ELDIM). Results obtained are also shown in Table 2-1. As a result of observing each of the liquid crystal display devices made, it was ascertained that neutral black display was achieved in both frontal and viewing-angle directions when the cellulose acylate films made in Examples 2-1 to 2-3 and Comparative Examples 2-3 and 2-4 were used.

Furthermore, evaluation of unevenness on the perimeter was made, and it was found that the liquid crystal display devices using the cellulose acylate films made in Examples 2-1 to 2-3 were reduced in unevenness on the perimeter, compared with those using the cellulose acylate films made in Comparative Examples.

On the other hand, the liquid crystal display device using the cellulose acylate film made in Reference Example was somewhat inferior to those using the present cellulose acylate films.

Evaluation criteria employed herein are as follows.

Viewing Angle (Polar angle range in which the contrast ratio is 10 or above and there is no tone reversal in the black side)

A: The polar angle is 80° or above in all of the upward, downward, rightward and leftward directions

B: The polar angle is 80° or above in three of the upward, downward, rightward and leftward directions

C: The polar angle is 80° or above in two of the upward, downward, rightward and leftward directions

F: The polar angle is 80° or above in none or one of the upward, downward, rightward and leftward directions

### Color Drift (Δx)

A: Smaller than 0.02

B: 0.02 to 0.04

C: 0.04 to 0.06

F: Greater than 0.06

### Unevenness on Perimeter (Evaluations under hot condition and hot, humid condition)

[Hot Condition]

As to the forced conditions employed, a 20-inch liquid crystal panel having the polarizing plate laminated throughout its either side was stored for 48 hours under a hot condition (temperature: 80° C., humidity: 10% or below) and mounted on backlights within 10 minutes thereafter, and the backlights were switched on.

By the degree of light leakage observed on the perimeter of the panel at the time of backlighting, unevenness on the perimeter was evaluated.

[Hot, Humid Condition]

As to the forced conditions employed, a 20-inch liquid crystal panel having the polarizing plate laminated throughout its either side was stored for 48 hours under a hot, humid condition (temperature: 60° C., humidity: 90%), then stored for 24 hours in the 25° C.-60% RH atmosphere, and thereafter mounted on backlights, and the backlights were switched on.

By the degree of light leakage observed on the perimeter of the panel at the time of backlighting, unevenness on the perimeter was evaluated.

The following are evaluation criteria employed in both cases of storage under the hot condition and storage under the hot, humid condition.

### (Evaluation of Light Leakage as Unevenness on Perimeter)

A: Almost no light leakage is observed

B: Although light leakage is observed, it is acceptable because the intensity and area thereof is small

F: Light leakage is observed, and it is unacceptable because the intensity and area thereof is great

TABLE 2-1

| | Stretching and Shrinking | | | | | | | | | | |
|---|---|---|---|---|---|---|---|---|---|---|---|
| | Charge | | | | | | | | | | |
| | Air | | Stretch | | | Shrink | Sound Velocity | | | (@550 nm) | |
| | Temp. | Stretch | Rate | Shrink | Shrink Rate | Speed | C (TD) | C (MD) | | Re | Rth |
| | (° C.) | Direction | (%) | Direction | (%) | (%/min) | (km/sec) | (km/sec) | C (TD)/C (MD) | (nm) | (nm) |
| Ex. 2-1 | 160 | TD | 22 | MD | 15 | 60 | 2.31 | 1.59 | 1.45 | 45 | 160 |
| Ex. 2-2 | 180 | TD | 31 | MD | 35 | 70 | 2.82 | 1.88 | 1.50 | 69 | 190 |
| Ex. 2-3 | 180 | TD | 26 | MD | 20 | 50 | 2.36 | 1.84 | 1.45 | 60 | 115 |
| Compar. | 160 | TD | 20 | MD | Fixed | — | 2.01 | 2.02 | 1.00 | 41 | 145 |
| Ex. 2-1 | | | | | width | | | | | | |
| Compar. | 180 | TD | 35 | MD | Fixed | — | 2.20 | 2.12 | 1.04 | 55 | 185 |
| Ex. 2-2 | | | | | width | | | | | | |
| Compar. | 180 | TD | 38 | MD | 15 | 2 | 2.09 | 2.03 | 1.03 | 60 | 115 |
| Ex. 2-3 | | | | | | | | | | | |
| Compar. | 180 | TD | 32 | MD | 12 | 130 | 2.19 | 2.02 | 1.08 | 60 | 115 |
| Ex. 2-4 | | | | | | | | | | | |
| Ref. Ex. | 180 | TD | 20 | MD | Free | 30 to 40 | 2.28 | 1.81 | 1.26 | 51 | 160 |
| | | | | | width | | | | | | |

| | | | | | | | | | Unevenness on | |
|---|---|---|---|---|---|---|---|---|---|---|
| | | | | | | | | | Perimeter | |
| | | Relation | Relation | Relation | (@550 | Surface | Viewing | | | Hot, |
| | Relation (I)*¹ | (I)*² | (II) | (III) | nm) ΔRth | Condition | Angle | Color Drift | Hot cond. | Humid Cond. |
| Ex. 2-1 | 0.86 | 1.12 | 0.92 | 1.06 | A | A | B | B | A | A |
| Ex. 2-2 | 0.71 | 1.24 | 0.83 | 0.22 | A | A | A | A | A | A |
| Ex. 2-3 | 0.60 | 1.61 | 0.68 | 1.41 | A | A | F | C | A | A |
| Compar. | 1.00 | 1.00 | 1.05 | 0.95 | F | A | C | F | F | F |
| Ex. 2-1 | | | | | | | | | | |
| Compar. | 1.00 | 1.00 | 1.05 | 0.95 | F | A | A | F | F | F |
| Ex. 2-2 | | | | | | | | | | |
| Compar. | 0.59 | 1.59 | 0.66 | 1.39 | A | A | F | C | F | F |
| Ex. 2-3 | | | | | | | | | | |
| Compar. | 0.60 | 1.62 | 0.67 | 1.40 | A | F | F | C | F | B |
| Ex. 2-4 | | | | | | (wrinkle) | | | | |
| Ref. Ex. | 0.72 | 1.21 | 0.71 | 1.22 | A | A | B | B | A | A |

In Table 2-1, Ex. stands for Example, Compar. Ex. stands for Comparative Example, and Ref. Ex. stands for Reference Example. In Reference Example, the shrinking was carried out at the shrinking speed shown in the table while letting the film width take its natural course. Re and Rth stands for Re(550) and Rth(550), respectively. The value of Relation (I)*¹ is a value of {(Re(450)/Rth(450))/(Re(550)/Rth(550))}, and the value of Relation (I)*² is a value of {(Re(650)/Rth(650))/(Re(550)/Rth(550))}. “@550 nm” in the table is abbreviation of the expression “measurement at a wavelength of 550 nm”.

In the next place, cellulose acylate films were made in the same manner as in Example 2-2, except that the acyl substitution degree on the 2-position hydroxyl groups of glucose units, DS2, the acyl substitution degree on the 3-position hydroxyl groups of glucose units, DS3, and the acyl substitution degree on the 6-position hydroxyl groups of glucose units, DS6, were changed as shown in Table 2-2, worked into polarizing plates, mounted in VA panels, and then evaluated. Evaluation results obtained are shown in Table 2-2. Example 2-4 enabled achievement of neutral black display in both frontal and viewing-angle directions. Examples 2-5 to 2-7 also ensured small color drift and enabled achievement of neutral black display in both frontal and viewing-angle directions, but they were inferior to Example 2-4 in at least either humidity dependence or viewing angle. These results indicate that the factors concerning acyl substitution degrees on the hydroxyl groups of glucose units in cellulose acylate film, (DS2+DS3+DS6) and SS6/(DS2+DS3+DS6), are of importance to improving those qualities.

TABLE 2-2

| | | | Stretching and Shrinking | | | | | | | | | | |
|---|---|---|---|---|---|---|---|---|---|---|---|---|---|
| | | | Charge | | | | | | | | | | |
| | Cellulose Acylate | | Air | | Stretch | | Shrink | Shrink | Sound Velocity | | | (@550 | |
| | DS2 + DS3 + | DS6/ | Temp. | Stretch | Rate | Shrink | Rate | Speed | C (TD) | C (MD) | C (TD)/ | nm) | |
| | DS6 | (DS2 + DS3 + DS6) | (° C.) | Direction | (%) | Direction | (%) | (%/sec) | (km/sec) | (km/sec) | C (MD) | Re | Rth |
| Ex. | 2.50 | 0.34 | 180 | TD | 31 | MD | 35 | 70 | 2.81 | 1.90 | 1.48 | 57 | 180 |
| 2-4 | | | | | | | | | | | | | |
| Ex. | 1.90 | 0.33 | 180 | TD | 31 | MD | 35 | 70 | 2.80 | 1.92 | 1.46 | 40 | 170 |
| 2-5 | | | | | | | | | | | | | |
| Ex. | 2.75 | 0.28 | 180 | TD | 31 | MD | 35 | 70 | 2.79 | 1.89 | 1.48 | 35 | 150 |
| 2-6 | | | | | | | | | | | | | |
| Ex. | 1.80 | 0.30 | 180 | TD | 31 | MD | 35 | 70 | 2.82 | 1.90 | 1.48 | 21 | 130 |
| 2-7 | | | | | | | | | | | | | |

| | | | | | | | | | Unevenness on | |
|---|---|---|---|---|---|---|---|---|---|---|
| | | | | | (@550 nm) | | | | Perimeter | |
| | Relation (I)*¹ | Relation (I)*² | Relation (II) | Relation (III) | ΔRth | ΔRe | Viewing Angle | Color Drift | Hot Cond. | Hot, Humid Cond. |
| Ex. 2-4 | 0.85 | 1.16 | 0.87 | 1.11 | A | A | B | A | A | A |
| Ex. 2-5 | 0.94 | 1.22 | 0.86 | 1.00 | A | F | C | B | A | A |
| Ex. 2-6 | 0.71 | 1.11 | 1.00 | 1.12 | A | A | F | B | A | A |
| Ex. 2-7 | 1.01 | 1.20 | 0.81 | 1.21 | A | F | F | B | A | A |

In Table 2-2, Ex. stands for Example. Re and Rth stands for Re(550) and Rth(550), respectively. The value of Relation (I)*¹ is a value of {(Re(450)/Rth(450))/(Re(550)/Rth(550))}, and the value of Relation (I)*² is a value of {(Re(650)/Rth(650))/(Re(550)/Rth(550))}. “@550 nm” in the table is abbreviation of the expression “measurement at a wavelength of 550 nm”.

### Example 2-8

### <Evaluation of Mounting in OCB Panel>

### (Alkali Treatment)

A 1.0N potassium hydroxide solution (solvent: water/isopropyl alcohol/propylene glycol=69.2 parts by mass/15 parts by mass/15.8 parts by mass) was applied at a coverage of 10 cc/m² to the cellulose acylate film made in Example 2-1, and kept in a condition of about 40° C. for 30 seconds. Then, the alkali solution was scraped off the film, and the resulting film was washed with purified water. The drops of water remaining were eliminated with an air knife. Thereafter, the film was dried at 100° C. for 15 seconds.

The contact angle of the alkali-treated film surface with respect to purified water was found to be 42°.

### (Formation of Oriented Film)

An oriented film coating solution having the following composition was applied at a coverage of 28 ml/m² to the alkali-treated surface of the film by means of a #16 wire bar coater. The solution applied was dried with 60° C. hot air for 60 seconds, and further with 90° C. hot air for 150 seconds, thereby forming an oriented film.

Composition of Coating Solution for Oriented Film

| | |
|---|---|
| Modified polyvinyl alcohol illustrated | 10 parts by mass |
| below | |
| Water | 371 parts by mass |
| Methanol | 119 parts by mass |
| Glutaraldehyde (cross-linking agents) | 0.5 parts by mass |
| Citric acid ester (AS3, produced by | 0.35 parts by mass |
| Sankyo Chemical Co., Ltd.) | |
| Modified polyvinyl alcohol | |

| | | |
|---|---|---|
| 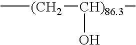 | 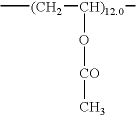 | 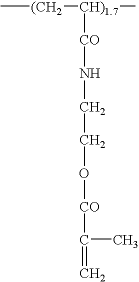 |

### (Rubbing Treatment)

A transparent substrate (the cellulose acylate film made in Example 2-1, alkali-treated and provided with the oriented film) was fed at a speed of 20 m/min, and rubbing treatment was given to the surface of the oriented film under a condition that a rubbing roll (measuring 300 mm in diameter) was adjusted to rub against the oriented film surface at an angle of 45° with respect to the direction of the length while rotating at 650 rpm. The length of contact between the rubbing roll and the transparent substrate was adjusted to 18 mm.

### (Formation of Optically Anisotropic Layer)

In 102 Kg of methyl ethyl ketone were dissolved 41.01 Kg of the following disc-shaped liquid crystalline compound (discotic liquid crystalline compound), 4.06 Kg of ethylene oxide-modified trimethylolpropane triacrylate (V#360, produced by Osaka Organic Chemical Industry Ltd.), 0.35 Kg of cellulose acetate butyrate (CAB531-1, produced by Eastman Chemical Company), 1.35 Kg of a photopolymerization initiator (Irgacure 907, produced by Ciba-Geigy) and 0.45 Kg of a sensitizer (Kayacure DETX, produced by Nippon Kayaku Co., Ltd.). To this solution, 0.1 Kg of a copolymer having fluorinated aliphatic groups (Megafac F780, produced by Dainippon Ink and Chemicals, Incorporated) was added to prepare a coating solution. The coating solution thus prepared was applied continuously to the oriented film surface of the transparent substrate, which was transported at a speed of 20 m/min, while rotating a #3.2 wire bar at 391 rpm in the same direction as the transport direction of the film.

### Discotic Liquid Crystalline Compound

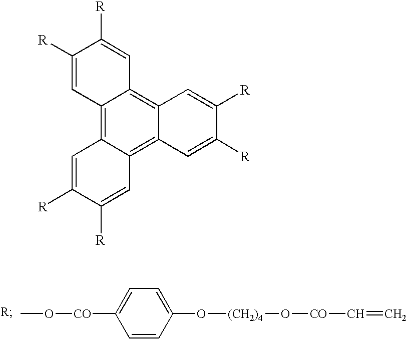

The coating solution applied was heated at temperatures raised continuously up to 100° C. from room temperature to evaporate the solvent, and then the discotic liquid crystalline compound was oriented by further heating for about 90 seconds in a 130° C. drying zone where the wind velocity at the filmy surface of the discotic, optically-anisotropic coating was adjusted to 2.5 m/sec. Subsequently thereto, the resulting film was transported into a 80° C. drying zone, and irradiated with ultraviolet rays at a illumination of 600 mW for 4 seconds by use of ultraviolet irradiation apparatus (ultraviolet lamp: output of 160 W/cm, light-emitting length of 1.6 m) in a condition that the surface temperature of the film was about 100° C. By this operation, cross-linking reaction progressed and the orientation of the discotic liquid crystal compound was fixed. Thereafter, the film was cooled to room temperature, and wound around a cylindrical-shaped core to take a roll form. In this way, roll-form optical compensation film (KH-4) was made.

When the viscosity of the optically anisotropic layer was measured at the film surface temperature of 127° C., it was found to be 695 cp (695 mPas). This viscosity value was a result of measurement made on a liquid crystal layer having the same composition (except for the solvent) as the optically anisotropic layer with a heating E-type viscometer.

A sample piece was cut from the thus made roll-form optical compensation film KH-4, and measured for optical characteristics. The Re retardation value of the optically anisotropic layer was found to be 38 nm as measured at the wavelength of 546 nm. In addition, it was found that the angles (tilt angles) which the disc planes of discotic liquid crystalline compound molecules in the optically anisotropic layer formed with the substrate surface varied continuously in the direction of the layer's depth and the average thereof was 28°. Furthermore, when the optically anisotropic layer alone was peeled off the sample piece and an average direction of the molecular symmetry axes in the optically anisotropic layer was determined, the average direction was found to be 45° with respect to the direction of the length of the optical compensation film.

### (Making of Polarizing Plate)

Iodine was adsorbed to a stretched polyvinyl alcohol film to make a polarizing film, and the film (KH-4) made in the foregoing manner was laminated on one side of the polarizing film with the aid of an adhesive of polyvinyl alcohol type. Therein, the transmission axis of the polarizing plate and the slow axis of the retardation film (KH-4) were arranged so as to become parallel.

A commercially available cellulose triacetate film (FUJI TAC TD80UF, produced by Fuji Photo Film Co., Ltd.) was saponified, and laminated on the other side of the polarizing film with the aid of the adhesive of polyvinyl alcohol type. Thus, a polarizing plate was made.

### (Making of Bend Alignment Liquid Crystal Cell)

A polyimide film as an oriented film was provided on a glass substrate equipped with ITO electrodes, and rubbing treatment was given to the oriented film. Two sheets of the glass substrate thus obtained were placed so that they faced each other and their rubbing directions became parallel, and a cell gap was adjusted to 4.7 μm. A liquid crystalline compound having Δn of 0.1396 (ZLI132, produced by Merck & Co., Inc.) was injected into the cell gap, thereby making a bend alignment liquid crystal cell.

Two sheets of the polarizing plate made in the foregoing manner were laminated so that the bend alignment liquid crystal cell was sandwiched between them. Therein, each sheet of the polarizing plate was arranged so that its optically anisotropic layer faced each cell substrate and the rubbing direction of the liquid crystal cell and the rubbing direction of the oriented film on which the optically anisotropic layer was formed became anti-parallel.

55 Hz rectangular wave voltage was applied to the liquid crystal cell. And the cell was adjusted to a normally white mode in which the voltage was 2V in a white-display state and 5V in a black-display state. When the liquid crystal display device thus made was observed in a condition that the voltage under which the transmittance in the frontal direction became a minimum, namely black voltage, was applied thereto, it was ascertained that neutral black display was achieved in both frontal and viewing-angle directions. In addition, the display was reduced in unevenness on the perimeter and delivered excellent performance.

### Examples 2-14 and 2-15, and Comparative Examples 2-5 to 2-8

From the cellulose acylate samples prepared, the cellulose acylate having an acetyl substitution degree of 2.00, a propionyl substitution degree of 0.60 and a viscosity-average polymerization degree of 350 was selected, and 100 parts by mass of the cellulose acylate selected, 5 parts by mass of ethylphthalylethyl glycolate, 3 parts by mass of triphenyl phosphate, 290 parts by mass of methylene chloride and 60 parts by mass of ethanol were placed in an airtight container. While slowly agitating the mixture, the container temperature was raised gradually up to 80° over a period of 60 minutes, thereby preparing a solution. The pressure inside the container went up to 1.5 atmospheres. The thus prepared dope was filtered with Azumi Filter Paper No. 244 (made by Azumi Filter Paper Co., Ltd.), and allowed to stand for 24 hours to eliminate foams therein.

Separately, 5 parts by mass of the cellulose acylate, 5 parts by mass of TINUVIN 109 (a product of Ciba Specialty Chemicals), 15 parts by mass of TINUVIN 326 (a product of Ciba Specialty Chemicals), 0.5 parts by mass of AEROSIL R972V (a product of Nippon Aerosil Co., Ltd.), 94 parts by mass of methylene chloride and 8 parts by mass of ethanol were mixed with stirring and made into a solution of ultraviolet absorbents. The ingredient R972V was dispersed in the ethanol in advance, and then mixed with the other ingredients.

The solution of ultraviolet absorbents was added in a proportion of 6 parts by mass to 100 parts by mass of the dope, and mixed thoroughly by means of a static mixer.

### (Casting)

The thus prepared dope was cast in accordance with the same method as described in the paragraph headed “(Casting)” in the description of Example 2-1 to be made into a 108 μm-thick cellulose acylate film. The glass transition temperature of the thus made cellulose acylate film was 140° C. This film was grasped by its four sides in the biaxial stretching tester according to the same method as described in the foregoing paragraph headed “<Casting>”, and subjected to stretching and shrinking processes under the same conditions as shown in Table 2-3.

Measurements were made on the thus stretched and shrunken film in accordance with the same methods as described in the paragraphs headed “Sound Velocity”, “<Re and Rth of Film at Wavelengths 450 nm, 550 nm and 650 nm>” and “<Surface Condition of Film>” in the description of Example 2-1, and a polarizing plate was made using the thus stretched and shrunken film in the same manner as described in the paragraph headed “<Making of Polarizing Plate>” in the description of Example 2-1. Furthermore, mounting evaluation was performed in the same steps as described in the paragraphs headed “<Making of Liquid Crystal Cell>” and “<Mounting in VA Panel>” in the description of Example 2-1. Results obtained are shown in Table 2-3.

TABLE 2-3

| | Stretching and Shrinking | | | | | | | | | | |
|---|---|---|---|---|---|---|---|---|---|---|---|
| | Charge | | | | | | | | | | |
| | Air | | Stretch | | Shrink | Shrink | Sound Velocity | | | | |
| | Temp. | Stretch | Rate | Shrink | Rate | Speed | C (TD) | C (MD) | | (@550 nm) | |
| | (° C.) | Direction | (%) | Direction | (%) | (%/min) | (km/sec) | (km/sec) | C (TD)/C (MD) | Re | Rth |
| Ex. 2-14 | 160 | TD | 18 | MD | 15 | 80 | 2.32 | 1.62 | 1.43 | 45 | 127 |
| Ex. 2-15 | 180 | TD | 27 | MD | 18 | 65 | 2.61 | 1.70 | 1.54 | 60 | 116 |
| Compar. | 160 | TD | 20 | MD | Fixed | — | 2.09 | 2.01 | 1.04 | 40 | 120 |
| Ex. 2-15 | | | | | width | | | | | | |
| Compar. | 180 | TD | 20 | MD | Fixed | — | 2.03 | 1.95 | 1.04 | 55 | 110 |
| Ex. 2-16 | | | | | width | | | | | | |
| Compar. | 180 | TD | 37 | MD | 15 | 3 | 2.14 | 1.98 | 1.08 | 60 | 116 |
| Ex. 2-17 | | | | | | | | | | | |
| Compar. | 180 | TD | 33 | MD | 11 | 150 | 2.19 | 2.06 | 1.06 | 80 | 116 |
| Ex. 2-18 | | | | | | | | | | | |

| | | | | | | | | Unevenness on Perimeter | |
|---|---|---|---|---|---|---|---|---|---|
| | | Relation | Relation | Relation | Surface | | | Hot | |
| | Relation (I)*¹ | (I)*² | (II) | (III) | Condition | Viewing Angle | Color Drift | Cond. | Hot, Humid Cond. |
| Ex. 2-14 | 0.9 | 1.12 | 0.91 | 1.16 | A | A | A | A | A |
| Ex. 2-15 | 0.86 | 1.15 | 0.82 | 1.21 | A | A | A | A | A |
| Compar. | 1.00 | 1.00 | 1.05 | 0.95 | A | A | F | A | A |
| Ex. 2-15 | | | | | | | | | |
| Compar. | 1.00 | 1.00 | 1.05 | 0.95 | A | A | F | A | A |
| Ex. 2-16 | | | | | | | | | |
| Compar. | 0.86 | 1.16 | 0.81 | 1.20 | A | A | A | A | B |
| Ex. 2-17 | | | | | | | | | |
| Compar. | 0.86 | 1.15 | 0.80 | 1.21 | F | A | A | A | A |
| Ex. 2-18 | | | | | (wrinkle) | | | | |

### Examples 2-16 to 2-18

Cellulose acylate film samples were made in the same manner as in Example 2-14, except that the substitution degree of acetyl groups (abbreviated as “Ac”), that of propionyl groups (abbreviated as “Pr”), that of butyryl groups (abbreviated as “Bt”) and that of benzoyl groups (abbreviated as “Bz”) were changed as shown in Table 2-4, respectively. The measurements and evaluations of mounting of these films were made in the same manners as adopted in Example 2-14.

TABLE 2-4

| | | | | | Stretching and Shrinking | | | | | | | | | | |
|---|---|---|---|---|---|---|---|---|---|---|---|---|---|---|---|
| | | | | | Charge | | | | | | Sound Velocity | | | | |
| | | | | | Air | | Stretch | | Shrink | Shrink | C (TD) | C (MD) | | (@550 | |
| | Cellulose Acylate | | | | Temp. | Stretch | Rate | Shrink | Rate | Speed | (km/ | (km/ | C (TD)/ | nm) | |
| | Ac | Pr | Bt | Bz | (° C.) | Direction | (%) | Direction | (%) | (%/min) | (sec) | (sec) | C (MD) | Re | Rth |
| Ex. | 1.98 | 0.72 | 0 | 0 | 160 | TD | 18 | MD | 15 | 80 | 2.28 | 1.68 | 1.36 | 45 | 128 |
| 2-16 | | | | | | | | | | | | | | | |
| Ex. | 200 | 0 | 0.70 | 0 | 160 | TD | 18 | MD | 15 | 80 | 2.35 | 1.62 | 1.45 | 41 | 122 |
| 2-17 | | | | | | | | | | | | | | | |
| Ex. | 200 | 0 | 0 | 0.70 | 160 | TD | 18 | MD | 15 | 80 | 2.23 | 1.65 | 1.41 | 50 | 130 |
| 2-18 | | | | | | | | | | | | | | | |

| | Relation | | | | | | Unevenness on Perimeter | |
|---|---|---|---|---|---|---|---|---|
| | (I)*¹ | Relation (I)*² | Relation (II) | Relation (III) | Viewing Angle | Color Drift | Hot, Condition | Hot, Humid Condition |
| Ex. 2-16 | 0.91 | 1.11 | 0.88 | 1.12 | A | A | A | A |
| Ex. 2-17 | 0.80 | 1.15 | 0.92 | 1.21 | A | A | A | A |
| Ex. 2-18 | 0.86 | 1.22 | 0.83 | 1.15 | A | A | A | A |

As can be seen from Table 2-4, the present cellulose acylate films which each had a substitution degree B, or a propionyl, butyryl or benzoyl substitution degree, of greater than 0, were successful without addition of any retardation developer in achieving viewing angle and color drift qualities equivalent to those achieved in Examples 2-1 and 2-7 by using cellulose acylate films whose substitutents were all acetyl groups. In addition, they were also successful in reducing unevenness on the perimeter.

### Example 3

### Example 3-1

### <<Formation of Cellulose Acylate Film>>

### (1) Cellulose Acylate

Cellulose acylate was prepared through acylation reaction carried out by adding sulfuric acid as a catalyst to a cellulose material and further adding thereto carboxylic acid anhydrides as starting materials of acyl substitutents, and subsequent neutralization and ripening by saponification. Therein, cellulose acylate samples differing in kind of acyl group, substitution degree, bulk density and polymerization degree were prepared by controlling the amount of catalyst used, the kinds and amounts of carboxylic acid anhydrides used, the amount of neutralizing agent added, the amount of water added, the reaction temperature and the ripening temperature. In addition, the cellulose acylate samples thus prepared were cleaned with acetone to remove their low molecular components.

From the thus prepared samples, cellulose acylate having the acetyl substitution degree of 2.79 and DS6/(DS2+DS3+DS6)=0.322 was selected, and subjected to the dope preparation described below.

### (2) Dope Preparation

### <1-1> Cellulose Acylate Solution

The following ingredients were charged into a mixing tank, made into a solution by stirring, and further heated at 90° C. for about 10 minutes. The resulting solution was filtered through a filter paper with an average pore size of 34 μm and a sintered metal filter with an average pore size of 10 μm.

Cellulose Acylate Solution

| | |
|---|---|
| Cellulose acylate | 100.0 parts by mass |
| Triphenyl phosphate | 8.0 parts by mass |
| Biphenyldiphenyl phosphate | 4.0 parts by mass |
| Methylene chloride | 403.0 parts by mass |
| Methanol | 60.2 parts by mass |

### <1-2> Matting Agent Dispersion

The following ingredients including the cellulose acylate solution prepared in the foregoing manner were charged into a dispersing machine, thereby preparing a matting agent dispersion.

Matting Agent Dispersion

| | |
|---|---|
| Silica particles having an average size of | 2.0 parts by mass |
| 16 nm (AEROSIL R972, produced by | |
| Nippon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution A

The following ingredients including the cellulose acylate solution prepared in the foregoing manner were charged into a mixing tank, and made into a solution by stirring under heating. Thus, a retardation developer solution A was prepared.

Retardation Developer Solution A

| | |
|---|---|
| Retardation Developer A | 20.0 parts by mass |
| (Compound illustrated below) | |
| Methylene chloride | 58.3 parts by mass |
| Methanol | 8.7 parts by mass |
| Cellulose acylate solution | 12.8 parts by mass |

A dope for film formation was prepared by mixing 100 parts by mass of the cellulose acylate solution with 1.35 parts by mass of the matting agent dispersion, and further with the retardation developer solution A in an amount that the content of the retardation developer A in the cellulose acylate film to be formed became 5.1 parts by mass.

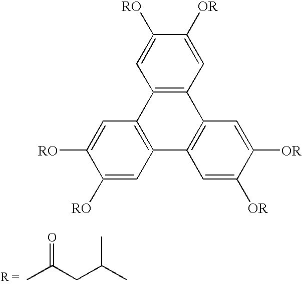

### (Casting)

Casting of the dope was carried out using glass-plate casting apparatus. The cast dope was dried for 6 minutes with hot air of a charge air temperature of 70° C., and the film stripped off the glass plate was fixed to a frame and dried for 10 minutes with hot air of a charge air temperature of 100° C. and further dried for 20 minutes with hot air of a charge air temperature of 140° C. Thus, 108 μm-thick cellulose acylate film was formed. The glass transition temperatures of the cellulose acylate film was found to be 140° C.

This film was grasped by its four sides and underwent a stretching-and-shrinking process under different conditions shown in Table 3-1, respectively, by means of a biaxial stretching tester (made by Toyo Seiki Seisaku-Sho, Ltd.). As to a common condition for the stretching-and-shrinking process, the film before stretching was subjected to 2-minute preheating at the charge air temperature specified for each process case. Thereafter, under each charge air temperature, the film was stretched in the TD direction and shrunken in the MD direction. Additionally, it was confirmed that the film surface temperature accorded with the charge air temperature. After those processes, each film was cooled for 5 minutes by air blasting as it was grasped with clips. The term “MD” in the table means the casting direction during the glass-plate casting, and the term “TD” means the width direction orthogonal to the MD. The films thus made are termed Films 3-1 to 3-8.

### <Crystallization Temperature of Film>

Crystallization temperatures of these films were determined by DSC. Results obtained are shown in Table 3-1.

### <Re and Rth of Film at Wavelengths 450 nm, 550 nm and 650 nm>

Re and Rth values of each film at wavelengths of 450 nm, 550 nm and 650 nm were measured according to the method described hereinbefore and using KOBRA 21 ADH (made by Oji Scientific Instruments).

The results obtained are shown in Table 3-1. As can be seen from Table 3-1, the Re and Rth values of each film manufactured according to the present method at the wavelengths of 450 nm, 550 nm and 650 nm satisfy the relations (I) to (III) specified in the invention.

As can further be seen from Table 3-1, the cellulose acylate films having undergone the stretching-and-shrinking process at temperatures in the range specified by the invention permit adjustments of linear thermal expansion coefficients in the width and longitudinal directions and the ratio between them to the ranges specified individually in the invention in contrast to cellulose acylate films having undergone the process at temperatures outside the range of the invention.

### <Making of Polarizing Plate>

A polarizing film was prepared by making a stretched polyvinyl alcohol film to adsorb iodine.

Each of the cellulose acylate films 3-1 to 3-8 was laminated on one side of the polarizing film with the aid of an adhesive of polyvinyl alcohol type. Incidentally, saponification treatment for these films was performed under the following condition.

A 1.5 mole/liter of aqueous sodium hydroxide solution was prepared, and kept at 55° C. A 0.01 mole/liter of diluted aqueous sulfuric acid solution was prepared, and kept at 35° C. After the cellulose acylate films formed were immersed for 2 minutes in the aqueous sodium hydroxide solution, they were immersed in water and the sodium hydroxide was thoroughly washed away from the films. Then, the films were immersed for 1 minute in the diluted aqueous sulfuric acid solution, and thereafter they were immersed in water and the sulfuric acid was thoroughly washed away from the films. Finally, these film samples were fully dried at 120° C.

A commercially available cellulose triacylate film (FUJI TAC TD80UF, produced by Fuji Photo Film Co., Ltd.) was saponified, and laminated on the other side of the polarizing film with the aid of the adhesive of polyvinyl alcohol type, and further dried at 70° C. for at least 10 minutes.

The polarizing film was placed so that its transmission axis became parallel to the slow axis of each of the cellulose acylate films made in the foregoing manners. On the other hand, the commercially available cellulose acylate film was placed so that its slow axis became orthogonal to the transmission axis of the polarizing film.

### <Making of Liquid Crystal Cell>

A liquid crystal cell was made by infusing a liquid crystal material having negative permittivity anisotropy (MLC6608, produced by Merck & Co.) into a cell gap kept at 3.6 μm between substrates and sealing the liquid crystal material in between the substrates to form a liquid crystal layer. The retardation of the liquid crystal layer (the product of a thickness d (μm) and a refractive-index anisotropy Δn of the liquid crystal layer, namely d·Δn) was adjusted to 300 nm. Additionally, the liquid crystal material was oriented so as to have vertical molecular alignment.

### <Mounting in VA Panel>

As an upper side (viewer side) polarizing plate of a liquid crystal display device using the foregoing vertical alignment liquid crystal cell, a commercially available superhigh contrast product (HLC2-5618, produced by Sanritz Corporation) was used. As a lower side (backlight side) polarizing plate, the polarizing plate having each of the films 3-1 to 3-8 was arranged so that the cellulose acylate film lay on the side of the liquid crystal cell. The upper side polarizing plate and the lower side polarizing plate were bonded to both sides of the liquid crystal cell, respectively, via a tackiness adhesive. Herein, these two polarizing plates were placed in the crossed Nicol arrangement so that the transmission axis of the upper side polarizing plate was oriented in a vertical direction and that of the lower side polarizing plate in a lateral direction.

55 Hz rectangular wave voltage was applied to the liquid crystal cell. And the cell was adjusted to a normally black mode in which the voltage was 5V in a white-display state and 0V in a black-display state. The black-display transmittance (%) at the viewing angle in the direction of 45° azimuth and 60° polar angle under the state of black display, and a color drift Δx between the direction of 45° azimuth and 60° polar angle and the direction of 180° azimuth and 60° polar angle were determined.

Color Drift:

Sum of ΔCu′v′ (u′v′(60° polar angle)−u′v′(0° polar angle)) at 45° azimuth and ΔCu′v′ (u′v′(60′ polar angle)−u′v′(0° polar angle)) at 135° azimuth. (u′v′: chromaticity coordinates in the CIELAB space)

In addition, the transmittance ratio (white display/black display) was regarded as a contrast ratio, and the viewing angles (the polar angle ranges in which the contrast ratio is 10 or above and there is no tone reversal in the black side) in 8 steps from the black display (L1) to the white display (L8) were measured with an instrument (EZ-Contrast 160D, made by ELDIM). Results obtained are also shown in Table 3-1. As a result of observing each of the liquid crystal display devices made, it was ascertained that the liquid crystal display devices using the films according to the invention delivered neutral black display in both frontal and viewing-angle directions.

### <Evaluation of Liquid Crystal Display Device by Wet Heat Treatment>

The liquid crystal display devices were allowed to stand for 48 hours in the 60° C.-90% RH surroundings. Thereafter, the displays were transferred to the 25° C.-60% RH surroundings. When the power was turned on and the state of black display was observed, it was found that the liquid crystal display devices using the films 3-4, 3-5 and 3-8 had light leaks around the perimeters of their respective screens. In contrast thereto, the liquid crystal display devices using the films 3-1, 3-2 and 3-3 had no light leak and delivered favorable black display.

In the next place, the mounted panels were taken out from their respective liquid crystal display devices, and transferred to the 25° C.-60% RH surroundings. After a lapse of 20 minutes, warpage of each panel was measured. Herein, the warpage w (mm) is defined as the distance between the short side of a panel and a plane which is tangent to the panel at the panel's center part. And L (mm) represents the dimension a panel has in the long side direction.

Measurement results are shown in Table 3-1. The panels made in accordance with the invention are slight in warpage, while those in comparative cases are considerable in warpage. So, it can be said that the invention has significant effect.

Criteria for viewing angle and color drift evaluations are as follows.

Viewing Angle (Polar angle range in which the contrast ratio is 10 or above and there is no tone reversal in the black side)

A: The polar angle is 80° or above in all of the upward, downward, rightward and leftward directions

B: The polar angle is 80° or above in three of the upward, downward, rightward and leftward directions

C: The polar angle is 80° or above in two of the upward, downward, rightward and leftward directions

F: The polar angle is 80° or above in none or one of the upward, downward, rightward and leftward directions

Color Drift (Δx) at Black-Display Time

A: Smaller than 0.02

B: 0.02 to 0.04

C: 0.04 to 0.06

F: Greater than 0.06

TABLE 3-1

| | Charge air | Crystallization | Stretch | Shrink | Linear Thermal | | | | | |
|---|---|---|---|---|---|---|---|---|---|---|
| | Temp. | Temp. | rate | Rate | Expansion Coefficient | | | Re (550) | Rth (550) | |
| | (° C.) | (° C.) | (%) | (%) | TD (A) | MD (B) | A/B | (nm) | (nm) | note |
| Film 3-1 | 180 | 180 | 35 | 18 | 35 | 95 | 0.37 | 82 | 206 | Invention |
| Film 3-2 | 185 | 180 | 35 | 18 | 38 | 80 | 0.48 | 79 | 198 | Invention |
| Film 3-3 | 175 | 180 | 35 | 18 | 34 | 83 | 0.41 | 78 | 205 | Invention |
| Film 3-4 | 195 | 180 | 35 | 18 | 70 | 75 | 0.93 | 10 | 120 | Comparison |
| Film 3-5 | 165 | 180 | 35 | 18 | 55 | 65 | 0.85 | 50 | 180 | Comparison |
| Film 3-6 | 195 | 180 | 30 | 18 | 41 | 80 | 0.53 | 78 | 201 | Comparison |
| Film 3-7 | 195 | 180 | 20 | 18 | 45 | 80 | 0.56 | 75 | 195 | Comparison |
| Film 3-8 | 195 | 180 | 20 | 18 | 50 | 77 | 0.65 | 12 | 117 | Comparison |

| | Value of | Value of | | | | | | |
|---|---|---|---|---|---|---|---|---|
| | Relation | Relation | Value of | Value of | Warpage of | Light Leak around | Viewing | Color |
| | (II) | (III) | Relation (I)*¹ | Relation (I)*² | Panel (w/L) | Perimeter | Angle | Drift |
| Film 3-1 | 0.65 | 1.37 | 0.55 | 1.44 | 0.004 | Not observed | A | A |
| Film 3-2 | 0.63 | 1.39 | 0.51 | 1.47 | 0.005 | Not observed | A | A |
| Film 3-3 | 0.67 | 1.35 | 0.59 | 1.4 | 0.005 | Not observed | A | A |
| Film 3-4 | 0.5 | 1.2 | 0.89 | 1.09 | 0.015 | Observed | F | A |
| Film 3-5 | 1.04 | 0.96 | 1.03 | 0.97 | 0.021 | Observed | F | F |
| Film 3-6 | 0.66 | 1.35 | 0.56 | 1.45 | 0.009 | Not observed | F | F |
| Film 3-7 | 0.67 | 1.33 | 0.54 | 1.43 | 0.01 | Not observed | F | F |
| Film 3-8 | 0.52 | 1.21 | 0.88 | 1.07 | 0.011 | Observed | F | F |

*¹(Re(450)/Rth(450))/(Re(550)/Rth(550))
*²(Re(650)/Rth(650))/(Re(550)/Rth(550))

### Example 3-2

Films were made in the same manner as in Example 3-1, except that the conditions for stretching and shrinking processes were so changed as to be shown in Table 3-2.

And liquid crystal panels were made in the same manner as in Example 3-1, and panels' warpage, light leak around the perimeter, viewing angle and color drift at black-display time were evaluated. Results obtained are also shown in Table 3-2.

TABLE 3-2

| | Charge air | Crystallization | Stretch | Shrink | Linear Thermal | | | | | |
|---|---|---|---|---|---|---|---|---|---|---|
| | Temp. | Temp. | rate | Rate | Expansion Coefficient | | | Re (550) | Rth (550) | |
| | (° C.) | (° C.) | (%) | (%) | TD (A) | MD (B) | A/B | (nm) | (nm) | note |
| Film 3-21 | 180 | 180 | 28 | 14 | 40 | 85 | 0.471 | 72 | 197 | Invention |
| Film 3-22 | 185 | 180 | 28 | 0 | 51 | 70 | 0.729 | 63 | 189 | Comparison |
| Film 3-23 | 175 | 180 | 0 | 18 | 83 | 83 | 1 | 21 | 112 | Comparison |
| Film 3-24 | 180 | 180 | 32 | 16 | 35 | 92 | 0.38 | 74 | 205 | Invention |

| | Value of | Value of | | | | | | |
|---|---|---|---|---|---|---|---|---|
| | Relation | Relation | Value of | Value of | Warpage of | Light Leak around | Viewing | Color |
| | (II) | (III) | Relation (I)*¹ | Relation (I)*² | Panel (w/L) | Perimeter | Angle | Drift |
| Film 3-21 | 0.71 | 1.34 | 0.71 | 1.34 | 0.006 | Not observed | A | A |
| Film 3-22 | 0.97 | 1.02 | 0.91 | 1.07 | 0.016 | Observed | F | F |
| Film 3-23 | 0.96 | 1.02 | 0.96 | 1.01 | 0.014 | Observed | F | F |
| Film 3-24 | 0.72 | 1.32 | 0.72 | 1.33 | 0.006 | Not observed | A | A |

*¹(Re(450)/Rth(450))/(Re(550)/Rth(550))
*²(Re(650)/Rth(650))/(Re(550)/Rth(550))

As can be seen from Table 3-2, the liquid crystal display devices had wide viewing angles and slight color drift by using the films made in accordance with the present method including both stretching and shrinking processes and ending the stretching process within the temperature range specified by the invention. In addition, it can be seen that the panels stored in wet and hot surroundings were reduced in warpage to a level causing no light leak around the perimeter by undergoing both the processes.

### Example 3-3

### <Making of Film>

Cellulose acylate materials were prepared so that Relations (IV) and (V) among the acyl substitution degree on the 2-position hydroxyl groups of glucose units, DS2, the acyl substitution degree on the 3-position hydroxyl groups of glucose units, DS3, and the acyl substitution degree on the 6-position hydroxyl groups of glucose units, DS6, were adjusted to those shown in Table 3-3. And cellulose acylate films were made in the same manner as in Example 3-1, except that those cellulose acylate materials were used and the amount of the retardation developer was changed. These films are termed Films 3-31 to 3-34. Furthermore, these films were worked into polarizing plates in the same manner as in Example 1.

### <Double Mounting in VA Panel>

As both the upper side (viewer side) polarizing plate and the lower side (backlight side) polarizing plate of the liquid crystal display device using the same vertical alignment liquid crystal cell as used in Example 3-1, two sheets of the polarizing plate having each of the films 3-31 to 3-34 were arranged so that their cellulose acylate films faced the liquid crystal cell and bounded to the liquid crystal cell surfaces, respectively, via a tackiness agent. In addition, these two sheets were placed in the crossed Nicol arrangement so that the transmission axis of the upper side polarizing plate was oriented in a vertical direction and that of the lower side polarizing plate in a lateral direction.

As in the case of Example 3-1, color drift and viewing angle evaluations were performed on the thus made liquid crystal display devices. In addition, each of the panels was subjected to the wet heat treatment, and examined for warpage and light leaks around the perimeter. Results obtained are shown in Table 3-3.

TABLE 3-3

| | | | | | Linear Thermal | | | | | |
|---|---|---|---|---|---|---|---|---|---|---|
| | Charge Air | Crystallization | Stretch | Shrink | Expansion | | | Value of | | |
| | Temp. | Temp. | Rate | Rate | Coefficient | | | Relation | Value of | |
| | (° C.) | (° C.) | (%) | (%) | TD (A) | MD (B) | A/B | (IV) | Relation (V) | note |
| Film 3-31 | 180 | 180 | 27 | 15 | 38 | 83 | 0.46 | 2.79 | 0.322 | Invention |
| Film 3-32 | 180 | 180 | 27 | 15 | 38 | 83 | 0.46 | 2.79 | 0.31 | Invention |
| Film 3-33 | 180 | 180 | 27 | 15 | 38 | 83 | 0.46 | 2.79 | 0.29 | Invention |
| Film 3-34 | 180 | 180 | 27 | 15 | 38 | 83 | 0.46 | 2.79 | 0.341 | Invention |

| | | | | | | | | Light | | |
|---|---|---|---|---|---|---|---|---|---|---|
| | | | Value of | Value of | Value of | Value of | Warpage | Leak | | |
| | Re (550) | Rth (550) | Relation | Relation | Relation | Relation | of Panel | around | Viewing | Color |
| | (nm) | (nm) | (II) | (III) | (I)*¹ | (I)*² | (w/L) | Perimeter | Angle | Drift |
| Film 3-31 | 63 | 115 | 0.63 | 1.37 | 0.54 | 1.48 | 0.004 | Not | A | A |
| | | | | | | | | observed | | |
| Film 3-32 | 61 | 116 | 0.62 | 1.39 | 0.53 | 1.51 | 0.005 | Not | A | A |
| | | | | | | | | observed | | |
| Film 3-33 | 62 | 114 | 0.63 | 1.39 | 0.53 | 1.51 | 0.006 | Not | A | A |
| | | | | | | | | observed | | |
| Film 3-34 | 63 | 113 | 0.62 | 1.35 | 0.52 | 1.45 | 0.003 | Not | A | A |
| | | | | | | | | observed | | |

*¹(Re(450)/Rth(450))/(Re(550)/Rth(550))
*²(Re(650)/Rth(650))/(Re(550)/Rth(550))

All the liquid crystal display devices made in Example 3-3 had wide viewing angles and achieved neutral black display. Although light leaks around the perimeter, which are traceable to storage of panels in hot, humid surroundings, were not observed, a difference in warpage was observed among the panels. More specifically, the warpage became smaller when the value of DS6/(DS2+DS3+DS6) was greater.

### Example 3-4

A 1.0 mol/L potassium hydroxide solution (solvent: water/isopropyl alcohol/propylene glycol=69.2 parts by mass/15 parts by mass/15.8 parts by mass) was applied at a coverage of 10 cc/m² to each of the cellulose acylate films 3-31 to 3-34 made in Example 3-3, and kept in a condition of about 40° C. for 30 seconds. Then, the alkali solution was scraped off the film, and the resulting film was washed with purified water. The drops of water remaining were eliminated with an air knife. Thereafter, the film was dried at 100° C. for 15 seconds.

The contact angle of the alkali-treated surface of each film with respect to purified water was found to be 41°.

### (Formation of Oriented Film)

An oriented film coating solution having the following composition was applied at a coverage of 28 ml/m² to the alkali-treated surface of each film by means of a #16 wire bar coater. The solution applied was dried with 60° C. hot air for 60 seconds, and further with 90° C. hot air for 150 seconds, thereby forming an oriented film.

Composition of Coating Solution for Oriented Film

| | |
|---|---|
| Modified polyvinyl alcohol illustrated | 10 parts by mass |
| below | |
| Water | 371 parts by mass |
| Methanol | 119 parts by mass |
| Glutaraldehyde (cross-linking agent) | 0.5 parts by mass |
| Citric acid ester (AS3, produced by | 0.35 parts by mass |
| Sankyo Chemical Co., Ltd.) | |
| Modified polyvinyl alcohol | |

| | | |
|---|---|---|
| 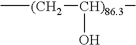 | 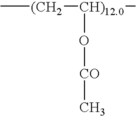 | 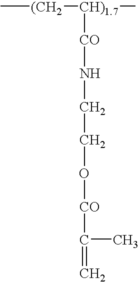 |

### (Rubbing Treatment)

A transparent substrate (each of the oriented film coated cellulose acylate films 3-31 to 3-34) was fed at a speed of 20 m/min, and rubbing treatment was given to the surface of the oriented film under a condition that a rubbing roll (measuring 300 mm in diameter) was adjusted to rub against the oriented film surface at an angle of 45° with respect to the longitudinal direction while rotating at 650 rpm. The length of contact between the rubbing roll and the transparent substrate was adjusted to 18 mm.

### (Formation of Optically Anisotropic Layer)

In 102 Kg of methyl ethyl ketone were dissolved 41.01 Kg of a disc-shaped liquid crystalline compound (the discotic liquid crystalline compound illustrated below), 4.06 Kg of ethylene oxide-modified trimethylolpropane triacrylate (V#360, produced by Osaka Organic Chemical Industry Ltd.), 0.35 Kg of cellulose acetate butyrate (CAB531-1, produced by Eastman Chemical Company), 1.31 Kg of a photopolymerization initiator (Irgacure 907, produced by Ciba-Geigy) and 0.47 Kg of a sensitizer (Kayacure DETX, produced by Nippon Kayaku Co., Ltd.). To this solution, 0.1 Kg of a copolymer having fluorinated aliphatic groups (Megafac F780, produced by Dainippon Ink and Chemicals, Incorporated) was added to prepare a coating solution. The coating solution thus prepared was applied continuously to the oriented film surface of the transparent substrate, which was transported at a speed of 20 m/min, while rotating a #3.2 wire bar at 391 rpm in the same direction as the transport direction of the film.

### Discotic Liquid Crystalline Compound

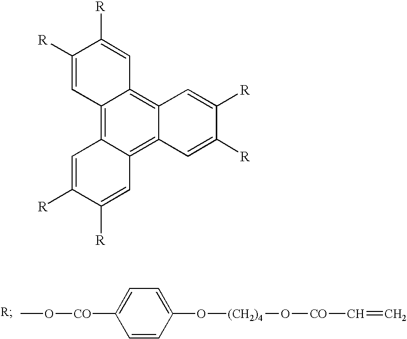

The coating solution applied was heated at temperatures raised continuously up to 100° C. from room temperature to evaporate the solvent, and then the discotic liquid crystalline compound was oriented by further heating for about 90 seconds in a 130° C. drying zone where the wind velocity at the filmy surface of the discotic, optically-anisotropic coating was adjusted to 2.5 m/sec. Subsequently thereto, the resulting film was transported into a 80° C. drying zone, and irradiated with ultraviolet rays at a illumination of 600 mW for 4 seconds by use of ultraviolet irradiation apparatus (ultraviolet lamp: output of 160 W/cm, light-emitting length of 1.6 m) in a condition that the surface temperature of the film was about 100° C. By this operation, cross-linking reaction progressed and the orientation of the discotic liquid crystal compound was fixed. Thereafter, the film was cooled to room temperature, and wound around a cylindrical-shaped core to take a roll form. In this way, roll-form optical compensation films were made.

When the viscosity of the optically anisotropic layer was measured at the film surface temperature of 127° C., it was found to be 695 cp (695 mPas). This viscosity value was a result of measurement made on a liquid crystal layer having the same composition (except for the solvent) as the optically anisotropic layer with a heating E-type viscometer.

A sample piece was cut from each of the thus made roll-form optical compensation film, and measured for optical characteristics. The Re retardation value of the optically anisotropic layer was found to be 36 nm as measured at the wavelength of 546 nm. In addition, it was found that the angles (tilt angles) which the disc planes of discotic liquid crystalline compound molecules in the optically anisotropic layer formed with the substrate surface varied continuously in the direction of the layer's depth and the average thereof was 28°. Furthermore, when the optically anisotropic layer alone was peeled off the sample piece and an average direction of the molecular symmetry axes in the optically anisotropic layer was determined, the average direction was found to be 45° with respect to the direction of the length of the optical compensation film.

### <Evaluation of Mounting in OCB Panel>

These optically anisotropic layer-equipped cellulose acylate film samples were each worked into a polarizing plate in the same manner as in Example 3-1.

### <Evaluation of Mounding in Liquid Crystal Display Device> (Making of Bend Alignment Liquid Crystal Cell)

A polyimide film as an oriented film was provided on a glass substrate equipped with ITO electrodes, and rubbing treatment was given to the oriented film. Two sheets of the glass substrate thus obtained were placed so that they faced each other and their rubbing directions became parallel, and a cell gap was adjusted to 4.7 μm. A liquid crystalline compound having Δn of 0.1396 (ZLI132, produced by Merck & Co., Inc.) was injected into the cell gap, thereby making a bend alignment liquid crystal cell.

Two sheets of each polarizing plate made in the foregoing manner were laminated so that the bend alignment liquid crystal cell was sandwiched between them. Therein, each sheet was placed so that its optically anisotropic layer faced each cell substrate and the rubbing direction of the liquid crystal cell and the rubbing direction of the oriented film on which the optically anisotropic layer was formed became anti-parallel.

55 Hz rectangular wave voltage was applied to the liquid crystal cell. And the cell was adjusted to a normally white mode in which the voltage was 2V in a white-display state and 5V in a black-display state. Under a condition that the voltage under which the transmittance in the frontal direction became a minimum, namely black voltage, was applied to each of the thus made liquid crystal cell, the black-display transmittance (%) at the viewing angle in the direction of 0° azimuth and 60° polar angle and a color drift Δx between the direction of 0° azimuth and 60° polar angle and the direction of 180° azimuth and 60° polar angle were determined. In addition, the transmittance ratio (white display/black display) was regarded as a contrast ratio, and viewing angles in 8 steps from the black display (L1) to the white display (L8) were measured with an instrument (EZ-Contrast 160D, made by ELDIM). Results obtained are put in order in the same way as in Example 3-1, and shown in Table 3-4. All the liquid crystal display devices using the films according to the invention delivered excellent performance on viewing angle and color drift at black-display time.

TABLE 3-4

| | Charge Air | Crystallization | Stretch | Shrink | Linear Thermal | | | Value | Value of | | | |
|---|---|---|---|---|---|---|---|---|---|---|---|---|
| | Temp. | Temp. | Rate | Rate | Expansion Coefficient | | | of Relation | Relation | | Color | |
| | (° C.) | (° C.) | (%) | (%) | TD (A) | MD (B) | A/B | (IV) | (V) | Viewing Angle | Drift | note |
| Film 3-31 | 180 | 180 | 27 | 15 | 38 | 83 | 0.46 | 2.79 | 0.322 | A | A | Invention |
| Film 3-32 | 180 | 180 | 27 | 15 | 38 | 83 | 0.46 | 2.79 | 0.31 | A | A | Invention |
| Film 3-33 | 180 | 180 | 27 | 15 | 38 | 83 | 0.46 | 2.79 | 0.29 | A | A | Invention |
| Film 3-34 | 180 | 180 | 27 | 15 | 38 | 83 | 0.46 | 2.79 | 0.341 | A | A | Invention |

### Example 3-5

From the cellulose acylate samples prepared, the cellulose acylate having an acetyl substitution degree of 1.10, a butyryl substitution degree of 1.70 and a viscosity-average polymerization degree of 350 was selected, and 100 parts by mass of the cellulose acylate selected, 5 parts by mass of ethylphthalylethyl glycolate, 3 parts by mass of triphenyl phosphate, 290 parts by mass of methylene chloride and 60 parts by mass of ethanol were placed in an airtight container. While slowly agitating the mixture, the container temperature was raised gradually up to 80° over a period of 60 minutes, thereby preparing a solution. The pressure inside the container went up to 1.5 atmospheres. The thus prepared dope was filtered with Azumi Filter Paper No. 244 (made by Azumi Filter Paper Co., Ltd.), and allowed to stand for 24 hours to eliminate foams therein.

Separately, 5 parts by mass of the cellulose acylate, 5 parts by mass of TINUVIN 109 (a product of Ciba Specialty Chemicals), 15 parts by mass of TINUVIN 326 (a product of Ciba Specialty Chemicals), 0.5 parts by mass of AEROSIL R972V (a product of Nippon Aerosil Co., Ltd.), 94 parts by mass of methylene chloride and 8 parts by mass of ethanol were mixed with stirring and made into a solution of ultraviolet absorbents. The ingredient R972V was dispersed in the ethanol in advance, and then mixed with the other ingredients.

The solution of ultraviolet absorbents was added in a proportion of 6 parts by mass to 100 parts by mass of the dope, and mixed thoroughly by means of a static mixer.

### (Casting)

The thus prepared dope was cast in accordance with the same method as described in the paragraph headed “(Casting)” in the description of Example 3-1 to be made into a 108 μm-thick cellulose acylate film. The glass transition temperature of the thus made cellulose acylate film was 155° C. This film was grasped by its four sides in the biaxial stretching tester according to the same method as described in the foregoing paragraph headed “<Casting>”, and subjected to stretching and shrinking processes under conditions shown in Table 3-5. Thus made films are termed Films 3-51 to 3-55.

### <Film Evaluation>

The thus made films were examined for Re and Rth values at wavelengths of 450 nm, 550 nm and 650 nm and made into polarizing plates in the same manners as in Example 3-1. Furthermore, liquid crystal cells were made using these polarizing plates and mounted in VA panels in the same manners as in Example 3-1, and mounting evaluations were performed thereon. Results obtained are shown in Table 3-5.

The panels made in accordance with the invention were slight in warpage traceable to storage in wet and hot surroundings, and free of light leaks around the perimeter. In other words, they produced remarkable effects.

TABLE 3-5

| | Charge air | Crystallization | Stretch | Shrink | Linear Thermal | | | | | |
|---|---|---|---|---|---|---|---|---|---|---|
| | Temp. | Temp. | rate | Rate | Expansion Coefficient | | | Re (550) | Rth (550) | |
| | (° C.) | (° C.) | (%) | (%) | TD (A) | MD (B) | A/B | (nm) | (nm) | note |
| Film 3-51 | 155 | 155 | 40 | 20 | 38 | 92 | 0.41 | 84 | 207 | Invention |
| Film 3-52 | 165 | 155 | 40 | 20 | 36 | 76 | 0.47 | 80 | 200 | Invention |
| Film 3-53 | 145 | 155 | 40 | 20 | 35 | 79 | 0.44 | 79 | 207 | Invention |
| Film 3-54 | 175 | 155 | 40 | 20 | 75 | 78 | 0.96 | 15 | 125 | Comparison |
| Film 3-55 | 135 | 155 | 40 | 20 | 50 | 55 | 0.91 | 55 | 185 | Comparison |

| | | | Value of | | Warpage of | | | |
|---|---|---|---|---|---|---|---|---|
| | Value of | Value of Relation | Relation (I) | | Panel | Light Leaks | | |
| | Relation (II) | (III) | *1 | *2 | (w/L) | around Perimeter | Viewing Angle | Color Drift |
| Film 3-51 | 0.66 | 1.38 | 0.54 | 1.45 | 0.005 | Not observed | A | A |
| Film 3-52 | 0.64 | 1.4 | 0.5 | 1.48 | 0.004 | Not observed | A | A |
| Film 3-53 | 0.68 | 1.34 | 0.6 | 1.39 | 0.005 | Not observed | A | A |
| Film 3-54 | 0.51 | 1.21 | 0.9 | 1.1 | 0.015 | Observed | F | A |
| Film 3-54 | 1.04 | 0.97 | 1.03 | 0.97 | 0.021 | Observed | F | F |

*1 (Re(450)/Rth(450))/(Re(550)/Rth(550))
*2 (Re(650)/Rth(650))/(Re(550)/Rth(550))

### Example 3-6

From the cellulose acylate samples prepared, the cellulose acylate having an acetyl substitution degree of 2.00, a propionyl substitution degree of 0.72 and a viscosity-average polymerization degree of 350 was selected, and 100 parts by mass of the cellulose acylate selected, 5 parts by mass of ethylphthalylethyl glycolate, 3 parts by mass of triphenyl phosphate, 290 parts by mass of methylene chloride and 60 parts by mass of ethanol were placed in an airtight container. While slowly agitating the mixture, the container temperature was raised gradually up to 800 over a period of 60 minutes, thereby preparing a solution. The pressure inside the container went up to 1.5 atmospheres. The thus prepared dope was filtered with Azumi Filter Paper No. 244 (made by Azumi Filter Paper Co., Ltd.), and allowed to stand for 24 hours to eliminate foams therein.

Separately, 5 parts by mass of the cellulose acylate selected, 5 parts by mass of TINUVIN 109 (a product of Ciba Specialty Chemicals), 15 parts by mass of TINUVIN 326 (a product of Ciba Specialty Chemicals), 0.5 parts by mass of AEROSIL R972V (a product of Nippon Aerosil Co., Ltd.), 94 parts by mass of methylene chloride and 8 parts by mass of ethanol were mixed with stirring and made into a solution of ultraviolet absorbents. The ingredient R972V was dispersed in the ethanol in advance, and then mixed with the other ingredients.

The solution of ultraviolet absorbents was added in a proportion of 6 parts by mass to 100 parts by mass of the dope, and mixed thoroughly by means of a static mixer.

### (Casting)

The thus prepared dope was cast in accordance with the same method as described in the paragraph headed “(Casting)” in the description of Example 3-1 to be made into a 108 μm-thick cellulose acylate film. The glass transition temperature of the thus made cellulose acylate film was 140° C. This film was grasped by its four sides in the biaxial stretching tester according to the same method as described in the foregoing paragraph headed “<Casting>”, and subjected to stretching and shrinking processes under the conditions shown in Table 3-6. The thus obtained film was termed Film 3-61.

### <Making of Films Having Different Substitutents>

Films 3-62 and 3-63 were each made in the same manner as Film 3-61, except that the acetyl substitution degrees were changed and the propyl substitution was changed to the butyryl (Bt) or benzoyl (Bz) substitution as shown in Table 3-6.

### <Film Evaluation>

The thus made films were examined for Re and Rth values at wavelengths of 450 nm, 550 nm and 650 nm and made into polarizing plates in the same manners as in Example 3-1. Furthermore, liquid crystal cells were made using these polarizing plates and mounted in VA panels in the same manners as in Example 3-3, and mounting evaluations were performed thereon. Results obtained are shown in Table 3-6.

TABLE 3-6

| | | | | | Linear thermal | | | |
|---|---|---|---|---|---|---|---|---|
| | Ac Substitution | Pr Substitution | Bt Substitution | Bz Substitution | Expansion Coefficient | | | |
| | Degree | Degree | Degree | Degree | TD (A) | MD (B) | A/B | note |
| Film 3-61 | 2.00 | 0.72 | 0 | 0 | 40.0 | 90.0 | 0.44 | Invention |
| Film 3-62 | 1.99 | 0 | 0.73 | 0 | 41.0 | 89.0 | 0.46 | Invention |
| Film 3-63 | 2.01 | 0 | 0 | 0.71 | 37.9 | 93.0 | 0.40 | Invention |

| | | | | | Value of | | | |
|---|---|---|---|---|---|---|---|---|
| | Re (550) | Rth (550) | Value | Value of Relation | Relation (I) | | | |
| | (nm) | (nm) | of Relation (II) | (III) | *1 | *2 | Viewing Angle | Color Drift |
| Film 3-61 | 59 | 115 | 0.64 | 1.42 | 0.56 | 1.56 | A | A |
| Film 3-62 | 56 | 117 | 0.63 | 1.50 | 0.56 | 1.70 | A | A |
| Film 3-63 | 61 | 113 | 0.64 | 0.97 | 0.55 | 1.05 | A | A |

*1 (Re(450)/Rth(450))/(Re(550)/Rth(550))
*2 (Re(650)/Rth(650))/(Re(550)/Rth(550))

As can be seen from Table 3-6, the cellulose acylate films each having a substitution degree B, or a propionyl, butyryl or benzoyl substitution degree, of greater than 0 in accordance with the invention were successful in achieving wide viewing angle and excellent color drift performance at black-display time.

In accordance with the invention, cellulose acylate films which can ensure accurate optical compensation, high contrast and improvement in color drift depending on the direction of a visual angle at black-display time when used in liquid crystal cells, notable of VA, IPS and OCB modes, methods of manufacturing such cellulose acylate films and polarizing plates using them are provided. The invention can further provide liquid crystal display devices hardly develop unevenness on the perimeter thereof even when the displays undergo drastic changes in temperature and humidity. In addition, the invention can provide liquid crystal display devices which, even after storage in wet, hot surroundings, hardly generate warpage and are improved in light leaks around the perimeter of the screen.

The entire disclosure of each and every foreign patent application from which the benefit of foreign priority has been claimed in the present application is incorporated herein by reference, as if fully set forth.

1. An optical film, which has a photoelastic coefficient in a longitudinal direction of the optical film and a photoelastic coefficient in a direction approximately orthogonal to the longitudinal direction,
wherein a value obtained by dividing smaller one of the two photoelastic coefficients by greater one of the two photoelastic coefficients is 0.8 or below.

2. The optical film according to claim 1,
wherein values of in-plane retardation Re and thickness-direction retardation Rth at wavelengths 450 nm, 550 nm and 650 nm satisfy the following relations (I) to (III):
0.4<{(Re(450)/Rth(450))/(Re(550)/Rth(550))}<0.95 and
1.05<{(Re(650)/Rth(650))/(Re(550)/Rth(550))}<1.9 Relation (I)
0.1<(Re(450)/Re(550))<0.95 Relation (II)
1.03<(Re(650)/Re(550))<1.93 Relation (III)
wherein Re(λ) represents an in-plane retardation Re value, expressed in the unit nm, at a wavelength λ nm; and
Rth(λ) represents a thickness-direction retardation Rth value, expressed in the unit nm, at a wavelength λ nm.

3. A method of manufacturing an optical film, which comprises:
casting a dope solution on to a support; then
drying the dope solution at a temperature of from 40° C. to 60° C., so as to form a film; then
stretching the film; and
shrinking the film.

4. The optical film produced by the method according to claim 3, wherein the optical film has a photoelastic coefficient in a longitudinal direction of the optical film and a photoelastic coefficient in a direction approximately orthogonal to the longitudinal direction, wherein a value obtained by dividing smaller one of the two photoelastic coefficients by greater one of the two photoelastic coefficients is 0.8 or below.

5. An optical film, which has a value of 1.2 or above obtained by dividing greater one of a velocity of sound in a longitudinal direction of the optical film and a velocity of sound in a direction approximately orthogonal to the longitudinal direction by smaller one of the two velocities.

6. An optical film, which has a value of 1.1 or above obtained by dividing greater one of a velocity of sound in a longitudinal direction of the optical film and a velocity of sound in a direction approximately orthogonal to the longitudinal direction by smaller one of the two velocities,
wherein values of in-plane retardation Re and thickness-direction retardation Rth at wavelengths 450 nm, 550 nm and 650 nm satisfy the following relations (I) to (III):
0.4<{(Re(450)/Rth(450))/(Re(550)/Rth(550))}<0.95 and
1.05<{(Re(650)/Rth(650))/(Re(550)/Rth(550))}<1.9 Relation (I)
0.1<(Re(450)/Re(550))<0.95 Relation (II)
1.03<(Re(650)/Re(550))<1.93 Relation (III)
wherein Re(λ) represents an in-plane retardation Re value, expressed in the unit nm, at a wavelength λ nm; and
Rth(λ) represents a thickness-direction retardation Rth value, expressed in the unit nm, at a wavelength λ nm.

7. A method of manufacturing an optical film, which comprises:
stretching a film; and
shrinking a film,
wherein the shrinking is performed at a shrink speed of 10% to 100% per minute.

8. The optical film produced by the method according to claim 7, wherein the optical film has a value of 1.2 or above obtained by dividing greater one of a velocity of sound in a longitudinal direction of the optical film and a velocity of sound in a direction approximately orthogonal to the longitudinal direction by smaller one of the two velocities.

9. The optical film according to claim 1,
wherein an in-plane retardation Re value at a wavelength of 550 nm is in a range of from 20 to 100 nm and a thickness-direction retardation Rth value at a wavelength of 550 nm is in a range of from 100 to 300 nm.

10. The optical film according to claim 1, which comprises a cellulose acylate.

11. The optical film according to claim 10,
wherein substitution degrees of hydroxyl groups with acyl groups at 2-, 3- and 6-positions of a glucose unit in the cellulose acylate satisfy the following relations (IV) and (V):
2.0≦(DS2+DS3+DS6)≦3.0 Relation (IV)
DS6/(DS2+DS3+DS6)≧0.315 Relation (V)
wherein DS2 represents an acyl substitution degree on the 2-position hydroxyl group;
DS3 represents an acyl substitution degree on the 3-position hydroxyl group; and
DS6 represents an acyl substitution degree on the 6-position hydroxyl group.

12. The cellulose acylate film according to claim 10, which substantially comprises a cellulose acylate satisfying the following relations (VI) and (VII):
2.0≦A+B≦3.0 Relation (VI)
0≦B Relation (VII)
wherein A represents a substitution degree of hydroxyl groups of a glucose unit in the cellulose acylate with acetyl groups; and
B represents a substitution degree of hydroxyl groups of a glucose unit in the cellulose acylate with propionyl groups, butyryl groups or benzoyl groups.

13. The optical film according to claim 1, which comprises a retardation developer.

14. A polarizing plate, which comprises:
a polarizing film; and
a pair of protective films sandwiching the polarizing film,
wherein at least one of the pair of protective films is an optical film according to claim 1.

15. A liquid crystal display device, which comprises an optical film according to claim 1.

16. A liquid crystal display device, which comprises a polarizing plate according to claim 14,
wherein the liquid crystal display device is of IPS-mode, OCB-mode or VA-mode.

17. A VA-mode liquid crystal display device, which comprises a polarizing plate according to claim 14 on a backlight side.

18. An optical film, which has a coefficient of linear thermal expansion in a longitudinal direction of the optical film and a coefficient of linear thermal expansion in a width direction approximately orthogonal to the longitudinal direction,
wherein a value obtained by dividing smaller one of the two coefficients of linear thermal expansion by greater one of the two coefficients is from 0.1 to 0.5.

19. The optical film according to claim 18,
wherein one of the two coefficients of linear thermal expansion in the longitudinal direction of the optical film and the width direction approximately orthogonal to the longitudinal direction is 42 or below and the other is 80 or above.

20. The optical film according to claim 18,
wherein values of in-plane retardation Re and thickness-direction retardation Rth at wavelengths 450 nm, 550 nm and 650 nm satisfy the following relations (I) to (III):
0.4<{(Re(450)/Rth(450))/(Re(550)/Rth(550))}<0.95 and
1.05<{(Re(650)/Rth(650))/(Re(550)/Rth(550))}<1.9 Relation (I)
0.1<(Re(450)/Re(550))<0.95 Relation (II)
1.03<(Re(650)/Re(550))<1.93 Relation (III)
wherein Re(λ) represents an in-plane retardation Re value, expressed in the unit nm, at a wavelength λ nm; and
Rth(λ) represents a thickness-direction retardation Rth value, expressed in the unit nm, at a wavelength λ nm.

21. A method of manufacturing an optical film, which comprises:
stretching a film; and
shrinking a film,
wherein an ending temperature of the stretching is adjusted to a range of (crystallization temperature of the optical film −10° C.) to (crystallization temperature of the optical film +10° C.).

22. The optical film produced by the method according to claim 21, wherein the optical film has a coefficient of linear thermal expansion in a longitudinal direction of the optical film and a coefficient of linear thermal expansion in a width direction approximately orthogonal to the longitudinal direction, wherein a value obtained by dividing smaller one of the two coefficients of linear thermal expansion by greater one of the two coefficients is from 0.1 to 0.5.

23. The optical film according to claim 18, which comprises a cellulose acylate.

24. The optical film according to claim 23,
wherein all acyl substitutents in the cellulose acylate are acetyl groups and a total degree of acyl substitution is from 2.56 to 3.00.

25. The optical film according to claim 23,
wherein substitution degrees of hydroxyl groups with acyl groups at 2-, 3- and 6-positions of a glucose unit in the cellulose acylate satisfy the following relations (IV) and (V):
2.0≦(DS2+DS3+DS6)≦3.0 Relation (IV)
DS6/(DS2+DS3+DS6)≧0.315 Relation (V)
wherein DS2 represents an acyl substitution degree on the 2-position hydroxyl group;
DS3 represents an acyl substitution degree on the 3-position hydroxyl group; and
DS6 represents an acyl substitution degree on the 6-position hydroxyl group.

26. The optical film according to claim 23,
wherein acyl substitutents of the cellulose acylate comprises at least two of acetyl, propionyl, butanoyl and benzoyl groups, and a total degree of acyl substitution is from 2.50 to 3.00

27. The optical film according to claim 18, which comprises a retardation developer.

28. A polarizing plate, which comprises:
a polarizing film; and
a pair of protective films sandwiching the polarizing film,
wherein at least one of the pair of protective films is an optical film according to claims 18.

29. A liquid crystal display device, which comprises an optical film according to claim 18.

30. A liquid crystal display device, which comprises:
a pair of polarizing plates; and
a liquid crystal cell between the pair of polarizing plates,
wherein at least one of the pair of polarizing plates is a polarizing plate according to claim 28, and
the liquid crystal display device is of IPS-mode, OCB-mode or VA-mode.

31. A VA-mode liquid crystal display, which comprises a polarizing plate according to claim 28 on a backlight side.
